(19) United States
(12) Patent Application Publication
(10) Pub. No.: US 2024/0062617 A1
(43) Pub. Date: Feb. 22, 2024

(54) SYSTEM, METHOD, AND NON-TRANSITORY COMPUTER-READABLE STORAGE MEDIA FOR PROVIDING PATRON ACCESS TO MULTIPLE ACCOUNTS

(71) Applicant: White Ivory Elephant Technologies Corp, Las Vegas, NV (US)

(72) Inventors: Murali Ganesan, Las Vegas, NV (US); Vaughn Place, Henderson, NV (US); Manmohan Reddy Rajidi, Cumming, GA (US)

(73) Assignee: White Ivory Elephant Technologies Corp, Las Vegas, NV (US)

(21) Appl. No.: 18/451,285

(22) Filed: Aug. 17, 2023

Related U.S. Application Data
(60) Provisional application No. 63/488,786, filed on Mar. 7, 2023.
(60) Provisional application No. 63/398,740, filed on Aug. 17, 2022.

(51) Int. Cl. G07F 17/32

(52) U.S. Cl. CPC G07F 17/3227; G07F 17/3237; G07F 17/3204

(57) ABSTRACT

A computer platform provides patrons with access to a plurality of casino management systems (CMS). The platform performs the steps of allowing one of the patrons to logon onto to the computer platform using a user device, allowing the one of the patrons to select a casino management systems, locating a patron CMS configuration record associated with the one of the patrons and the casino management systems and automatically logging onto the one of the plurality of casino managements systems as the one of the patrons using CMS logon data stored on the platform; and providing access to the one of the plurality of casino management systems to the one of the patrons.

### CROSS REFERENCE TO RELATED APPLICATIONS

This application claims priority to US Provisional Patent Applications U.S. 63/398,740 filed on Aug. 17, 2022 (WHITEIVORY-P0001P) and 63/488,786 filed on Mar. 7, 2023 (WHITEIVORY-P0002P), the entire disclosures of which are hereby incorporated by reference and relied upon.

### FIELD OF THE INVENTION

The invention relates generally to casino management systems, and more particularly, to a computer platform that provides access to multiple casino management system accounts.

### BACKGROUND OF THE INVENTION

Casino management systems (CMS’) provide may provide many functions or features related to gaming and non-gaming aspects or activities within a casino or casino property. For instance, a casino management system may track wagering activities made by players within a casino for the purpose of governmental or regulatory activities and for the purposes of a player loyalty program. Such player loyalty programs may track player or patron activities and award the player tracking or loyalty points. The loyalty points may be traded in for predetermined awards at the casino.

Historically, such systems were limited to a particular casino or casino property. However, a casino management system may be tied to multiple casinos which are owned, or operated, by a common owner or operator. Each casino management system may be accessed remotely by the player to monitor, view, or otherwise interact with their player tracking account.

However, if a player has accounts at multiple casino management system, the patron must access, and recall and manage, their accounts separately.

The present invention is aimed at one or more of the problems identified above.

### BRIEF SUMMARY OF THE INVENTION

In a first aspect of the present invention, a computer platform for providing patrons with access to a plurality of casino management systems (CMS) is provided. The computer platform includes a data store and one or more content servers. The data store is configured to store a database including a patron data file including a plurality of patron records and a patron CMS data file including a plurality of patron CMS configuration records. Each patron record is associated with one of the patrons and includes computer platform logon data. Each patron CMS configuration record is associated with one of the patrons and includes CMS logon data for an associated casino management system. The one or more content servers are coupled to the data store and includes at least one processor programmed to execute an algorithm. The algorithm steps including the steps of allowing one of the patrons to logon onto to the computer platform using a user device; allowing the one of the patrons to select one of the plurality of casino management systems; locating the patron CMS configuration record associated with the one of the patrons and the one of the plurality of casino management systems and automatically logging onto the one of the plurality of casino managements systems as the one of the patrons using the CMS logon data in the located patron CMS configuration record; and providing access to the one of the plurality of casino management systems to the one of the patrons via the user device.

In a second aspect of the present invention, a method for operating a computer platform for providing patrons with access to a plurality of casino management systems (CMS). The computer platform includes a data store and one or more content servers coupled to the data store. The one or more content servers includes at least one processor programmed to execute an algorithm. The data store is configured to store a database including a patron data file including a plurality of patron records and a patron CMS data file including a plurality of patron CMS configuration records. Each patron record and each patron CMS configuration record is associated with one of the patrons. Each patron record includes computer platform logon data. Each patron CMS configuration record includes CMS logon data for an associated casino management system. The method includes the steps of: allowing one of the patrons to logon onto to the computer platform using a user device; allowing the one of the patrons to select one of the plurality of casino management systems; locating the patron CMS configuration record associated with the one of the patrons and the one of the plurality of casino management systems and automatically logging onto the one of the plurality of casino managements systems as the one of the patrons using the CMS logon data in the located patron CMS configuration record; and, providing access to the one of the plurality of casino management systems to the one of the patrons via the user device.

In a third aspect of the present invention, one or more non-transitory computer-readable storage media, having computer-executable instructions embodied thereon for operating for operating a computer platform for providing patrons with access to a plurality of casino management systems (CMS), is provided. The computer platform includes a data store and one or more content servers coupled to the data store. The one or more content servers include at least one processor. The data store is configured to store a database including a patron data file including a plurality of patron records and a patron CMS data file including a plurality of patron CMS configuration records. Each patron record and each patron CMS configuration record is associated with one of the patrons. Each patron record includes computer platform logon data. Each patron CMS configuration record includes CMS logon data for an associated casino management system. The computer-executable instructions cause the at least one processor to execute an algorithm to allow one of the patrons to logon onto to the computer platform using a user device; allow the one of the patrons to select one of the plurality of casino management systems; locate the patron CMS configuration record associated with the one of the patrons and the one of the plurality of casino management systems and automatically log onto the one of the plurality of casino managements systems as the one of the patrons using the CMS logon data in the located patron CMS configuration record; and, provide access to the one of the plurality of casino management systems to the one of the patrons via the user device.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a block diagram of a computer platform for providing patron access to multiple casino management system (CMS) accounts, according to an embodiment of the present invention.

FIG. 2 is a block diagram of a plurality of data files stored in a persistent database of the computer platform of FIG. 1.

FIG. 3 is a flow diagram of a portion of an algorithm associated with the computer platform of FIG. 1, according to an embodiment of the present invention.

FIG. 4 is a flow diagram of a second portion of an algorithm associated with the computer platform of FIG. 1, according to an embodiment of the present invention.

FIG. 5A is an exemplary patron data file associated with the computer platform of FIG. 1, according to an embodiment of the present invention.

FIG. 5B is an exemplary platform patron data file associated with the computer platform of FIG. 1, according to an embodiment of the present invention.

FIG. 6 is an exemplary patron CMS data file associated with the computer platform of FIG. 1, according to an embodiment of the present invention.

FIG. 7 is an exemplary loyalty promotion data file associated with the computer platform of FIG. 1, according to an embodiment of the present invention.

FIG. 8 is an exemplary casino promotion data file associated with the computer platform of FIG. 1, according to an embodiment of the present invention.

FIG. 9 is an exemplary casino asset data file associated with the computer platform of FIG. 1, according to an embodiment of the present invention.

FIG. 10 is an exemplary asset data file associated with the computer platform of FIG. 1, according to an embodiment of the present invention.

FIG. 11 is an exemplary casino data file associated with the computer platform of FIG. 1, according to an embodiment of the present invention.

FIG. 12 is an exemplary casino QR data file associated with the computer platform of FIG. 1, according to an embodiment of the present invention.

FIG. 13 is an exemplary casino roles data file associated with the computer platform of FIG. 1, according to an embodiment of the present invention.

FIG. 14 is an exemplary loyalty tiers data file associated with the computer platform of FIG. 1, according to an embodiment of the present invention.

FIG. 15 is an exemplary kiosk data file associated with the computer platform of FIG. 1, according to an embodiment of the present invention.

FIG. 16 is an exemplary device data file associated with the computer platform of FIG. 1, according to an embodiment of the present invention.

FIG. 17 is an exemplary employee data file associated with the computer platform of FIG. 1, according to an embodiment of the present invention.

FIG. 18 is an exemplary notification data file associated with the computer platform of FIG. 1, according to an embodiment of the present invention.

FIG. 19 is an exemplary notification topic data file associated with the computer platform of FIG. 1, according to an embodiment of the present invention.

FIG. 20 is an exemplary widget header data file associated with the computer platform of FIG. 1, according to an embodiment of the present invention.

FIG. 21 is an exemplary widget data file associated with the computer platform of FIG. 1, according to an embodiment of the present invention.

FIG. 22 is a functional block diagram of a computer platform for providing patron access to multiple casino management system (CMS) accounts which may be referred to as the IVOREE platform, according to a second embodiment of the present invention.

FIG. 23 is a first architectural diagram of the computer platform of FIG. 22.

FIG. 24 is a second architectural diagram of the computer platform of FIG. 22.

FIG. 25 is an environmental view of the computer platform of FIG. 22.

FIG. 26 is a flow diagram of a sign-up process associated with the computer platform of FIG. 22.

FIGS. 27A-27G are exemplary screenshots of the sign-up process of FIG. 26.

FIGS. 28A-28C are additional flow diagrams of the sign-up process of FIG. 26.

FIG. 29 is a flow diagram of a process or algorithm associated with the computer platform of FIG. 22.

FIG. 30 is a flow diagram associated with a search feature of the computer platform of FIG. 22.

FIGS. 31A-31E are exemplary screenshots of the search process of FIG. 30.

FIGS. 32A-32C are flow diagrams associated with a favorites features associated with the computer platform of FIG. 22.

FIGS. 32D-32E are exemplary screenshots of the favorites feature of FIG. FIGS. 32A-32C.

FIG. 33 is a flow diagram with a notification feature associated with the computer platform of FIG. 22.

FIGS. 34A-34C are exemplary screenshots of the notification feature of FIG. 33.

FIG. 35 is a flow diagram with a link casino feature associated with the computer platform of FIG. 22.

FIG. 36 is an exemplary screenshot of the link casino feature of FIG. 35.

FIGS. 37A-37C are flow diagrams associated with a favorites features associated with the computer platform of FIG. 22.

FIGS. 38A-38I are exemplary screenshots of the favorites feature of FIGS. 37A-37C.

FIG. 39 is a flow diagram of a kiosk signup method associated with the computer platform of FIG. 22.

FIGS. 40A-40J are exemplary screenshots of the kiosk signup method of FIG. 39.

FIGS. 41-43 are flow diagrams for performing telemetric and analytics related to the computer platform of FIG. 22.

### DETAILED DESCRIPTION OF THE INVENTION

Referring to the figures, wherein like numerals indicate like or corresponding parts throughout the several views, a computer platform 10 for providing patrons with access to a plurality of casino management systems (CMS), which may also be referred to as a player tracking system, 50 is provided. As discussed in more detail below, each casino management system 50 may be associated with one or more casinos 52. A casino management system 50 may perform or provide many gaming and non-gaming functions within a casino 52. In the context, the term casino 52 may refer to a casino property including all of the retail, gaming and non-gaming amenities, including retail, restaurants, hotel, gaming, etc. . . . . Generally, the CMS 50 may provide accounting, including governmental reporting and player tracking and loyalty gaming-related features. For example, a CMS 50 may provide a player tracking and loyalty system in which a patron's gaming and non-gaming activities are tracked and player tracking points rewarded to the patron. As is known, the player tracking points may be utilized for predefined gaming and non-gaming activities.

In general, the computer platform 10 provides patrons access to multiple casino management systems 50 with through a common environment defined by the computer platform 10 with a single logon. The common environment defined by the computer platform 10 provides a consistent user interface and user experience. A patron does not need to access different systems with different user interfaces that provides different user experiences. Additionally, the patron does not need to recall or manage different logon details, e.g., username and passwords or other logon details/requirements.

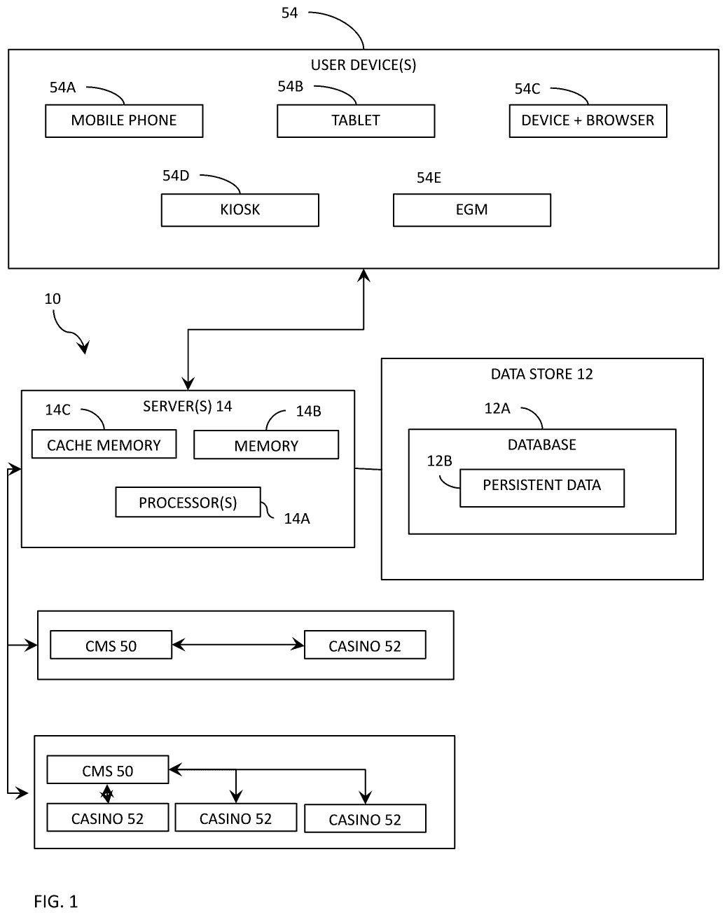

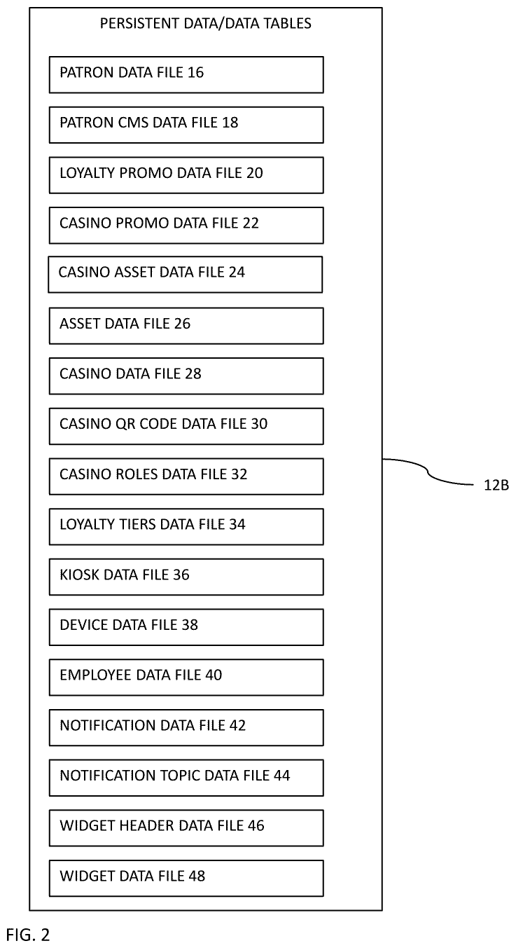

Referring to FIG. 1, the computer platform 10 includes a data store 12 that includes a database 12A and one or more content servers 14. The database 12A is used to store manage persistent data that may be arranged in one or more data tables or files 12B (see below). The one or more content servers 14 may include one or more processors 14A for executing computer instructions, various memory device(s) 14B (including one or more, or combinations of hard disk(s), solid state device(s), random access memory, read only memory (such as EEPROM, optical disks . . . ) and the like), and cache memory 14C. Cache memory 14C generally refers to memory in which data is stored temporarily, for example during a user or CMS session (see below). Generally, data stored in the cache memory 14C is deleted or removed when the need for the data is over, such as the close of a user or CMS session (see below). Cache memory 14C may be embodied in any type of memory, including for example, the one of the memory devices 14B.

The one or more content servers 14 may be located at a single location (either remote or at one of the casinos 52) or if more than one content server 14 is utilized, the content servers 14 may be distributed or located at different properties.

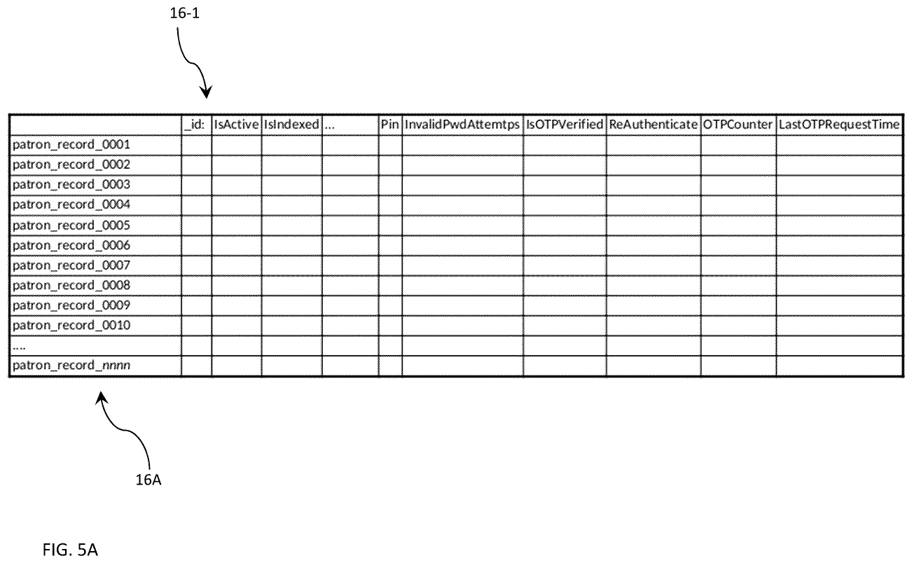

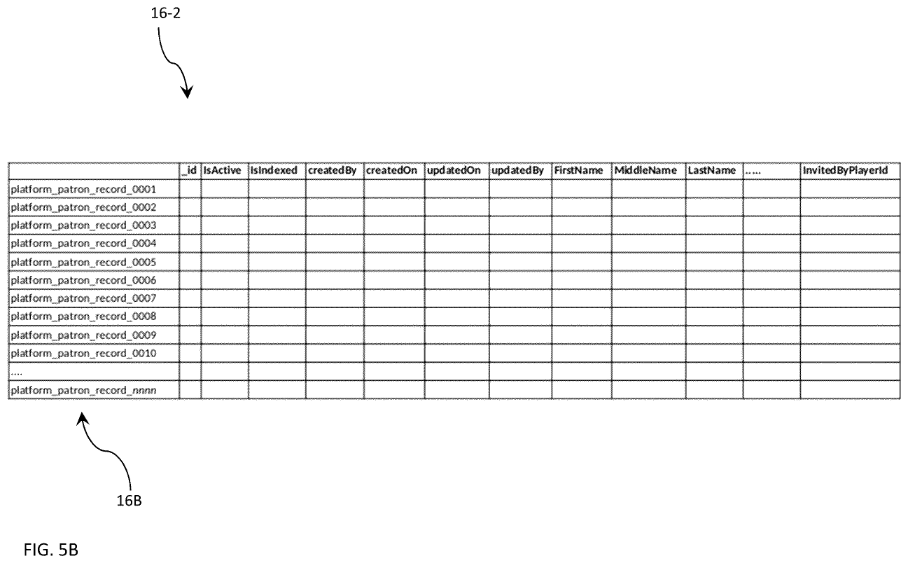

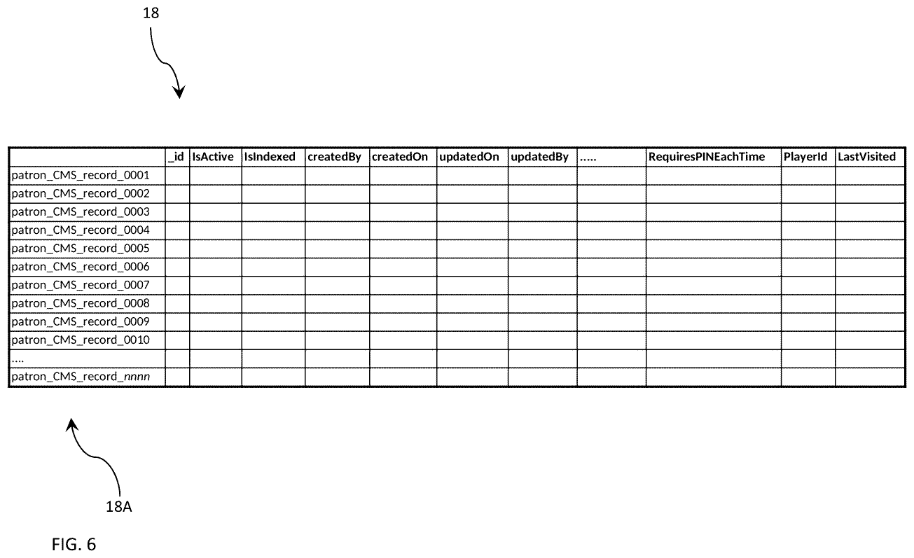

In the illustrated embodiment, the database 12A in the data store 12 includes a patron data file 16-1 and a patron CMS data file 18. With reference FIG. 5A, a portion of an exemplary patron data file 16-1 having a plurality of patron records 16A (patron_record_0001 through patron_record_nnnn) is shown. Each patron record 16A is associated with one of patrons. With reference to FIG. 6, a portion of an exemplary patron CMS data file 18 having a plurality of patron CMS configuration records 18A (patron_CMS_record_0001 through patron_CMS_record_nnnn) is shown.

Each patron record 18A is associated with one of the patrons and includes computer platform logon data. In the illustrated embodiment, there is generally only one patron record 18A for each patron. The patron record 18A contains the logon data that allows the patron to logon to the computer platform 10.

Each patron CMS configuration record is associated with one of the patrons and includes CMS logon data for an associated casino management system. In the illustrated embodiment, there may be one or more patron CMS configuration record for each patron. Each patron configuration CMS configuration record is used to manage the CMS logon details for the associated patron and one casino management system 50. So, if a patron has accounts on x casino management systems 50, there would be x patron CMS configuration records associated with that patron.

In the illustrated embodiment, the CMS logon details include the patron's account number (which may be referred to as the player tracking or loyalty account number) with the casino management system 50. Once a patron's player tracking account is integrated or linked with the patron's IVOREE account, access to the player tracking account at the casino management system 50 is handled via the connection between the computer platform 10 and the casino management system 50 (via an adapter see below, or the application programming interfaces provided at the operator or manufacturer of the casino management system 50). Generally, the patron's password or PIN number associated with the casino management system 50 is not needed once the player tracking account is integrated with the patron's account on the computer platform 10. However, it should be noted that the casino management system 50 or operator could require that a PIN number be entered every time access is requested or on a periodic basis.

In another embodiment, the CMS logon details include the patron's account number and a password or PIN.

In the illustrated embodiment, each platform patron record 16A may include the following fields:
_id: Primary key representing the unique identifier for each widget record,
IsActive: A boolean flag indicating whether the widget is currently active or not.
IsIndexed: A boolean flag indicating whether the widget data is indexed for faster retrieval.
createdBy: The user or system entity responsible for creating this widget record.
createdOn: The date and time when the widget record was created.
updatedOn: The date and time when the widget record was last updated.
updatedBy: The user or system entity responsible for the last update to this widget record,
Cognitold: A unique identifier of player in the relational database,
Enabled: Shows whether the player's account is enabled or disabled,
AccountStatus: Represents the current status of the player's account,
Email and Phone: Contact information associated with the player's account,
IsEmailVerified and IsPhoneVerified: Indicators of whether the email and phone are verified,
Created and Updated: Timestamps indicating creation and update times,
RegisteredDevices: Information about devices registered to the player's account (iphone 11, Samsung 23 etc),
DeviceKey: Key or identifier for a specific registered device, for sending notifications via firebase,
Name: Name of device,
PhoneMake, PhoneModel, PhoneOSVersion: Details about the player's mobile device.
ScreenSize: Display size of the player's device,
LastIP: IP address from which the player's account was last accessed,
LastSeen and SignOffTime: Timestamps indicating when the player was last seen and signed off,
OTP, OTPCreatedAt, OTPlnvalidAttemps: Information about one-time passwords (OTPs) for authentication,
Pin: Encrypted PIN that is used to login to the app,
InvalidPwdAttemtps: Number of unsuccessful password attempts,
IsOTPVerified: Denotes whether the OTP is verified,
ReAuthenticate: Forcing user to reauthenticate the app when opened next time,
OTPCounter: Number of OTP messages sent to the mobile, and
LastOTPRequestTime: Last OTP sent timestamp.

With reference to FIG. 5B, a platform player data file 16-2 may be utilized to provide additional patron details. The platform player data file 16-2 may include the following records.
id: Primary key representing the unique identifier for each platform patron record;
IsActive: A boolean flag indicating whether the patron account is currently active or not;
IsIndexed: A boolean flag indicating whether the patron data is indexed for faster retrieval;
createdBv: The user or system entity responsible for creating this patron record;
createdOn: The date and time when the patron record 16A was created;
updatedOn: The date and time when the patron 16A record was last updated;
updatedBv: The user or system entity responsible for the last update to this patron record 16A;
FirstName: The first name of the patron;
MiddleName: The middle name of the patron (if applicable);
LastName: The last name of the patron;
DOB: The date of birth of the patron;
Email: The email address associated with the patron account;
Phone: The contact phone number of the patron;
Address: The physical address of the patron;
AddressInfo: Additional information about the patron's address;
Nationality: The nationality or country of the patron;
CoknitoId: The unique identifier associated with the patron's Cognito identity;
Gender: The gender of the patron;
Pro fileImakeUrl: The URL of the profile image associated with the patron's account;
FavouriteDestination: Information about the patron's favorite travel destination;
Subscription: Details about the patron's subscription or membership;
ReferralCode: The referral code associated with the patron;
Identity: Information related to the patron's identity, such as identification documents or verification status;
IsSyncedWithMixpanel: A boolean flag indicating whether the patron's data is synced with Mixpanel analytics; and,
InvitedByPlayerId: The identifier of the patron who invited or referred this patron to the platform.

It should be noted that the patron records 16A may include more or less than the fields identified above.

In the illustrated embodiment, each patron CMS configuration record 18A may include the following fields:
id: Primary key representing the unique identifier for each patron CMS configuration record;
IsActive: A boolean flag indicating whether the patron CMS configuration record is currently active or not;
IsIndexed: A boolean flag indicating whether the patron CMS configuration record is indexed for faster retrieval;
createdBv: The user or system entity responsible for creating this patron CMS configuration record;
createdOn: The date and time when the patron CMS configuration record was created;
updatedOn: The date and time when the patron CMS configuration record was last updated;
updatedBv: The user or system entity responsible for the last update to this patron CMS configuration record;
CoknitoId: The unique identifier associated with the patron's Cognito identity;
CasinoTenantId: The identifier representing the specific casino tenant to which this patron CMS configuration record belongs;
AccountNumber: The account number associated with the patron's CMS account;
FirstName: The first name of the patron;
LastName: The last name of the patron;
Email: The email address associated with the patron's profile;
Phone: The contact phone number of the patron;
CurrentTier: The current tier level of the patron in the casino's loyalty program;
RequiresPINEachTime: A boolean flag indicating whether the patron is required to enter a Personal Identification Number (PIN) each time for certain actions or transactions;
PlayerId: An additional identifier for the patron, which might be different from the account number; and,
LastVisited: The date and time of the patron's last visit to the casino on IVOREE app.

It should be noted that the patron CMS configuration records 18A may include more or less than the fields identified above.

Returning to FIG. 1A, the one or more content servers 14 are coupled to the data store. Computer algorithm(s) in the form of computer instructions stored in memory 14B may be executed by the at least one processor (at one content server 14 or by or across multiple content servers 14) to perform various functions (see below) of the computer platform 10 (see below). As discussed in more detail below, the patrons may logon to the computer platform 10 using a user device 54. In one aspect of the present invention, the patron may access the computer platform 10 using a variety of user devices 54. For instance, the computer platform 10 may be accessed by a mobile phone 54A, a tablet 54B, a web browser running on a computing device (such as a desktop computer, laptop, mobile phone, tablet, or other computing device) 54C. A specific application or “app” may be provided or run on the mobile phone 54A or tablet 54B. Additionally, the computer platform 10 may be accessed by user devices 54 located within a casino 52 such as a kiosk 54B (that may provide additionally functionality) or a player interface provided on an electronic gaming machine (EGM) 54E.

As discussed above, the at least one processor 14A of the at least one content server 14 is programmed by computer instructions stored in the memory 14B to execute one or more algorithms to provide various functions to the patrons via one of the user devices 54.

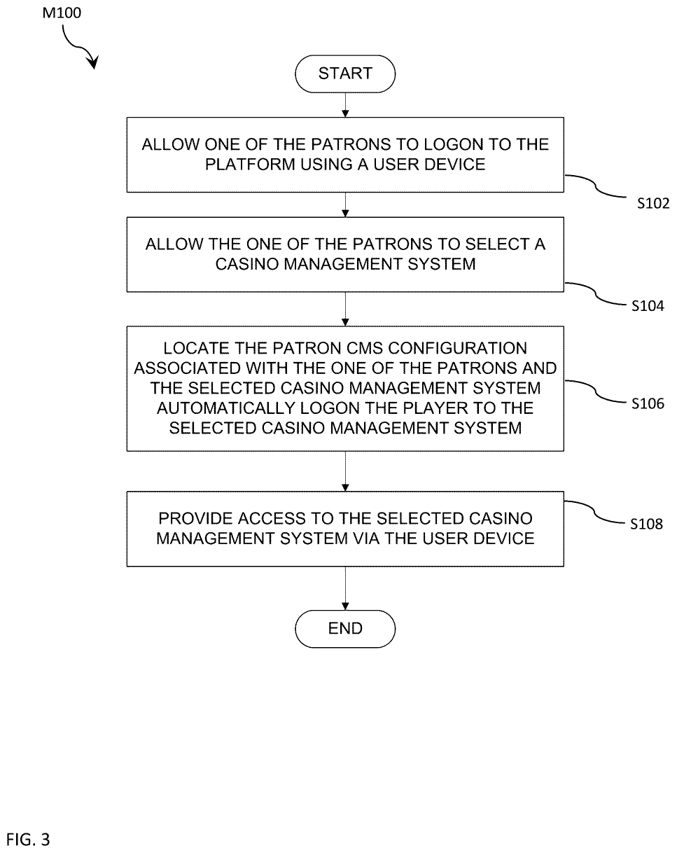

With specific reference to FIG. 3, the at least one content server 14 is programmed to provide a first method M100 to one of the patrons. In a first step S102, one of the patrons is allowed to logon onto to the computer platform 10 using a user device 54. As will be discussed in more detail below, this process may be dependent upon the user device 54 being used. For instance, the user device 54 is a mobile phone 54A or a tablet 54B, the patron may initiate the logon process by selecting or running an app (previously installed) on the mobile phone 54A or tablet 54B. Once the app is being run, the patron will be prompted to enter their logon details.

In a second step S104, the patron is allowed to select a casino management system 52. In one aspect of the present invention, the patron may be presented with the casino management systems 52 with which the patron has an account (and which is registered in the computer platform 10) and allowed to select one of the casino management systems 52 that are presented. In another aspect, the player may perform a search for a casino management system 52 in the computer platform 10.

As will be discussed in more detail below, generally the patron may have previously registered their existing account(s) at one or more casino management systems 52 within the computer platform 10. During this registration process, the patron's logon details for each casino management system 52 are entered by the patron and stored in a respective patron CMS configuration record 18A.

Once the patron has selected a casino management system 52, in a third step S106 the computer platform 10 locates the patron CMS configuration record 18A associated with the patron and the selected casino management system 52 and automatically logs the patron into the selected casino management system 52.

As will be discussed in more detail below, once the patron is logged into the selected casino management system 52, the player is provided access to the selected casino management system 52 via the user device 54. It should be noted that the features of the casino management system 52 may be defined by the operator of the casino management system 52 and may be also defined or dependent upon the type of user device 54 being used (see below). Generally, the manner in which data is exchanged, including the casino management system logon process is defined or dependent upon by the casino management system 52. For instance, data exchange between computer platform 10 may be accomplished, at least in part, by a series of application programming interfaces (API) defined by the operator (or supplier/manufacturer) of the casino management system 52.

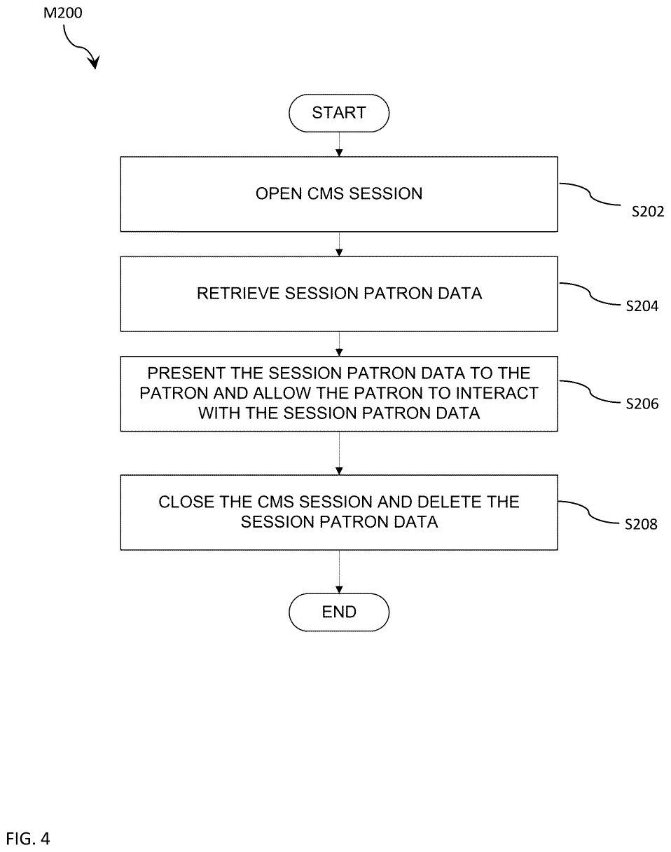

With specific reference to FIG. 4, the at least one content server 14 is programmed to provide a second method M200 to one of the patrons. The second method M200 is performed after the computer platform 10 has automatically logged the patron into the selected casino management system 52. As will be discussed in more detail below, in one aspect of the present invention data or information stored in the data store 12 is referred to as persistent data, i.e., data that is stored and/or maintained by the computer platform 10 independent of whether an associated patron is logged onto the computer platform 10 or one of the casino management systems 52. Persistent data may include some CMS data related to the casino management system 52 (see below). In one embodiment of the present invention, the persistent data may be updated periodically. In another embodiment, the persistent data is updated when the patron logs onto the computer platform 10.

Other data, i.e., data that is only needed for a short time and that is not stored persistently by the computer platform 10 may be temporarily stored in cache memory 14C.

For instance, in one aspect of the present invention, the computer platform 10 opens (and subsequently closes) a CMS session when the patron selects a casino management system 52 and automatically logs the patron into the selected casino management system 52. During the CMS session, data retrieved from the casino management system 52; data accessed by the patron; or data created during the CMS session, that is only needed during the CMS session may be temporarily stored in the cache memory 14C.

Referring again to FIG. 4, in a first step S202, a CMS session is opened. For instance, the CMS session may be opened once the player has selected one of the casino management systems 52 and the computer platform 10 has automatically logged the player into the selected casino management system 52. In a second step S204, the computer platform 10 may retrieve specific data from the casino management system 52 and/or create data based on data retrieved data, i.e., session data. In a third step S206, the session data may be presented to the patron on the user device 54 and the patron may be allowed to interact with the session data. Interacting with the session data may include viewing and/or modifying and/or performing activities based on the session data.

In a fourth step S208, the CMS session is closed in response to a patron action and deleting the session data from the cache memory 14C. The patron action resulting in the closing of the session may be a positive action for example, actively closing the session or logging out of the casino management system 52 or the computer platform 10 or a passive action, such as not interacting with the computer platform 10 for a predetermined time period.

Session data may include, but is not limited to player tracking points, casinos in range of the one of the patron's current location, active widgets associated with the casinos in range of the one of the patron's current location, tier points, personalized offers, available games, sweepstakes, VIP program, and leaderboard data (see below).

It should be noted that the patron may also interact with persistent CMS data related to the casino management system 52 and/or patron related data stored, for example, in their patron record, during a CMS session.

As will be discussed in more detail below, the data store 12 may include one or more data file 36, 38 that includes a plurality of user device records 36A, 38A. Each device record 36A, 38A may include data related to an associated device 54 or type of device for controlling settings and features of the associated device 54 used in providing access to the one of the plurality of casino management systems 52 to the one of the patrons via the user device 52.

### INDUSTRIAL APPLICABILITY

With reference to the FIGS., and in operation, a specific implementation of the computer platform 10 may be referred to as the IVOREE platform 100.

### Overview

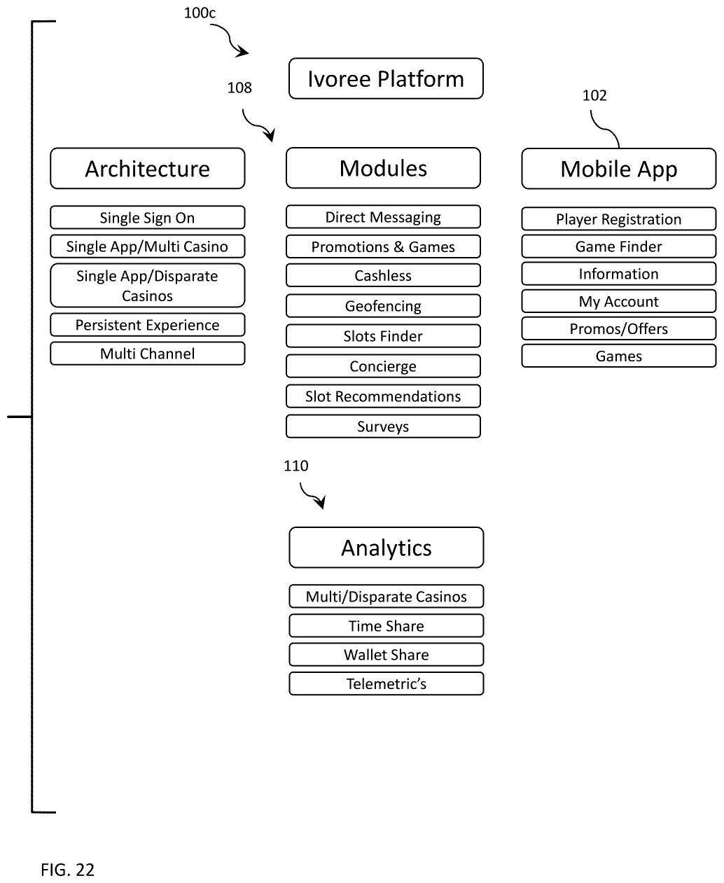

With specific reference to FIG. 22, the IVOREE platform 100 represents a unique platform that consists of an app (which may be referred to as the “One Mobile App”) 102, computer application, and website for any Casino, Resort, Operator (of any kind) in any city, state, any jurisdiction, and any regulatory body. The IVOREE platform 100 integrates a multitude of functions used within each casino, casino property or facility and across multiple casinos, casino properties or facilities (which may be located in different cities, states and/or jurisdictions under one platform. The IVOREE platform 100 may be accessed by users or patrons through multiple channels, including, but not limited, to website, kiosk (typically located onsite), tablet, computer, desktop, mobile, laptop and any device connected to the internet.

Generally, such facilities are managed by an operator. An operator may manage a single property or facility or multiple properties or facilities. The IVOREE platform 100 may support any type of operators and facilities, including but not limited to:
Tribal (Native American) Gaming Operators,
Commercial Gaming Operators,
Resorts,
Class II Gaming Operators,
Class Ill Gaming Operators,
Route Operators,
Historical Horse Racing (HHR) Gaming Operators,
VLT Gaming Operators,
Central Determinant Gaming Operators,
Horse Track—Racinos (RaceTrack+Casinos),
Dog Track—Racinos (RaceTrack+Casinos),
Gas Stations with Electronic Gaming Machines (EGMs),
Convenience Stores with Electronic Gaming Machines,
Card Rooms (Table Games Only),
Horse Racing Operators with Table Games,
And Operators with any combination of such facilities.

The IVOREE platform 100 brings together disparate gaming, casino, resort and other operator properties that traverse across states, sovereign Indian/Native tribal lands, jurisdictions, cities and across different ownership and oversight structure. Each operator may have its own loyalty program. The IVOREE platform, including the IVOREE One Mobile App, is a platform and mobile solution that has diverse set of offerings under the same platform which is not attached to one loyalty program.

When a patron visits facilities across multiple different operators within the same city/state or in a different city/state, the patron may use the same solution, i.e., the IVOREE platform to access the operator's casino management system (CMS) to interact with the associated loyalty programs. The patron is able to connect their membership in each casino management system and across different operators within the same city/state or in a different city/state. The patron is also able to “enroll” and create new membership across different operator's programs, across different operators within the same city/state or in a different city/state.

As will be discussed in more detail below, the IVOREE Platform 100 provides the patron (or guest) access to a plurality of features and abilities from the One Mobile App 102 or through the website or other device such as a kiosk or EGM. The patron is able to check their points, comps, balances, tier points, awards, rewards and other benefits using one single dashboard across multiple different and disparate operators (potentially from different cities, states and provinces).

The patron is able to check their offers, promotions, free play, bonuses, marketing vouchers, tickets and other bonusing components using one single dashboard and calendar format—across multiple different and disparate operators (potentially from different cities, states and provinces).

The patron can message securely from the One Mobile App to individual operators in a direct manner or in a broadcasting capacity, across different operators within the same city/state or in a different city/state.

Using the One Mobile App, the patron can order and secure gifts to be shipped directly to them or to be picked from the operator's facility or another location of the patron's choice, across different operators within the same city/state or in a different city/state.

Using the One Mobile App, the patron is able to use geofencing functionality to visit individual operator's physical location and “check-in” to offers, promotions, bonusing, gifting program etc . . . , across different operators within the same city/state or in a different city/state.

Patrons can use their points, loyalty rewards and benefits from disparate operators, within the same city/state or in a different city/state to redeem prizes, awards, experiences (shows, cruises, hotel stays etc.) or other objects. Patrons can transfer points, loyalty rewards and benefits from disparate operators, within the same city/state or in a different city/state for other types of loyalty programs unrelated to operators—including but not limited to ride-share, other hotel membership loyalty programs, other credit card loyalty programs, etc. Patrons can also transfer points, loyalty rewards and benefits from disparate operators, within the same city/state or in a different city/state to gift cards, electronic cards, pre-paid cards, value-oriented credit/debit cards which may be used at various merchants.

The IVOREE platform 100 utilizes unique identifiers (such as phone number and/or email) to enable validation of a patron's identity and connecting the patron(s) to disparate operators, within the same city/state or in a different city/state. The IVOREE platform 100 brings together disparate loyalty programs, player tracking systems, point of sale systems, retail systems, hotel systems, valet parking systems, gas station systems, convenience store systems, other 3rd party establishment systems, affiliate systems, channel partner systems together using the patron's unique identifier without requiring that the patron recall or independently logon to the different systems (or casino management systems) independently.

The IVOREE platform 100 dissolves the boundaries between disparate operators, within the same city/state or in a different city/state and their affiliates—that are unrelated to each other, to provide the guest with a unified experience.

The IVOREE platform 100 allow patrons to logon using the unified logon parameters above in a singular manner, across various portals, i.e., kiosks, website, tablets, mobile devices, laptops, desktops and other computer systems, between disparate operators, within the same city/state or in a different city/state and their affiliates that are unrelated to each other, to provide the patron with a unified experience.

The IVOREE platform allows patron(s) to update, modify, change and revise their personal information (including but not limited to mailing/billing address, zip code, phone number, PIN, password, email address) in a singular manner and disseminate/update that information to multiple relevant parties that the guest is affiliated with—between disparate operators, within the same city/state or in a different city/state and their affiliates—that are unrelated to each other, to provide the patron with a unified experience.

The IVOREE platform 100 may further establish guest influencer, group, family, friends and decision maker circles using unique traits such as shared IP addresses (for electronic, mobile, tablet and computer devices), internet connectivity, home address, zip code, shared credit card, debit card information in a singular manner—between disparate operators, within the same city/state or in a different city/state and their affiliates—that are unrelated to each other, to provide the guest with a unified experience.

The IVOREE platform 100 may also a patron to pay for non-gaming related services, goods, experiences, and merchandise using cashless payment technologies that are connected through the IVOREE platform 100 across disparate operators, within the same city/state or in a different city/state. Further, using the IVOREE platform 100 patrons may watch experiences—including concerts, live events, delayed events, previously recorded events, performances that are connected through the IVOREE platform 100 across disparate operators, within the same city/state or in a different city/state.

### Architecture

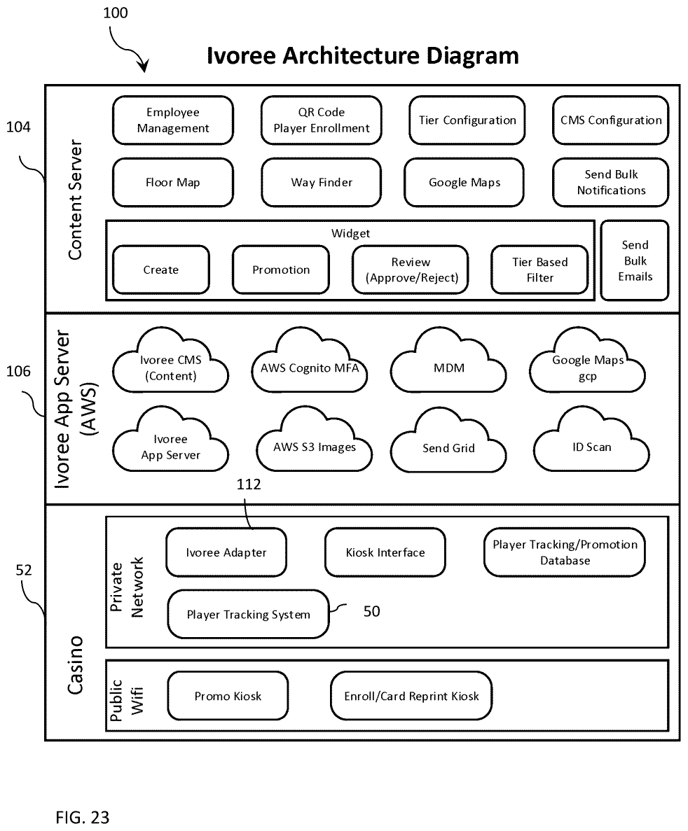

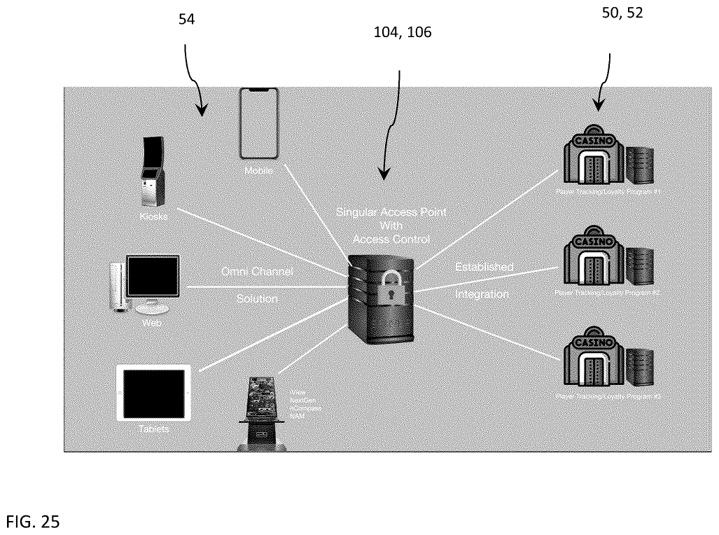

With reference to FIGS. 23-25, an exemplary structural and function architecture of the IVOREE platform 100 is shown. With specific reference to FIG. 22, the functions provided by the IVOREE platform 100 may be provided by a series of functional modules 108 and analytic modules 110. The function modules 108 may include:
a direct messaging module,
a promotions and games module,
a cashless module,
a geofencing module,
a slots finder module,
a concierge module,
a slot recommendations module, and
a surveys module.

The analytic modules 110 may include:
a multi/disparate casinos module,
a time share module,
a wallet share module, and
a telemetric s module.

As shown and described above, the architecture of the IVOREE platform 102 allows for a single sign on (or logon) through the IVOREE platform 100 to provide access multiple casino management systems 50 (or disparate casinos or operators) to provide a persistent experience. Patrons can access the IVOREE platform 100 through multiple channels (see above).

The One Mobile App 102 may provide patrons access to the features or modules of the IVOREE platform 100, including, but not limited to: player registration, game finder, information, my account, promos/offers and games.

With specific reference to FIGS. 23, in one embodiment the IVOREE platform 102 is embodied or implemented by a content server 104 and an app server 106. The IVOREE platform 102 may also be partially implemented by software located at, and running on various devices, at the casino(s).

The content server 104 is used to build and manage the necessary content by the casino or casino management system 50 that would be used to show on the mobile devices, tablet-kiosk devices, player portal, point-of-play at EGM/table (iVIEW, DM, UGA, Sentinel, nCompass, NextGen etc.), WebOS. The content server 104 may have the following high-level components:
an employee facing application,
support of Multi-Tenant and multi role
Corporate and or Casino Level Authentication and Authorization—User can see only the Casinos he/she has access to,
Employee Management—Add/edit employee and their roles,
QR Code—Define QR code(s) that defines players to enroll,
Tier Configuration—Manager Tiers, assign widgets, manage the sequence of the widget, add player card color,
CMS Configuration—Add/Edit CMS endpoint configuration,
Floor Map—Create map, assign asset to mimic the actual floor configuration,
Way Finder—Configure way finder,
Games—Define game/promotions and manage the player eligibility, and
Google Map—To define the casino geofence.

The app server 106 is the core component of the application for sharing the data or configuration. In one embodiment, the app server 106 is implemented using Amazon Web Services and is a serverless deployment running behind a load balancer.

At the casino, the IVOREE platform 100 includes an adapter 112 that runs inside the casino premises. The adapter 112 connects the app server 106 to the casino management system 50, typically, using the casino management system 50 application programming interfaces (API).

The One Mobile App 102 is the player facing mobile and/or tablet-kiosk solution and/or widget at the point-of-play (EGM/table).

### Data Tables

With reference to FIGS. 5-21, in the illustrated embodiment the IVOREE platform utilizes a number of data tables 12B. The data tables 12B includes the patron data table 16 and the patron CMS data file 18 described above.

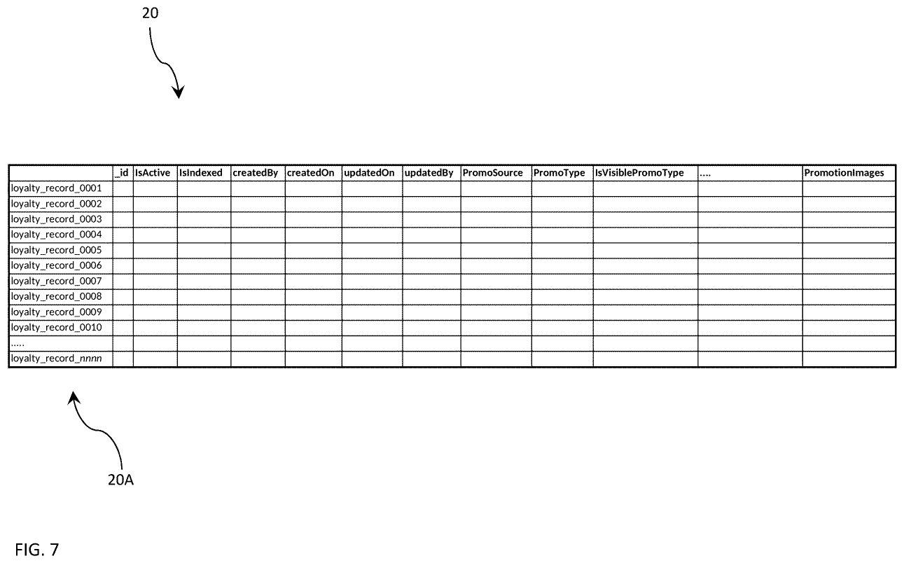

With specific reference to FIG. 7, an exemplary loyalty promotion data file or table 20 is shown. The loyalty promotion data table 20 includes a plurality of loyalty promo records (loyalty_record_0001 through loyalty_record_nnnn) 20A. The loyalty promotion data table 20 may be used to manage and store information about various promotions offered by the casino's player loyalty system. Promotions can include discounts, special offers, and incentives to attract and retain players. The loyalty promotion data table 20 facilitates the configuration and display of promotion details, including dates, eligibility criteria, and visual assets. In the illustrated embodiment, the loyalty promotion data table 20 may include the following fields:
_id: Primary key representing the unique identifier for each loyalty promo record,
IsActive: A boolean flag indicating whether the promotion is currently active or not,
IsIndexed: A boolean flag indicating whether the promotion data is indexed for faster
retrieval,
createdBy: The user or system entity responsible for creating this loyalty promo record,
createdOn: The date and time when the loyalty promo record was created,
updatedOn: The date and time when the loyalty promo record was last updated,
updatedBy: The user or system entity responsible for the last update to this loyalty promo record,
PromoSource: The source of the promotion (e.g., CMP, Konami, Aristrocrat etc),
PromoType: The type or category of the promotion (e.g., free play, madx, drawing, discount, free spins, cashback etc),
IsVisiblePromoType: A boolean flag indicating whether the promo type is visible,
CasinoTenentId: The identifier representing the specific casino tenant associated with the promotion,
PromotionCode: The code or identifier associated with the promotion,
IsVisiblePromoCode: A boolean flag indicating whether the promotion code is visible,
PromotionName: The name or title of the promotion,
PromotionId: The unique identifier for the promotion,
PromoValue: The value or amount of the promotion (e.g., discount percentage, cash value),
JackpotValue: The value or amount of the jackpot associated with the promotion (if applicable),
PromotionStartDate: The start date and time of the promotion,
PromotionEndDate: The end date and time of the promotion,
IsPromoRunning: A boolean flag indicating whether the promotion is currently running,
PromoStatus: The status of the promotion (e.g., pending, active, expired),
ApprovalRemarks: Remarks or comments related to the promotion approval process,
thumbnailURL: The URL of the thumbnail image associated with the promotion,
detailURL: The URL of the detailed page for the promotion,
PromoMessage: The message or content of the promotion,
RejectionReason: The reason for the rejection of the promotion (such as typo), and
Promotionlmages: Additional images or media related to the promotion,

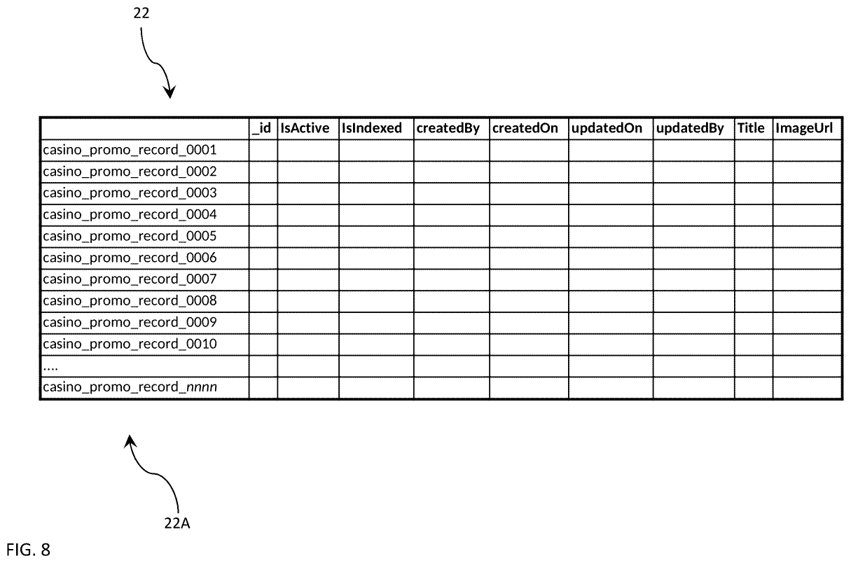

With specific reference to FIG. 8, an exemplary casino promo data file or table loyalty promotion data file or table 22 is shown. The casino promo data table 22 includes a plurality of casino promo records (casino_promo_record_0001 through casino_promo_record_nnnn) 22A. The casino promo promotion data table 22 may be used to highlight specific content, promotions, or events on the casino's website or app. The spotlight items are typically featured prominently to attract user attention and engagement. In the illustrated embodiment, the casino promo data table 22 may include the following fields:
_id: Primary key representing the unique identifier for each spotlight record,
IsActive: A boolean flag indicating whether the spotlight is currently active or not,
IsIndexed: A boolean flag indicating whether the spotlight data is indexed for faster
retrieval,
createdBy: The user or system entity responsible for creating this spotlight,
createdOn: The date and time when the spotlight was created,
updatedOn: The date and time when the spotlight was last updated,
updatedBy: The user or system entity responsible for the last update to this spotlight,
Title: The title or headline associated with the spotlight, and,
ImageUrl: The URL of the image used for the spotlight display.

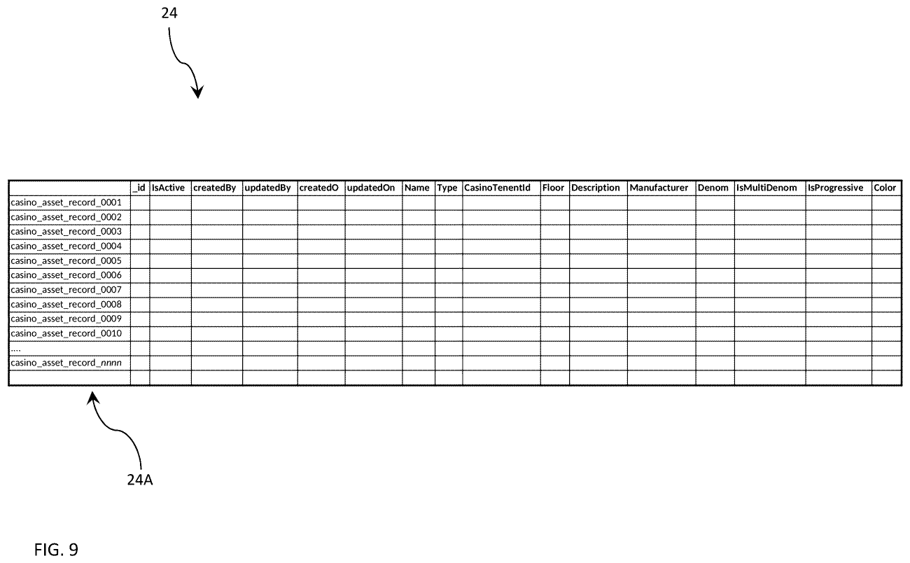

With specific reference to FIG. 9, an exemplary casino asset data file or table 24 is shown. The casino asset data file or table 24 includes a plurality of casino asset records (casino_asset_record_0001 through casino_asset_record_nnnn) 24A. The casino asset data table 24 may be used to manage and store information about various assets within the casino, such as gaming machines and table games. In the illustrated embodiment, the casino asset data table 24 may include the following fields:
_id: Primary key representing the unique identifier for each casino asset record,
IsActive: A boolean flag indicating whether the casino asset record is currently active or not,
createdBy: The user or system entity responsible for creating this casino asset record,
updatedBy: The user or system entity responsible for the last update to this casino asset record,
createdOn: The date and time when the casino asset record was created,
updatedOn: The date and time when the casino asset record was last updated,
Name: The name or identifier of the asset,
Type: The type or category of the asset (e.g., slot machine, table game, electronic gaming machine),
CasinoTenentId: The identifier representing the specific casino tenant to which this asset belongs,
Floor: The floor or location within the casino where the asset is located,
Description: A brief description or additional details about the asset,
Manufacturer: The manufacturer or company that produced the asset,
Denom: The denomination or value associated with the asset (e.g., for slot machines, the bet denomination),
IsMultiDenom: A boolean flag indicating whether the asset supports multiple denominations,
IsProgressive: A boolean flag indicating whether the asset is part of a progressive jackpot system, and
Color: The color or color scheme associated with the asset.

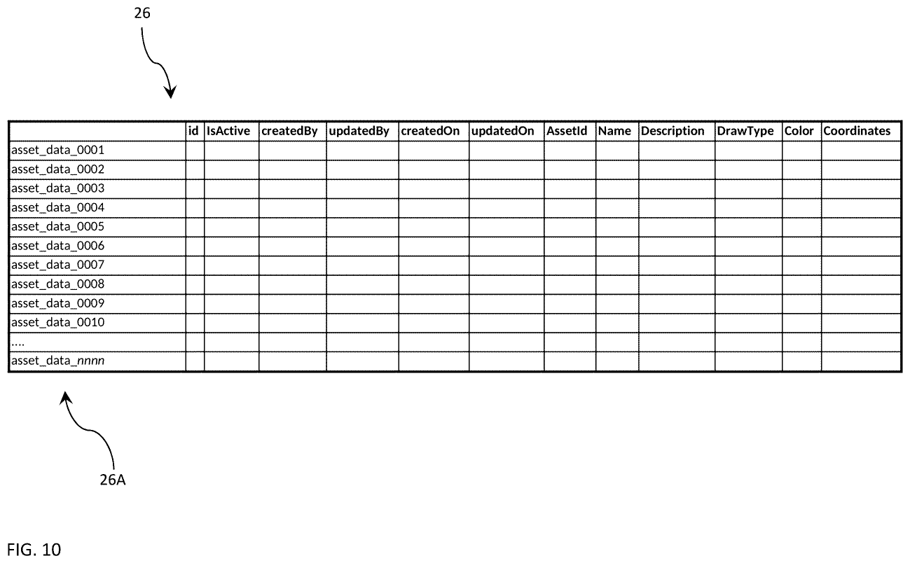

With specific reference to FIG. 10, an exemplary asset data file or table 26 is shown. The asset data file or table 26 includes a plurality of casino asset records (asset_record_0001 through asset_record_nnnn) 26A. The asset data table 26 may be used to manage and store information about individual items or components that are part of larger assets, such as different area, restaurant, restroom etc and manage the coordinates to create a virtual map on the app to manage and store information about various assets within the casino, such as gaming machines and table games. In the illustrated embodiment, the asset data table 26 may include the following fields:
id: Primary key representing the unique identifier for each casino asset record,
IsActive: A boolean flag indicating whether the asset item is currently active or not,
createdBy: The user or system entity responsible for creating this casino asset record,
updatedBy: The user or system entity responsible for the last update to this casino asset record,
createdOn: The date and time when the casino asset record was created,
updatedOn: The date and time when the casino asset record was last updated,
AssetId: Foreign key referencing the _id of the table, representing the parent asset to which this item belongs,
Name: The name or identifier of the casino asset record,
Description: A brief description or additional details about the asset item,
DrawType: The type of draw or presentation associated with the asset item (e.g., point, circle, rectangle etc),
Color: The color or color scheme associated with the asset item, and
Coordinates: The specific coordinates or positioning data related to the asset item within the parent asset (this can be used to determine the location of the item on the gaming floor or within the casino environment).

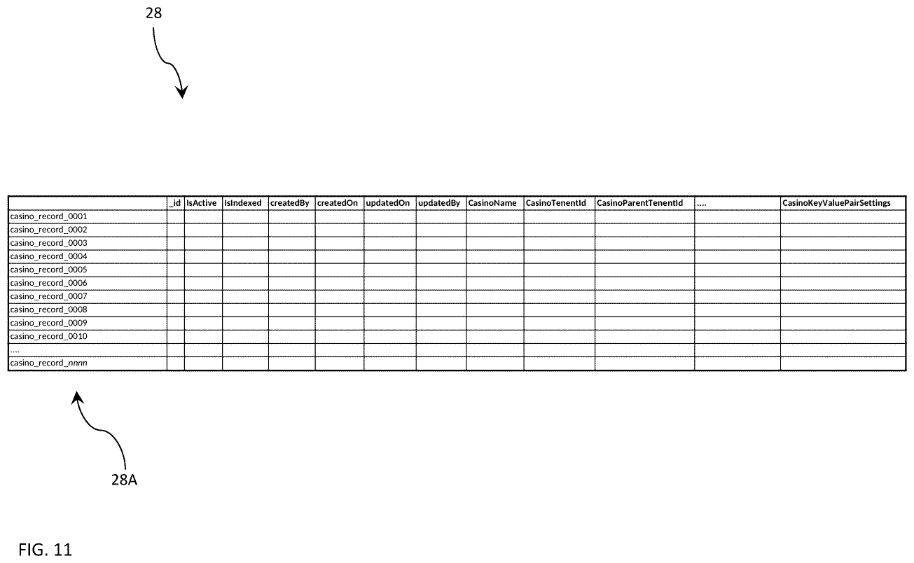

With specific reference to FIG. 11, an exemplary casino data file or table 28 is shown. The casino data file or table 28 includes a plurality of casino records (casino_record_0001 through casino_record_nnnn) 28A. The casino data table 28 may be used to manage and store casinos master information. There are 2 types of casinos that are supported by the IVOREE platform 100: (1). single Casino and (2) corporate casino. A corporate casino is more than 1 single casino under one corporate entity. The advantages of defining corporate casinos is to share player loyalty, share employees across casino, run games, etc. . . . In the illustrated embodiment, the casino data table 28 may include the following fields:
_id: Primary key representing the unique identifier for each casino record,
IsActive: A boolean flag indicating whether the casino is currently active or not,
IsIndexed: A boolean flag indicating whether the casino data is indexed for faster retrieval,
createdBy: The user or system entity responsible for creating this casino record,
createdOn: The date and time when the casino record was created,
updatedOn: The date and time when the casino record was last updated,
updatedBy: The user or system entity responsible for the last update to this casino record,
CasinoName: The name or title of the casino,
CasinoTenentId: The unique identifier associated with the casino's tenant,
CasinoParentTenentId: The identifier representing the parent tenant of the casino (if Corporate type only),
CasinoType: The type or category of the casino (e.g., single, corporate, online, sports betting etc),
CasinoImage: The image representing the casino, such as a logo or promotional image.
MessageImage: An image used for displaying messages or notifications related to the casino,
DefaultAssetImage: The default image used for assets within the casino,
CasinoWebSiteURL: The website URL of the casino,
AllowAnywhereAccount: A boolean flag indicating whether accounts can be created from anywhere (e.g., outside the casino premises),
AllowInsideCasinoAccount: A boolean flag indicating whether accounts can be created only from inside the casino premises,
ToolTipText: Additional tooltip text or information associated with the casino,
GeoLocation: The geographical location or coordinates of the casino,
CasinoOtp: Master One-time password (OTP) settings specific to the casino, casino can use this to override the player's OTP in case the patron never received OTP or has network issue(s),
CasinoAddress: The physical address of the casino location,
ThemeBgdColor: The background color used in the casino's theme,
VideoTourLink3D: A link to a 3D video tour of the casino,
CRMIntegration: Information/settings about the integration of the Casino's CMS system
CasinoGeoFence: Geofencing settings and details for the casino, this is used for drawing, running games within Geolocation, casino onsite check-in offers etc,
Facilities: The facilities and amenities offered by the casino,
CardOptions: Options and settings related to casino cards (e.g., player cards),
PaymentGateways: Information about payment gateways used for transactions in the casino,
WorkingHours: The operating hours of the casino,
FirebaseTopics: Topics related to Firebase, a mobile and web application development platform,
KioskPassword: Password settings for kiosk devices within the casino,
OperationalHours: Additional details about the casino's operational hours,
VisibilityRadius: The radius within which the casino is visible or accessible on the mobile app,
IsSaveIdFrontPage: A boolean flag indicating whether identification information is saved on the front page,
AppTheme: The theme used in the casino's mobile application,
WidgetDefaultColor: The default color scheme for widgets in the casino's application.
CasinoMapList: A list of maps associated with the casino,
VideoUploadMaxSize: The maximum allowed size for video uploads,
ImageUploadMaxSize: The maximum allowed size for image uploads,
AboutCasino: Information about the casino's background and details,
ResortView: Views and settings related to the resort associated with the casino,
CasinoBaseBuckets: Base buckets or settings specific to the casino,
EasypromosOrganizationName: Information about the EasyPromos organization associated with the casino,
EasypromosWebhookKey: Webhook key used for EasyPromos integration,
PromotionPrizeNotificationMessage: Notification message related to promotion prizes,
PromotionsProcessingInfo: Information about the processing of promotions,
AssociatedCasino: Details about associated casinos, if applicable,
CasinoTimeZone: The timezone setting for the casino,
ShowTitle: A boolean flag indicating whether to display the casino title,
ThemeSettings: Additional settings related to the casino theme.
AppLabel: The label used for the casino's mobile application.
AccountInfoAppLabel: The label used for account information in the mobile application.
CasinoViewType: The type of view used for the casino,
CasinoDetailTemplate: The template used for casino details,
PinKeyScrambling: Settings related to PIN key scrambling,
AppKeyboardType: The type of keyboard used in the mobile application,
PromoKioskSiginButtonTitles: Titles or labels used for kiosk sign-in buttons during promotions,
PinRequired: A boolean flag indicating whether a PIN is required for certain actions, and,
CasinoKeyValuePairSettings: Key-value pair settings specific to the casino. Any generic settings or labels can be added to Key Value Pair

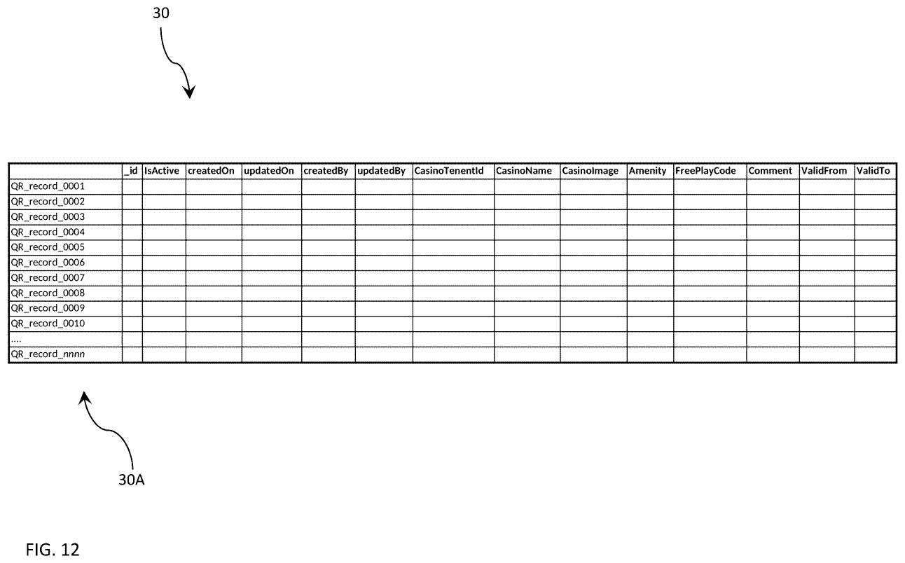

With specific reference to FIG. 12, an exemplary casino QR code data file or table 30 is shown. The casino QR code data file or table 30 includes a plurality of QR records (QR_record_0001 through QR_record_nnnn) 30A. The casino QR code data table 30 may be used to store data related to QR codes specific to a casino, which can be scanned by users to access certain promotions, offers, amenities, or services. The QR codes may be utilized for various purposes, such as marketing campaigns, guest access to events, redeeming free play, or accessing exclusive content. In the illustrated embodiment, the casino QR Code data table 30 may include the following fields:
_id: Primary key representing the unique identifier for each QR code record,
IsActive: A boolean flag indicating whether the QR code is currently active or not,
createdOn: The date and time when the QR code record was created,
updatedOn: The date and time when the QR code record was last updated,
createdBy: The user or system entity responsible for creating this QR code record,
updatedBy: The user or system entity responsible for the last update to this QR code record,
CasinoTenentId: The identifier representing the specific casino tenant associated with this QR code,
CasinoName: The name or title of the casino,
CasinoImage: The image or logo representing the casino in the QR code,
Amenity: Information about the specific amenity or service associated with the QR code (e.g., a particular attraction, event, or offer),
FreePlayCode: If applicable, a code associated with free play or promotional credit for the casino,
Comment: Additional comments or notes related to the QR code,
ValidFrom: The date and time when the QR code becomes valid and can be used, and
ValidTo: The date and time until which the QR code remains valid and usable.

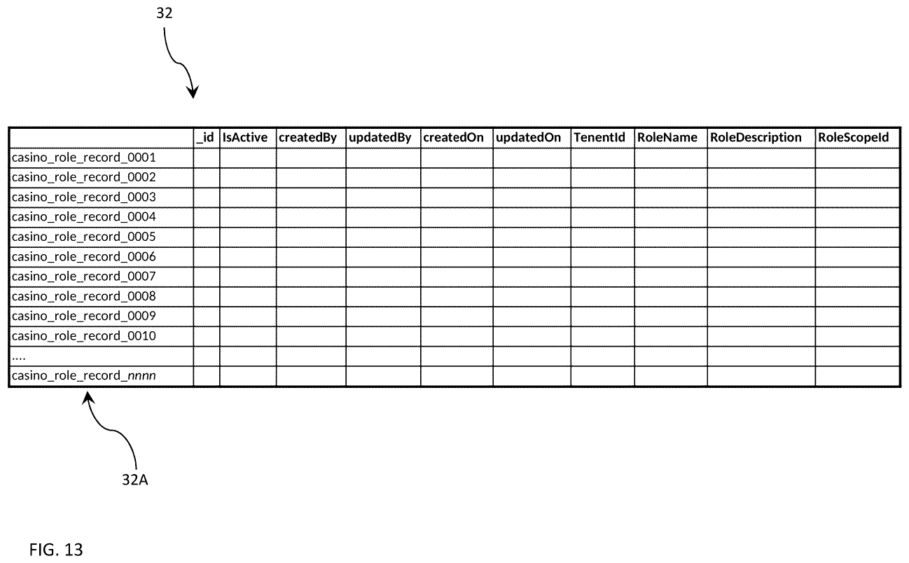

With specific reference to FIG. 13, an exemplary casino roles data file or table 32 is shown. The casino roles data file or table 32 includes a plurality of casino role records (casino_role_record_0001 through casino_role_record_nnnn) 32A. The casino role data table 32 may be used to manage and store information about different roles or job positions within the casino. These roles can represent various responsibilities, permissions, and access levels for employees or users within the casino's management and operational structure. The table may be used to control user access and privileges throughout the casino's systems and applications. In the illustrated embodiment, the casino roles data table 32 may include the following fields:
_id: Primary key representing the unique identifier for each casino role record,
IsActive: A boolean flag indicating whether the casino role is currently active or not,
createdBy: The user or system entity responsible for creating this casino role,
updatedBy: The user or system entity responsible for the last update to this casino role,
createdOn: The date and time when the casino role was created,
updatedOn: The date and time when the casino role was last updated,
TenentId: The identifier representing the specific casino tenant to which this role belongs,
RoleName: The name or title of the role that employee would be assigned to, for example Admin, Manager, Employee etc,
RoleDescription: A brief description or additional details about the casino role, and
RoleScopeId: An identifier representing the scope or level of the casino role, which might be used for role hierarchy or access control purposes.

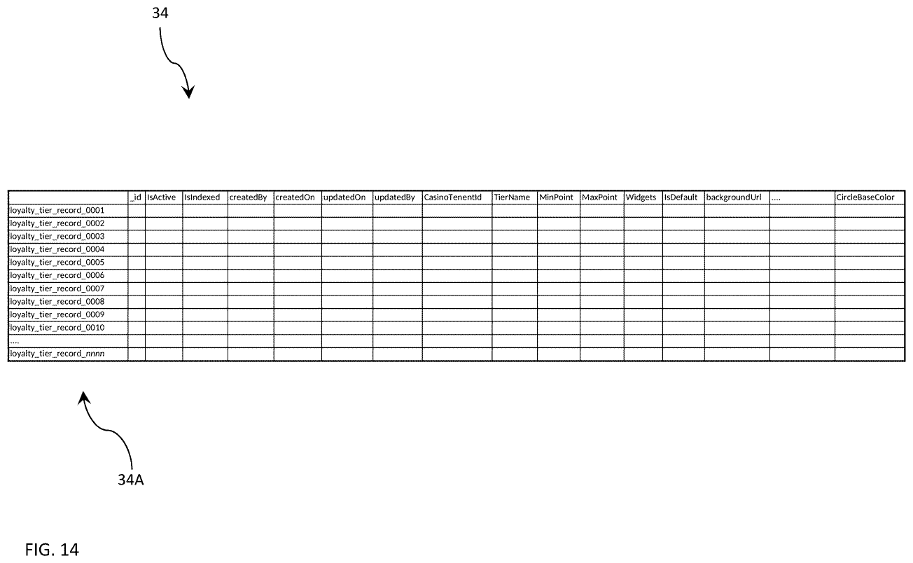

With specific reference to FIG. 14, an exemplary loyalty tiers data file or table 34 is shown. The loyalty tiers data file or table 34 includes a plurality of casino role records (loyalty_tier_record_0001 through loyalty_tier_record_nnnn) 34A. The loyalty tiers data table 34 may be used to manage and store information about different tiers or levels in the casino's loyalty program. Patrons may progress through these tiers based on their accumulated points, and each tier may offer different rewards, benefits, or privileges. The loyalty tiers data file 34 facilitates the organization and configuration of various tier-related settings and visuals to manage and store information about different roles or job positions within the casino. In the illustrated embodiment, the loyalty tiers data table 34 may include the following fields:
_id: Primary key representing the unique identifier for each loyalty tier record,
IsActive: A boolean flag indicating whether the casino tier is currently active or not,
IsIndexed: A boolean flag indicating whether the casino tier data is indexed for faster retrieval,
createdBy: The user or system entity responsible for creating this loyalty tier record,
createdOn: The date and time when the loyalty tier record was created,
updatedOn: The date and time when the loyalty tier record was last updated,
updatedBy: The user or system entity responsible for the last update to this casino tier,
CasinoTenentId: The identifier representing the specific casino tenant to which this tier belongs,
TierName: The name or title of the casino tier,
MinPoint: The minimum points required for a player to attain this tier,
MaxPoint: The maximum points allowed for a player to be part of this tier,
Widgets: Information about widgets associated with this tier,
IsDefault: A boolean flag indicating whether this tier is the default tier for the casino's loyalty program,
backgroundUrl: The URL of the background image associated with this tier,
BackgroundColor: The background color used for this tier,
AboutTier: Information or description about this casino tier,
IconUrl: The URL of the icon image representing this tier,
ShowImage: A boolean flag indicating whether to display an image for this tier,
ShowCircleAroundIcon: A boolean flag indicating whether to display a circle around the icon,
CircleColor: The color of the circle displayed around the icon, and,
CircleBase Color: The base color for the circle around the icon.

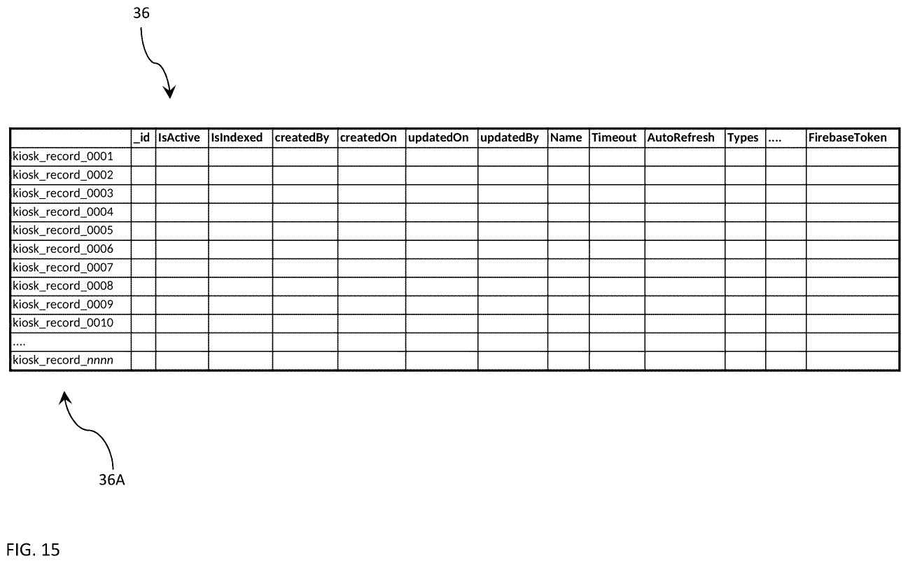

With specific reference to FIG. 15, an exemplary kiosk data file or table 36 is shown. The kiosk data file or table 36 includes a plurality of kiosk records (kiosk_record_0001 through kiosk_record_nnnn) 36A. The kiosk data table 36 may be used to manage and store information about various kiosks within the casino. Kiosks can provide self-service functionalities for players, such as account information, promotions, rewards, printing player cards, enrollment or survey. The table facilitates the configuration and control of kiosk settings and features. In the illustrated embodiment, the kiosk data table 36 may include the following fields:
_id: Primary key representing the unique identifier for each kiosk record,
IsActive: A boolean flag indicating whether the kiosk is currently active or not,
IsIndexed: A boolean flag indicating whether the kiosk data is indexed for faster retrieval,
createdBy: The user or system entity responsible for creating this kiosk,
createdOn: The date and time when the kiosk was created,
updatedOn: The date and time when the kiosk was last updated,
updatedBy: The user or system entity responsible for the last update to this kiosk,
Name: The name or identifier of the kiosk,
Timeout: The duration of inactivity allowed before the kiosk automatically logs out,
AutoRefresh: A boolean flag indicating whether the kiosk content should auto-refresh periodically,
Types: Information about the types or categories associated with the kiosk,
CasinoTenentId: The identifier representing the specific casino tenant to which this kiosk belongs,
LogoutMessageTimeout: The duration for displaying the logout message before the kiosk logs out due to inactivity,
CardPrinterName: The name or identifier of the card printer associated with the kiosk (if applicable),
LastCommunicatedTime: The date and time of the last communication or interaction with the kiosk, and,
FirebaseToken: The token used for Firebase communication or integration with the kiosk.

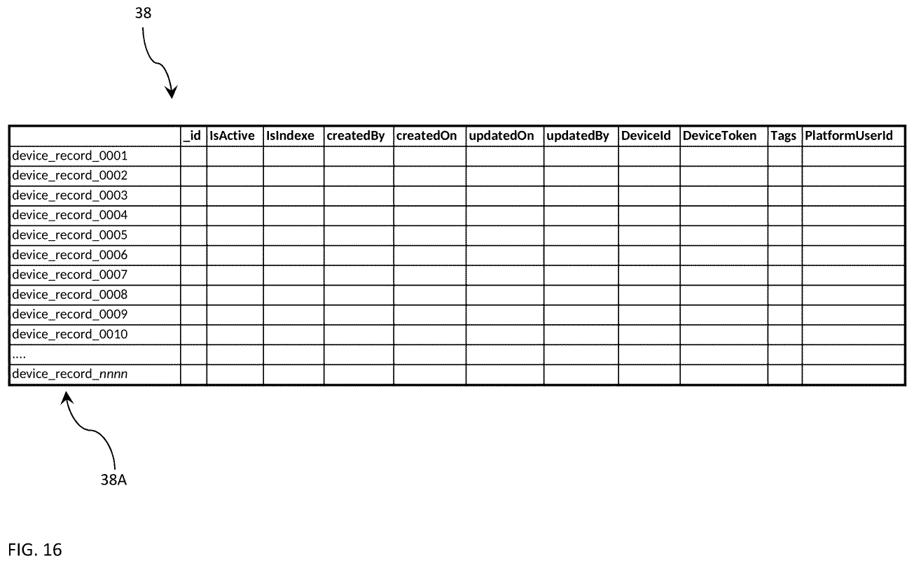

With specific reference to FIG. 16, an exemplary device data file or table 38 is shown. The device data file or table 38 includes a plurality of device records (device_record_0001 through device_record_nnnn) 38A. The device data table 38 may be used to manage and store information about various devices registered on a platform or application. Devices can include mobile phones, tablets, or other smart devices used by platform users. The table facilitates the organization and retrieval of device-related data, such as tokens for push notifications and user associations manage and store information about various kiosks within the casino. Kiosks can provide self-service functionalities for players, such as account information, promotions, rewards, printing player cards, enrollment or survey. In the illustrated embodiment, the device data table 38 may include the following fields:
_id: Primary key representing the unique identifier for each device record,
IsActive: A boolean flag indicating whether the device is currently active or not,
IsIndexed: A boolean flag indicating whether the device data is indexed for faster retrieval,
createdBy: The user or system entity responsible for creating this device record,
createdOn: The date and time when the device record was created,
updatedOn: The date and time when the device record was last updated,
updatedBy: The user or system entity responsible for the last update to this device record,
DeviceId: The unique identifier associated with the device,
DeviceToken: The token or key used for device identification and communication (e.g., push notifications),
Tags: Optional tags or labels associated with the device, used for categorization or grouping, and
PlatformUserId: The unique identifier of the user associated with the device on the platform.

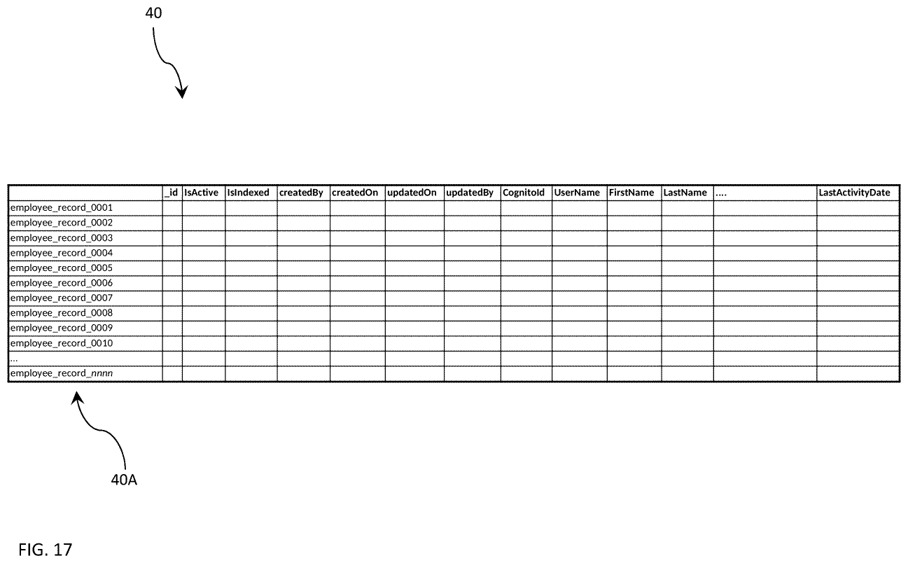

With specific reference to FIG. 17, an exemplary employee data file or table 40 is shown. The employee data file or table 40 includes a plurality of employee records (employee_record_0001 through employee_record_nnnn) 40A. The employee data table 40 may be used to manage and store information about employees registered on the platform or application. Employees can have various roles and permissions, and the table facilitates user authentication, access control, and employee activity tracking. In the illustrated embodiment, the employee data table 40 may include the following fields:
_id: Primary key representing the unique identifier for each employee record,
IsActive: A boolean flag indicating whether the employee is currently active or not,
IsIndexed: A boolean flag indicating whether the employee data is indexed for faster retrieval,
createdBy: The user or system entity responsible for creating this employee record,
createdOn: The date and time when the employee record was created,
updatedOn: The date and time when the employee record was last updated,
updatedBy: The user or system entity responsible for the last update to this employee record,
Cognitold: The unique identifier associated with the employee's Cognito identity,
UserName: The username of the employee for authentication and login purposes,
FirstName: The first name of the employee,
LastName: The last name of the employee,
Email: The email address associated with the employee,
Phone: The contact phone number of the employee,
Roles: The roles or permissions assigned to the employee in the platform,
IsCoginitoIDVerified: A boolean flag indicating whether the Cognito identity of the employee is verified,
CountryCode: The country code associated with the employee's phone number,
Status: The status of the employee (e.g., active, inactive, on leave, etc.),
Password: The password for the employee's account,
OTP: One-time password (OTP) associated with the employee's account for additional security,
OTPTime: The date and time when the OTP was generated,
LastLoginDate: The date and time of the employee's last login to the platform,
NoOTPSentToday: The number of OTPs sent to the employee's account on the current day, and,
LastActivityDate: The date and time of the employee's last activity on the platform.

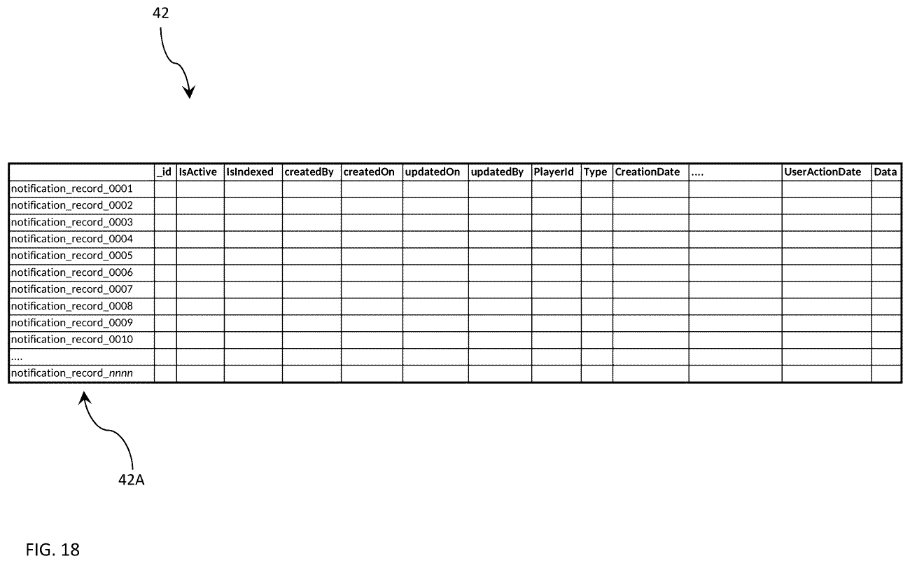

With specific reference to FIG. 18, an exemplary notification data file or table 42 is shown. The notification data file or table 42 includes a plurality of notification records (notification_record_0001 through notification_record_nnnn) 42A. The notification data table 42 may be used to manage and store information about various notifications sent to players or users on the platform along with the status of message delivery. Notifications can be in different formats and may include messages, alerts, or updates. The table facilitates the organization and tracking of notification details and delivery status. In the illustrated embodiment, the notification data table 42 may include the following fields:
_id: Primary key representing the unique identifier for each notification record,
IsActive: A boolean flag indicating whether the notification is currently active or not,
IsIndexed: A boolean flag indicating whether the notification data is indexed for faster retrieval,
createdBy: The user or system entity responsible for creating this notification record,
createdOn: The date and time when the notification record was created,
updatedOn: The date and time when the notification record was last updated,
updatedBy: The user or system entity responsible for the last update to this notification record,
PlayerId: The unique identifier associated with the player who will receive the notification,
Type: The type or category of the notification (e.g., email, push notification, SMS),
CreationDate: The date and time when the notification was created,
SendingDate: The date and time when the notification will be sent,
Status: The status of the notification (e.g., pending, sent, failed, delivered),
ErrorDescription: A description of any error that occurred during notification delivery.
Title: The title or subject of the notification,
MessageContent: The content or body of the notification message,
SourceType: The type of the source from which the notification originates (e.g., system, user, automated process),
SourceId: The identifier associated with the source of the notification.
CasinoTenentId: The identifier representing the specific casino tenant associated with the notification,
UserStatus: The status of the user associated with the notification (e.g., active, inactive).
UserActionDate: The date and time when the user took action in response to the notification, and,
Data: Additional data or information related to the notification.

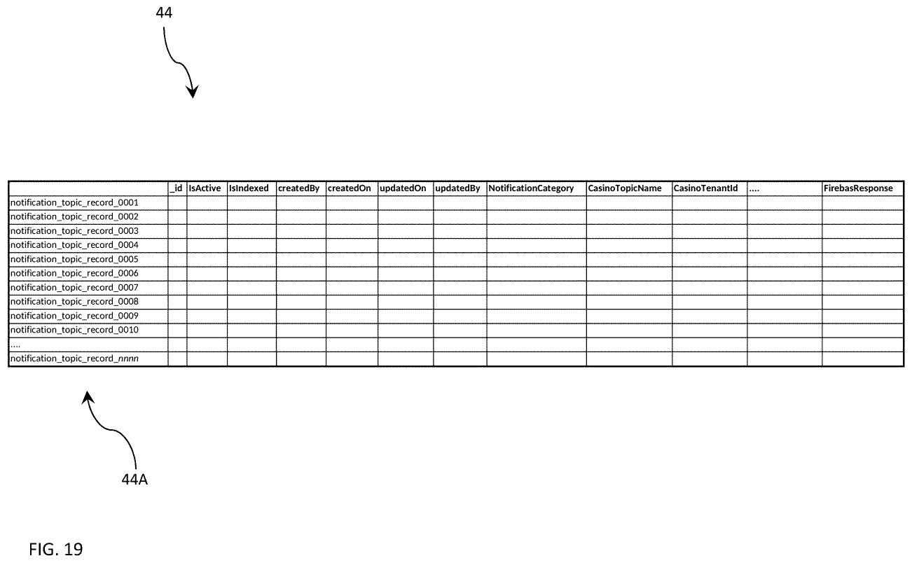

With specific reference to FIG. 19, an exemplary notification topic data file or table 44 is shown. The notification topic data file or table 44 includes a plurality of notification topic records (notification_topic_record_0001 through notification_topic_record_nnnn) 44A. The notification topic data table 44 may be used to manage and store information about various notification topic queues. These queues help organize and schedule notifications for different categories or topics associated with specific casinos. The table facilitates the configuration and tracking of notification details, including their display behavior and criteria. In the illustrated embodiment, the notification topic data table 44 may include the following fields:
_id: Primary key representing the unique identifier for each notification topic queue record,
IsActive: A boolean flag indicating whether the notification topic queue is currently active or not,
IsIndexed: A boolean flag indicating whether the notification topic queue data is indexed for faster retrieval,
createdBy: The user or system entity responsible for creating this notification topic queue record,
createdOn: The date and time when the notification topic queue record was created,
updatedOn: The date and time when the notification topic queue record was last updated.
updatedBy: The user or system entity responsible for the last update to this notification topic queue record,
NotificationCategory: The category or type of the notification topic queue (e.g., promotion, event, alert),
CasinoTopicName: The name of the topic associated with the casino,
CasinoTenantId: The identifier representing the specific casino tenant associated with the notification topic queue,
PrefixCasinoName: The prefix added to the casino name,
TopicName: The name of the topic for the notification,
ValidStartDate: The start date and time when the notification topic queue becomes valid,
ValidEndDate: The end date and time when the notification topic queue expires,
Title: The title or subject of the notification,
Message Content: The content or body of the notification message,
NotificationType: The type of notification (e.g., email, push notification, SMS),
DisplayBehaviour: The behavior of the notification display,
Placement: The placement or positioning of the notification,
Repetition Count: The number of times the notification can be repeated,
MinDisplayInMinute: The minimum time the notification should be displayed in minutes,
Criteria: Additional criteria or conditions associated with the notification topic queue,
Status: The status of the notification topic queue (e.g., pending, active, expired),
ErrorDescription: A description of any error that occurred during notification processing, and
FirebasResponse: The response or result from Firebase related to the notification/

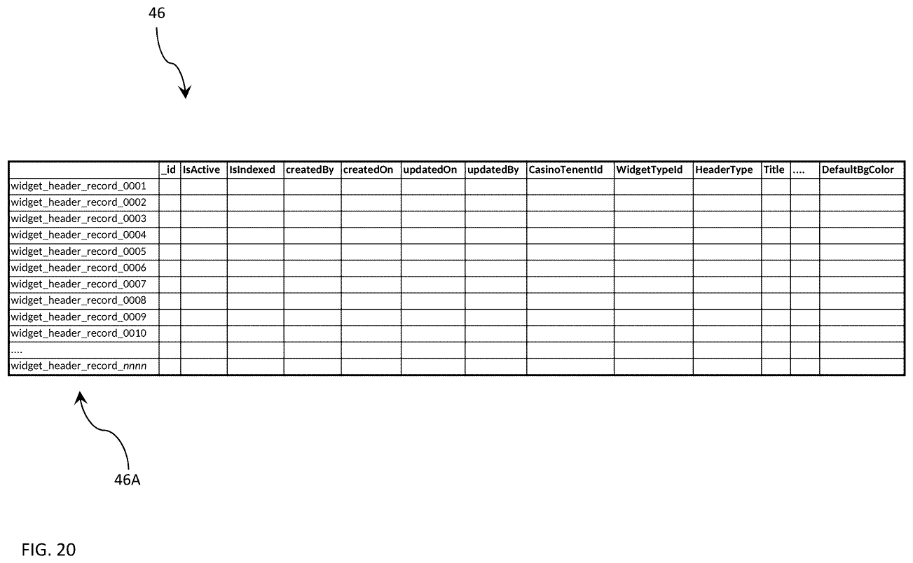

With specific reference to FIG. 20, an exemplary widget header data file or table 46 is shown. The widget header data file or table 46 includes a plurality of widget header records (widget_header_record_0001 through widget_header_record_nnnn) 46A. The widget header data table 46 may be used to manage and store information about various widget headers displayed on the IVOREE platform 100. Widget headers are sections that group and categorize widgets in a user interface. The table 46 facilitates the configuration and display of widget header details, including their content, style, and associated widgets. In the illustrated embodiment, the widget header table 46 may include the following fields:
_id: Primary key representing the unique identifier for each widget header record,
IsActive: A boolean flag indicating whether the widget header is currently active or not,
IsIndexed: A boolean flag indicating whether the widget header data is indexed for faster retrieval.
createdBy: The user or system entity responsible for creating this widget header record,
createdOn: The date and time when the widget header record was created,
updatedOn: The date and time when the widget header record was last updated,
updatedBy: The user or system entity responsible for the last update to this widget header record,
CasinoTenentId: The identifier representing the specific casino tenant to which this widget header belongs,
WidgetTypeId: The unique identifier of the widget type associated with this header,
HeaderType: The type or category of the widget header (e.g., navigation, title, spotlight).
Title: The title or heading of the widget header,
FreeFormText: Additional free-form text or content for the widget header,
Sequence: The sequence or order in which the widget header appears,
Widgets: Information about widgets associated with this header,
IsSpotlight: A boolean flag indicating whether the widget header is a spotlight header,
SpotlightType: The type or category of the spotlight (if applicable),
backgroundImage: The URL of the background image associated with the widget header,
icon: The icon associated with the widget header,
Filters: Information about filters applied to the widgets in the header,
FilterString: The filter string used for filtering the widgets (assets),
ShowTitle: A boolean flag indicating whether to display the title in the widget header,
DefaultFontColor: The default font color used in the widget header, and
DefaultBgColor: The default background color used in the widget header,

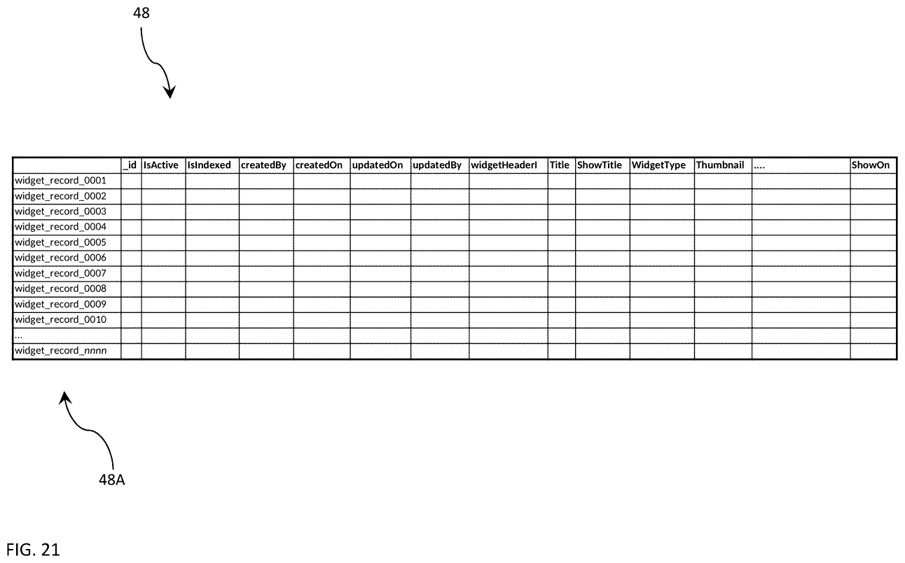

With specific reference to FIG. 21, an exemplary widget data file or table 48 is shown. The widget data file or table 48 includes a plurality of widget records (widget_record_0001 through widget_record_nnnn) 48A. The widget data table 48 may be used to manage and store information about various widget headers displayed on the IVOREE platform 100. Widget headers are sections that group and categorize widgets in a user interface. The table 46 facilitates the configuration and display of widget header details, including their content, style, and associated widgets. In the illustrated embodiment, the widget header table 46 may include the following fields:
_id: Primary key representing the unique identifier for each widget record,
IsActive: A boolean flag indicating whether the widget is currently active or not,
IsIndexed: A boolean flag indicating whether the widget data is indexed for faster retrieval,
createdBy: The user or system entity responsible for creating this widget record,
createdOn: The date and time when the widget record was created,
updatedOn: The date and time when the widget record was last updated,
updatedBy: The user or system entity responsible for the last update to this widget record,
widgetHeaderId: The identifier of the widget header to which this widget belongs,
Title: The title or name of the widget,
ShowTitle: A boolean flag indicating whether to display the widget title,
WidgetType: The type or category of the widget (e.g., content, media, promotion),
Thumbnail: The thumbnail image associated with the widget,
ShowThumbnail: A boolean flag indicating whether to display the widget thumbnail,
Sequence: The sequence or order in which the widget appears within its header,
Description: A description or additional details about the widget,
Themeing: Theme settings or configuration for the widget's appearance,
ShowActionButton: A boolean flag indicating whether to display an action button for the widget,
ActionModuleContent: Content or data related to the action button,
Sections: Information about sections associated with the widget,
Status: The status of the widget (e.g., active, inactive, pending),
CasinoTenentId: The identifier representing the specific casino tenant associated with the widget,
WidgetSchedule: Schedule or timing settings for displaying the widget,
Icon: The icon associated with the widget,
WidgetAdditionalConfig: Additional configuration or settings specific to the widget,
ParentWidgetId: The identifier of the parent widget to which this widget belongs (if applicable),
SubWidgetType: The type or category of the sub-widget (if applicable),
FilterableData: Data that can be filtered in the widget, and,
ShowOn: The platforms or devices on which the widget is displayed.

### Ivoree Platform 100 Sign-Up

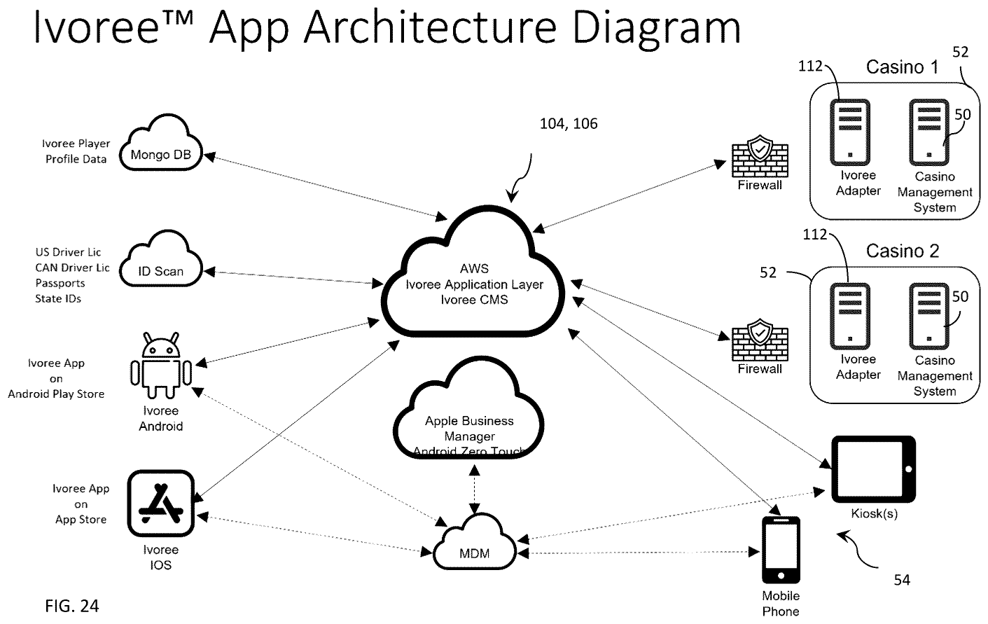

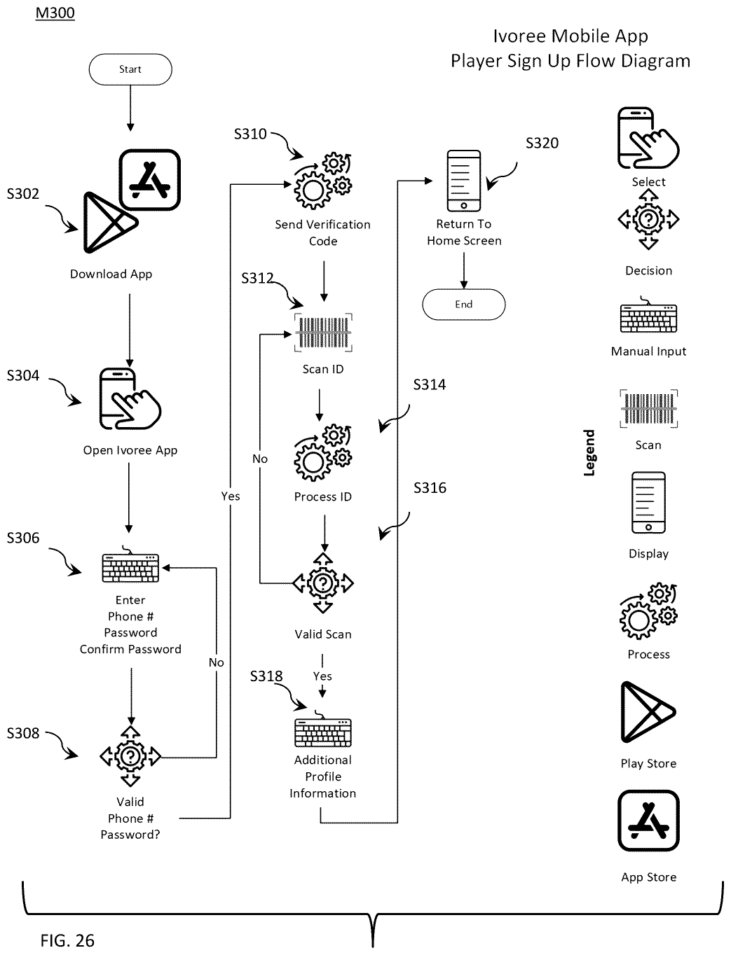

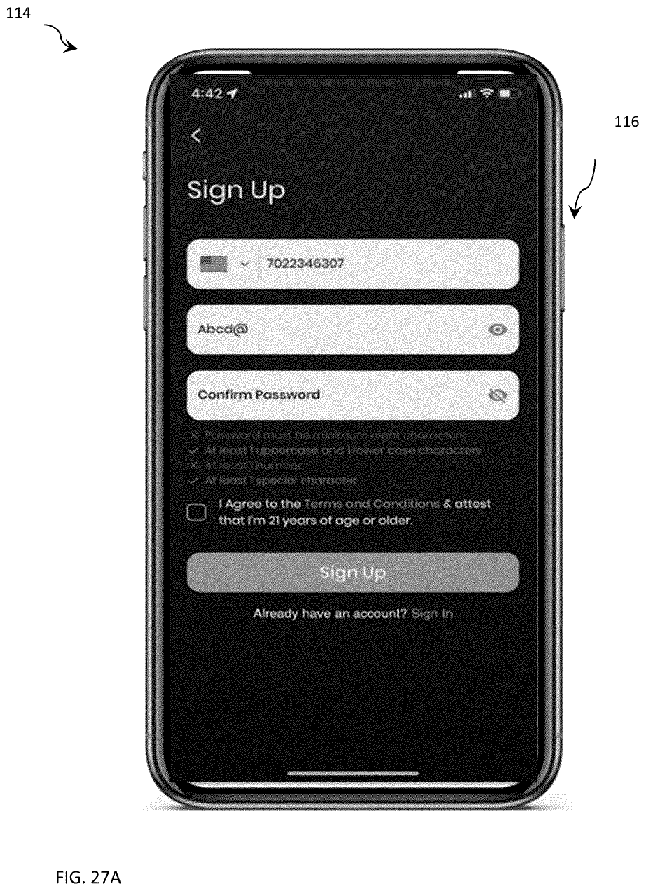

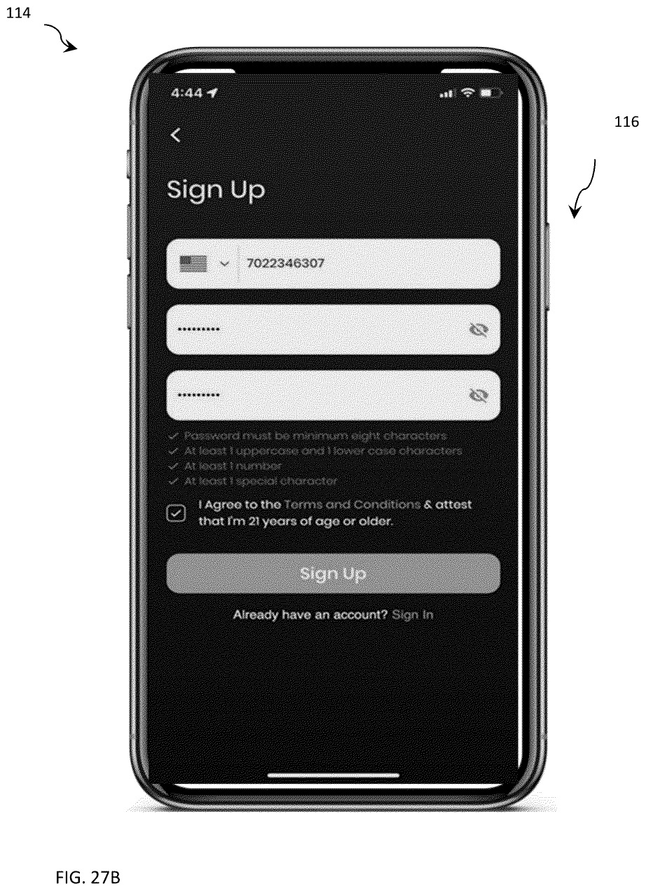

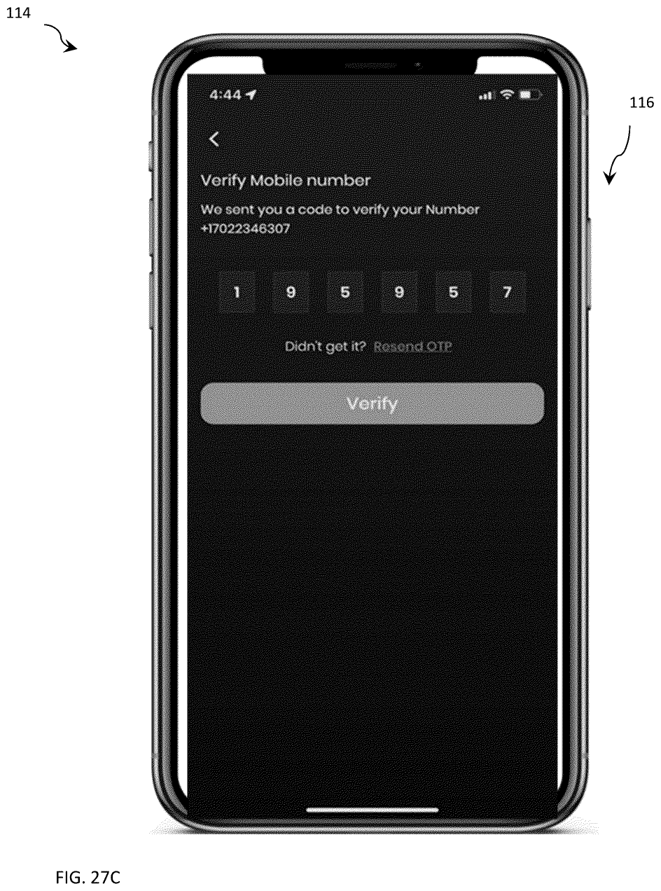

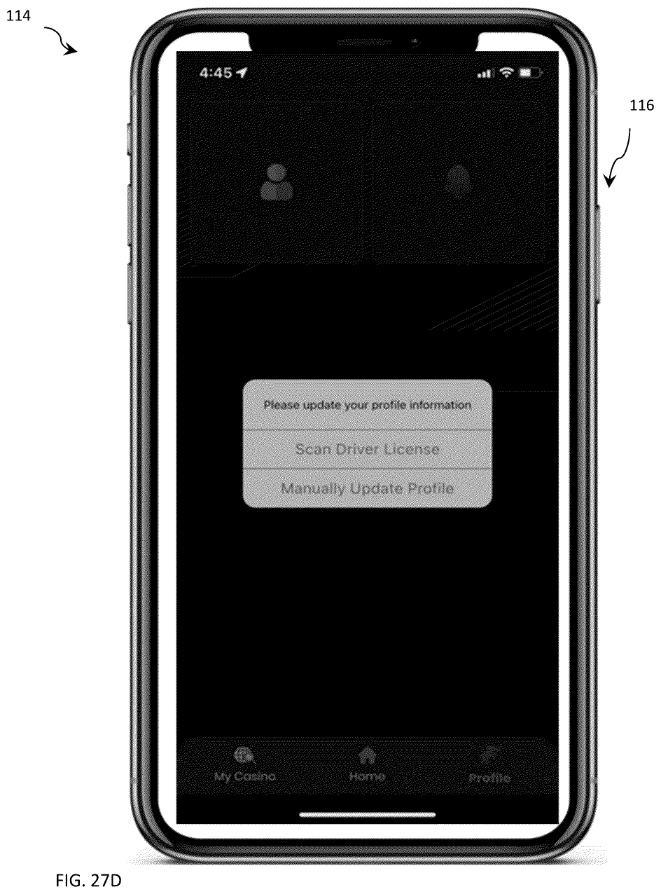

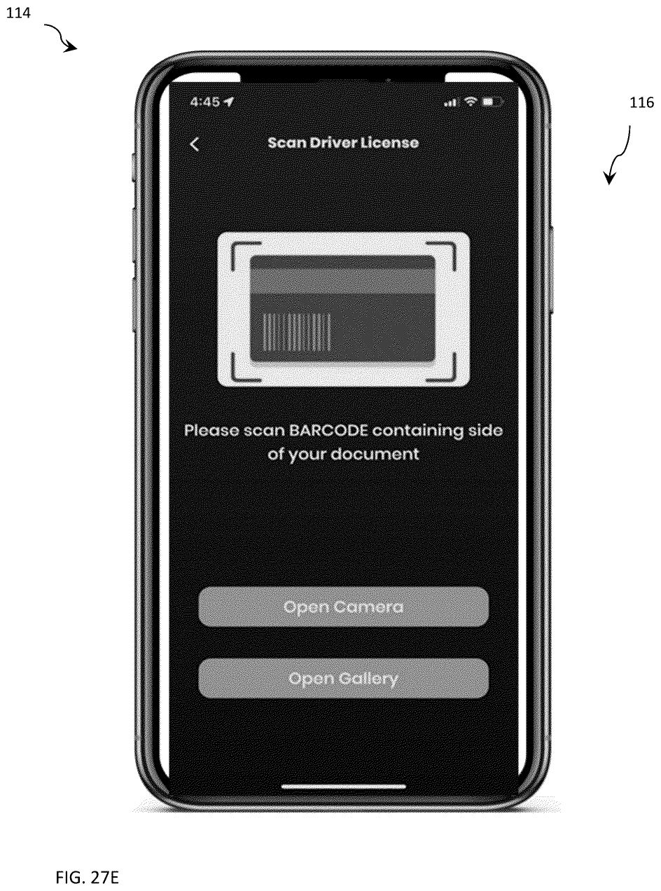

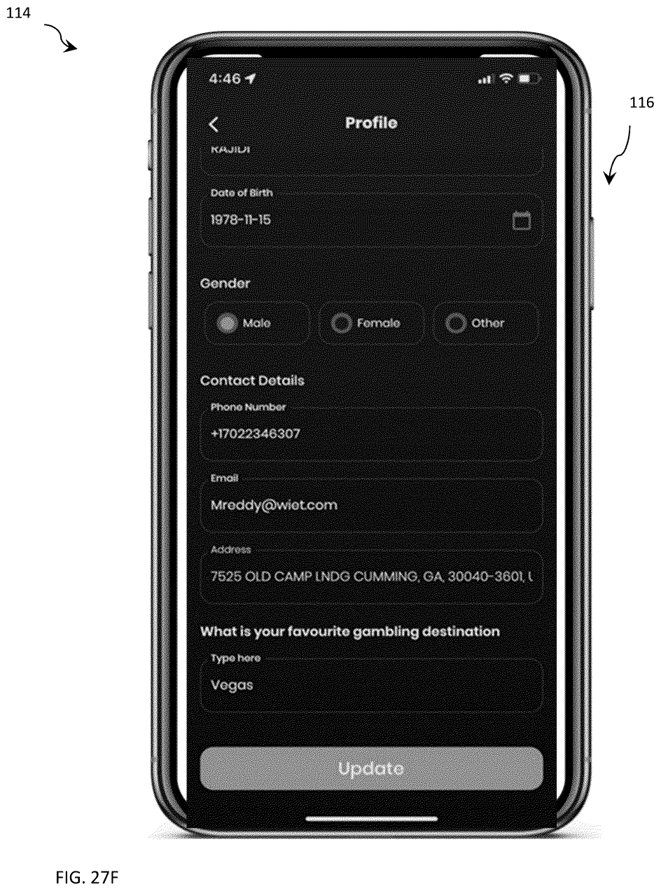

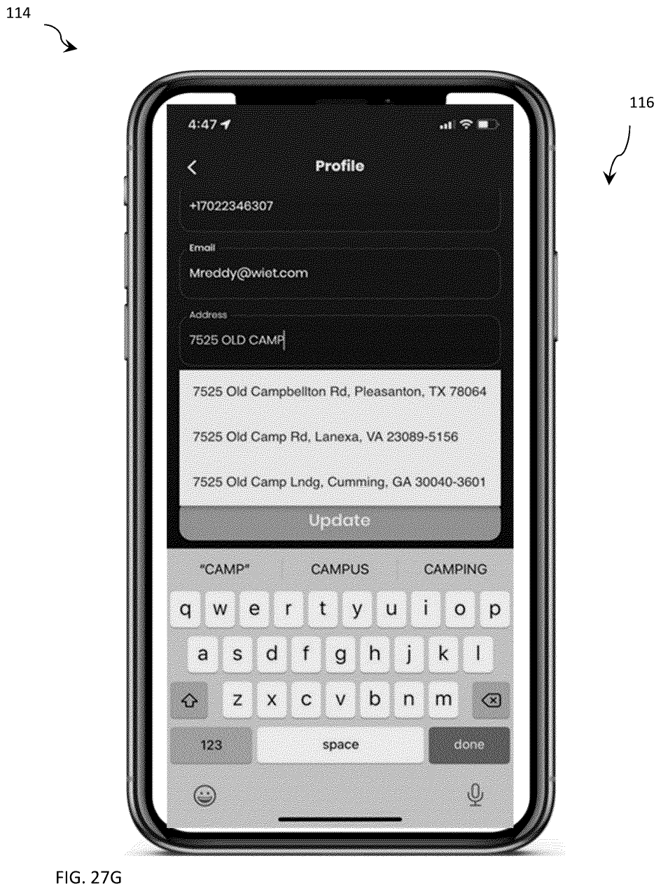

With reference to FIG. 26 and FIGS. 27A-27G, a patron may sign up/create an account on the IVOREE platform 100 using the One Mobile App 102 on the patron's cell phone or mobile device or tablet. With specific reference to FIG. 24, the One Mobile App 102 presents a user interface 114 to the patron. The user interface 114 includes a number of display screen interfaces (see below) with which the patron can interact, i.e., view, enter, and/or manipulate data.

The sign-up process or method M300 according to an embodiment of the present invention is shown in FIG. 26. In a first step S302, the patron can arrive at a first sign-up screen 116 displayed on the user interface 114 in one of 2 ways: (1) directly download the IVOREE One Mobile App from the appropriate App Store (Apple or Google Play) or (2) scan QR code and then be redirected to the respective App Store to download the One Mobile App 102.

Once the app has downloaded, the patron may run the One Mobile app 102 in a second step S304 an animated “Splash” screen (not shown) may be displayed to the user.

Starting in a third step S306, a series of sign-up screens 116 may be presented to the patron. In a first sign-up screen 116 (FIGS. 27A-27B), the patron is prompted to enter:
Primary mobile phone number (which will be associated with the app and the casino player loyalty program),
Password that meets the secure requirements:
   At least 8 characters in length,
   With at least 1 Upper case character,
   With at least 1 Lower case character,
   At least 1 numerical (number) value and
   At least 1 special character (@, #, $, %, & etc.)

The user is also expected to acknowledge that they are 21 years of age or older, by checking the box. To complete the signup by selecting the <SIGN UP> button to complete the first-time user registration process. If the user has already previously registered, then the user can click on the <SIGN IN> link. In a fourth step S308, the entered data is analyzed to make it is valid. If not, the method M300 returns to the third step S306 to prompt the patron to correct the data.

After the patron has clicked on the <SIGN UP> button, the patron may be taken through a series of steps to complete the creation of their account.

In the illustrated embodiment, the IVOREE platform 100 utilizes two-factor authentication. In a fifth step S310, the patron is sent a text message that contains a one-time two-factor authentication code to be entered in the One Mobile App 102 (FIG. 27C). If the patron did not receive the code, then the patron can click on the <RESEND OTP> button to receive a new code via text message Once the patron enters the code and clicks on the <VERIFY> button and the code validated successfully, the method M300 proceeds.

As shown in FIG. 27D, the patron may be prompted to: (1) scan their driver's license or (2) to manually enter additional information to update their user profile (FIG. 27G). If the patron elects to scan their driver's license, their driver's license is scanned in a sixth step S312 (see FIG. 27E). On this screen, the patron may either take a picture of the barcode by clicking on <OPEN CAMERA> or can upload a previously taken picture by clicking on <OPEN GALLERY>. If the patron clicks on the <OPEN CAMERA> button, the prompted to take a picture of the barcode at the back of the driver's license or state ID (FIG. 27E). Or the user may also take a picture of the front of the driver's license or state ID. Alternatively, the patron may upload a previously taken photo by clicking on the <OPEN GALLERY> button.

The scan of the driver's license (or picture of the driver's license) is processed in a seventh step S314. In an eighth step S316, the data from the driver's license is validated. If the scan is not valid, then the method M300 returned to the sixth step S312.

In a ninth step S318, the patron is prompted to enter additional profile information and/or to confirm their profile data (FIG. 27F).

If the patron clicks on the <Manually Update Profile> button, then the patron may be prompted (FIG. 27G) to enter/correct the following information: First Name, Last Name, Date of Birth, Gender, Phone Number, Email Address, Address and Favorite Gambling Destination.

In a tenth step S310, the method M300 returns to a home screen (not shown).

### Loyalty or Player Account Integration

Once the patron has created an account on the IVOREE platform 100, the patron may link existing player tracking or loyalty accounts on one or more casino management systems 50. Alternatively, or in addition, the patron may create a new player tracking or loyalty account on one or more casino management systems 50.

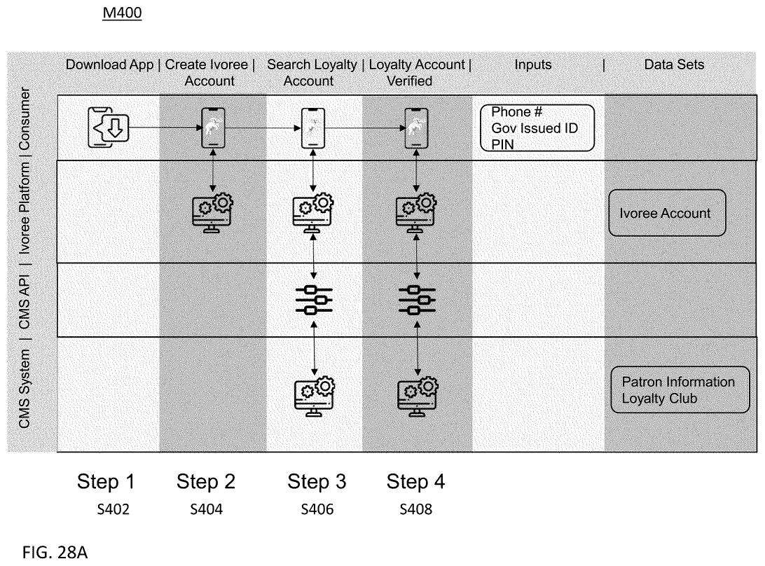

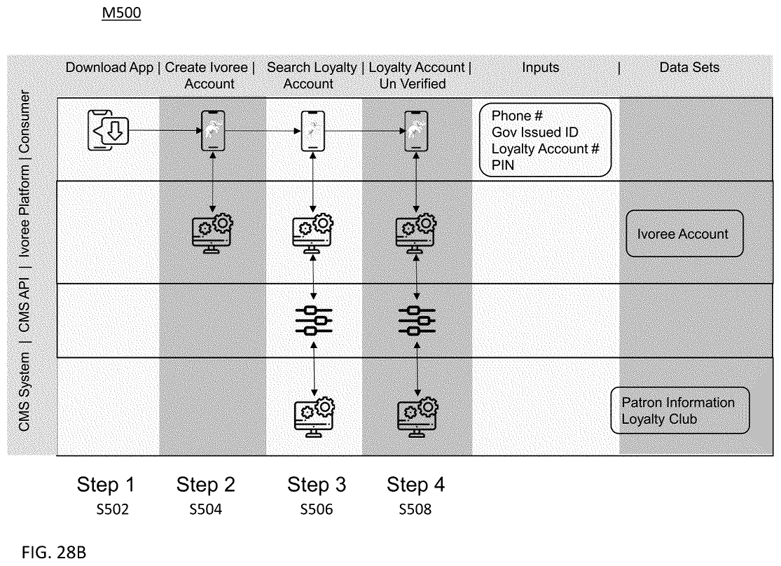

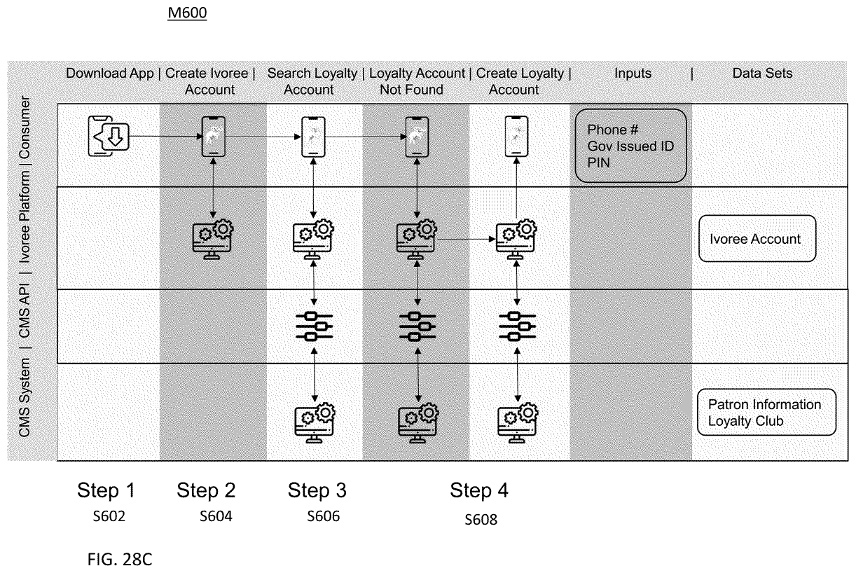

With reference to FIG. 28A, a method M400 for integrating a verified loyalty account at a casino management system 50 is shown. In a first step S402, the One Mobile App 102 is downloaded and, in a second step S404, an account on the IVOREE platform 100 is created. Alternatively, the patron may log into an existing IVOREE account.

In a third step S406, the IVOREE platform 100 queries one or more casino management system 50 (typically using the CMS API's) to determine if the patron has an existing account. If an existing account is found at the casino management system 50, the account is referred to as a verified account. In a fourth step S408, if an existing, or verified, account is found on one or more of the casino management systems 50, the patron is prompted to enter corroborating information such as a personal identification number (PIN) associated with their player tracking account on that casino management system 50. In other words, for an existing or verified account, the patron does not need to provide their play tracking account number. Once the entered PIN is confirmed, the patron's player tracking account at the CMS 50 is linked to the patron's IVOREE account. Thereafter, the patron may access their player tracking account at that CMS 50 by logging into their IVOREE account.

With reference to FIG. 28B, a method M500 for integrating an unverified loyalty account at a casino management system 50 is shown. In a first step S502, the One Mobile App 102 is downloaded and, in a second step S504, an account on the IVOREE platform 100 is created. Alternatively, the patron may log into an existing account.

In a third step S506, the IVOREE platform 100 queries one or more casino management system 50 (typically using the CMS API's) to determine if the patron has an existing account. If an account for the patron is not found (for some reason), but the patron does have an account, the account is referred to as an unverified account. In a fourth step S508, since the patron's player tracking account was not found, i.e., is unverified, the patron is prompted to enter their player tracking account number, as well as their personal identification number (PIN) associated with their player tracking account on that casino management system 50. Once the player tracking number and PIN are confirmed, the patron's player tracking account at the CMS 50 is linked to the patron's IVOREE account. Thereafter, the patron may access their player tracking account at that CMS 50 by logging into their IVOREE account.

With reference to FIG. 28C, a method M600 for creating a new loyalty or player tracking account at a casino management system 50 and linking the new loyalty or player tracking account to the patron's IVOREE account, is shown. In a first step S602, the One Mobile App 102 is downloaded and, in a second step S604, an account on the IVOREE platform 100 is created. Alternatively, the patron may log into an existing account.

The patron may then request that a new player tracking account be created at a specific casino management system 50. In a third step S606, the IVOREE platform first inquires the casino management system 50 to determine if there exists a player tracking account for the patron. If so, the patron is prompted to enter their player account PIN to link the existing account with the patron's IVOREE account.

If no player tracking account exists, in a fourth step S608, the patron is prompted to enter a new PIN and a new player tracking account on the CMS is created and linked to the patron's IVOREE account in the IVOREE platform 100. Thereafter, the patron may access their player tracking account at that CMS 50 by logging into their IVOREE account.

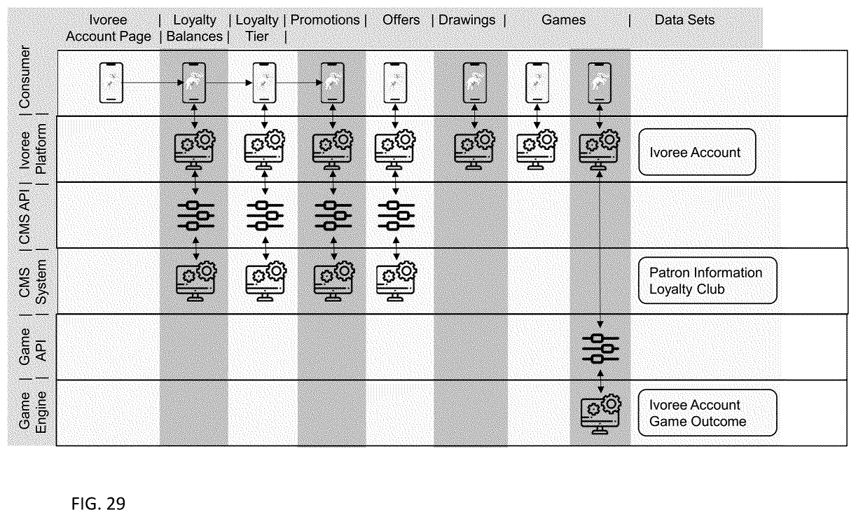

With reference to FIG. 29, once a player tracking account at a particular casino management system 50 has been integrated or linked to the patron's IVOREE account, the patron can view and/or manage their player tracking account on the IVOREE platform 100 via the One Mobile App 102 (or a different channel) without separately logging onto the casino management system 50. The patron can thus manage multiple player tracking accounts via the single sign on to the IVOREE platform 100. The CMS features available to the patron are dependent upon the CMS. The available features could include, but are not limited to, viewing loyalty account balances, tier information, CMS promotions and offers, drawings (offered by the IVOREE platform 100) and games offered by the CMS 50, the IVOREE platform 100, or third parties.

### Casino Search

Once a patron has an IVOREE account, the patron can search for any piece of content in a casino, such as restaurants, hotels, tables, etc. The user can also search through all of the casinos on the platform, or within a specific casino. The search results will fill populate as the user types in their query.

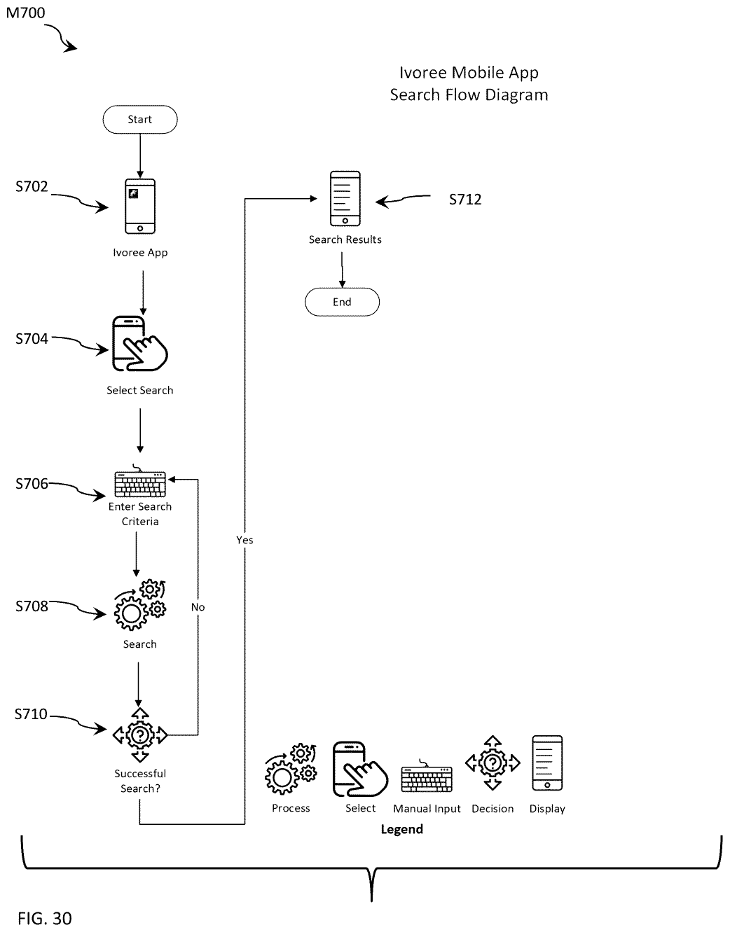

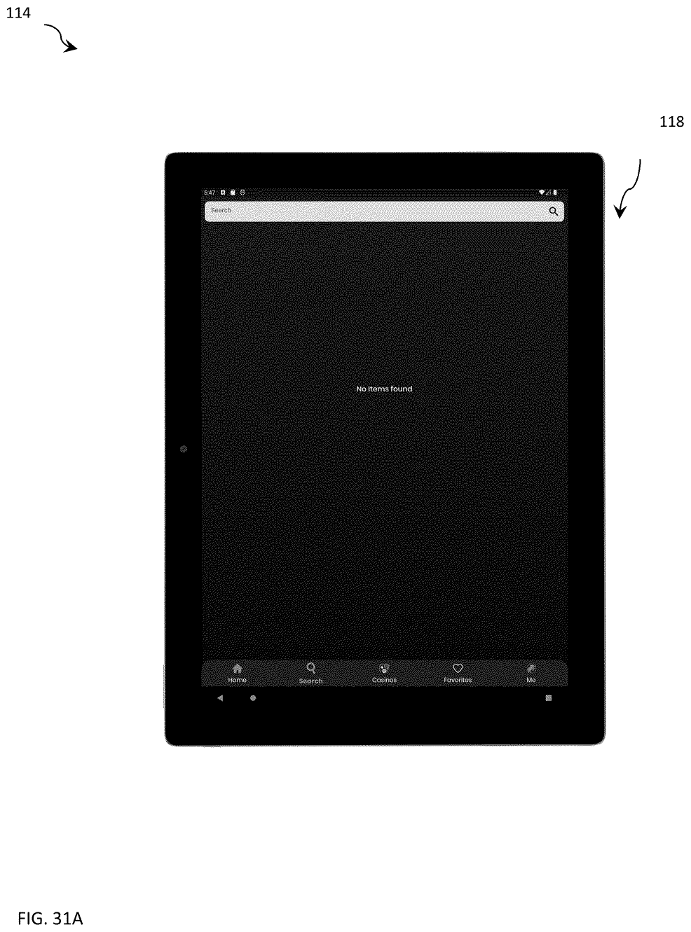

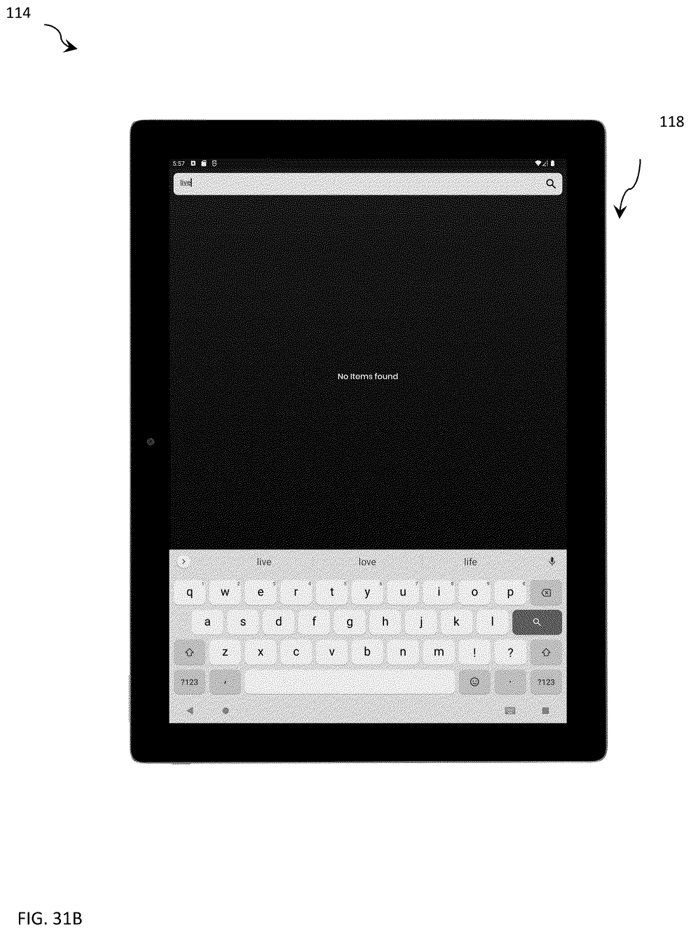

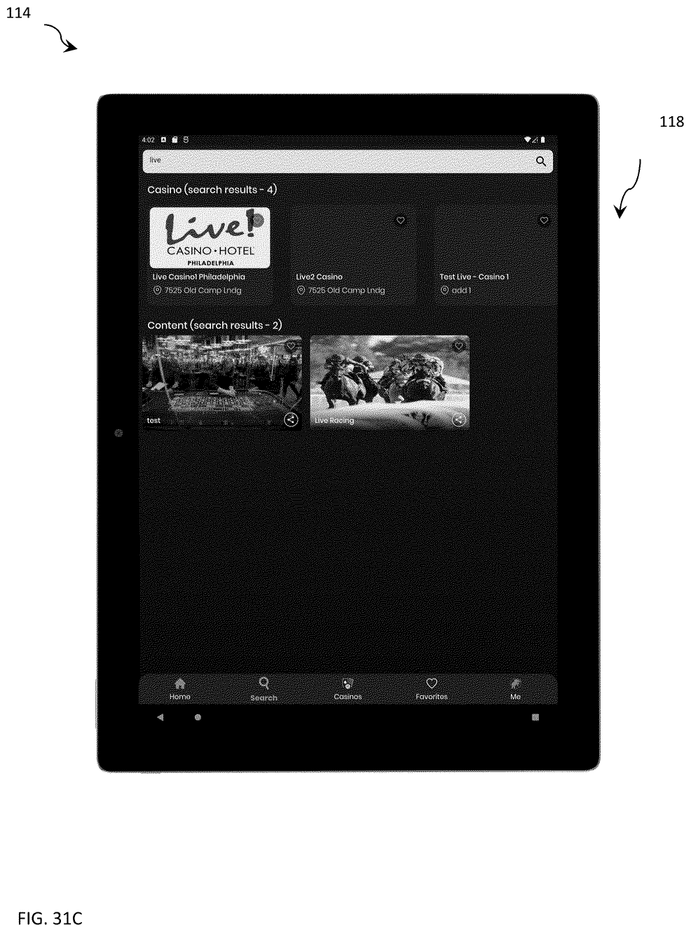

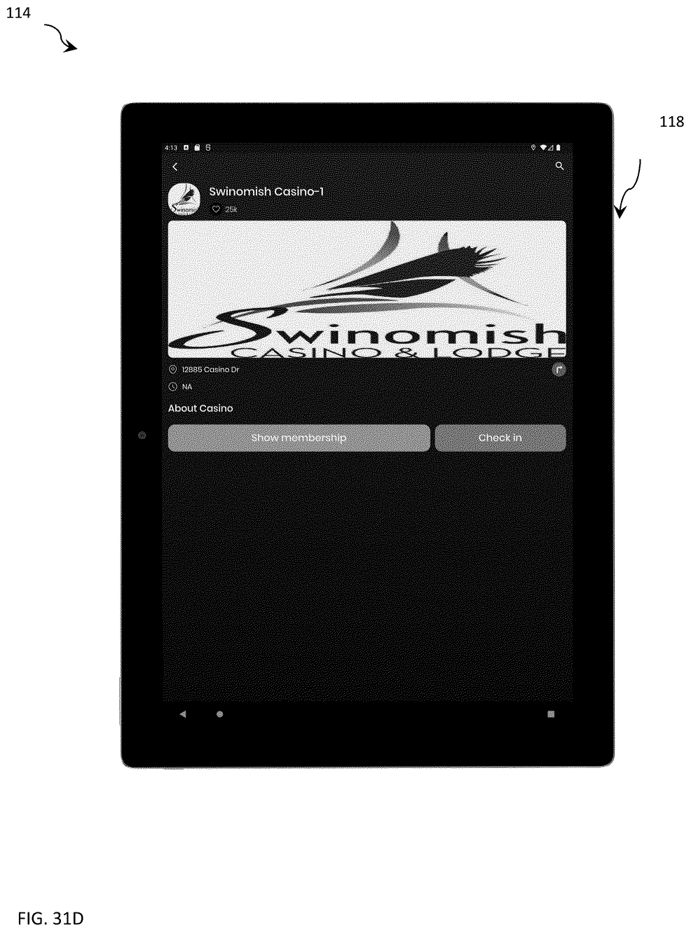

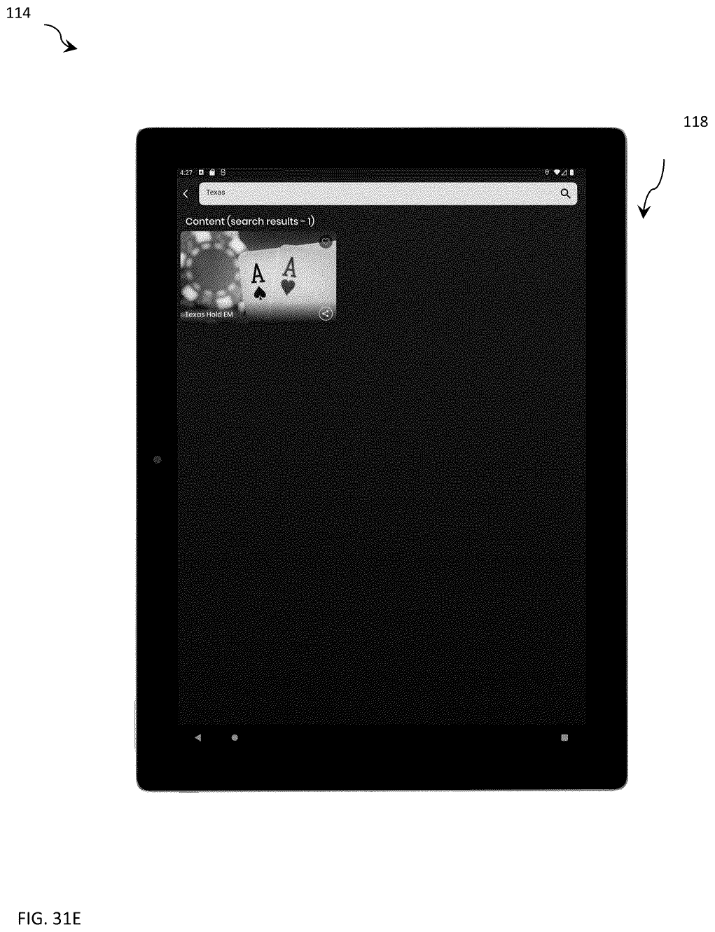

With particular reference to FIG. 30 and FIGS. 31A-31E, a method M700 for allowing a patron to perform a search is shown. During the method M700, a number of search dialogs 118 may be displayed on the user interface 114. In a first step S702, the patron selects and runs the One Mobile App 102 (and logons, if required). In a second step S704, the patron initiates a search. From a home page or screen of the One Mobile App 102, the patron can arrive at a search screen 118 (see FIG. 31A) by pressing a search icon, e.g., a magnifying glass-shaped icon or selecting a search bar.

In a third step S706, the patron can enter on the search page, text to be searched. By tapping or selecting the search bar, a virtual keyboard appears (see FIG. 31B). Once the patron has entered at least the first few characters of the content that they want to search for, the patron may click on the search key on the keyboard to perform the search (fourth step S708).

If the search yielded no results, then a “No Items Found” message may be displayed. In a fifth step S710, the patron may perform another search, if the search was not successful.

In a sixth step S712, the search results are displayed. The results may be categorized by type, for example, casino(s) or content (see FIG. 31C).

If the patron wants to search for content within a particular casino, the patron must search for the casino (see above). Selection of the desired casino will result in a casino's home screen being displayed (see FIG. 31D). A casino's home screen may also be displayed via the One Mobile App's home screen or from the patron's favorites (see below). From the casino's home page, the patron may perform a search for content at that casino (see FIG. 31E).

### Patron Favorites

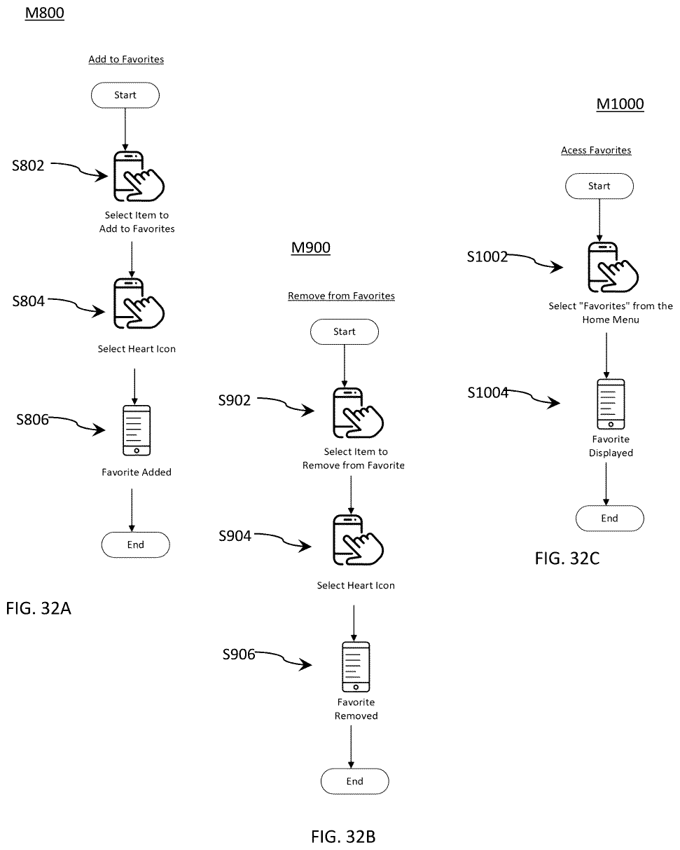

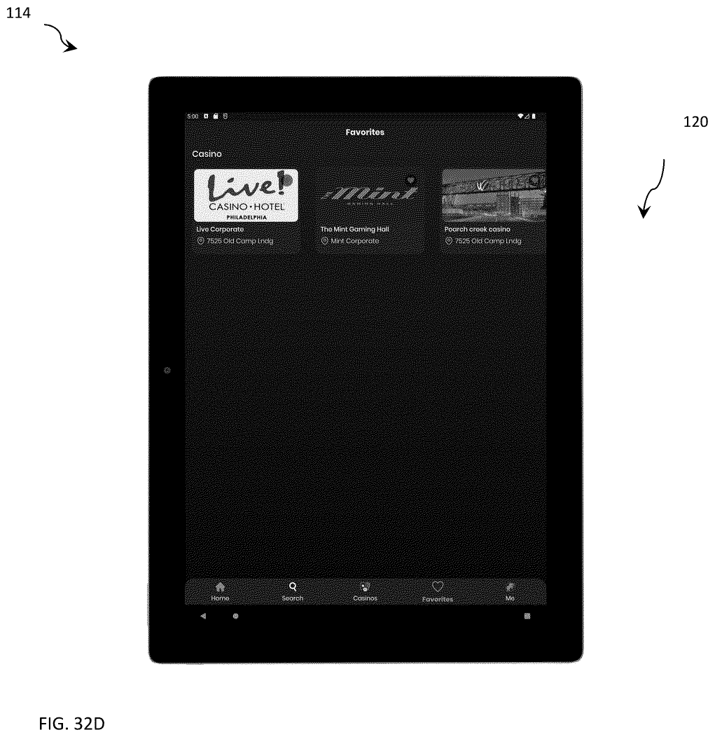

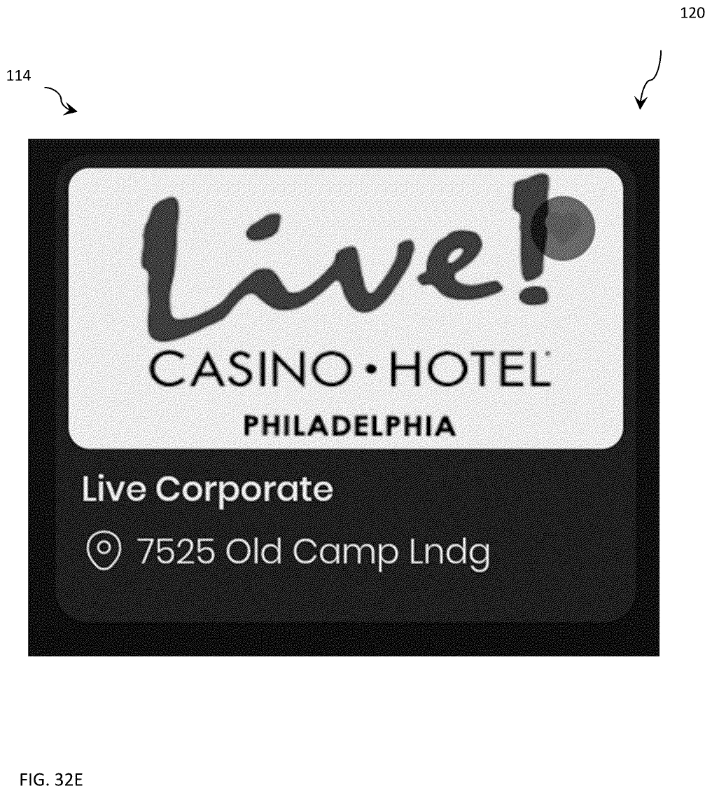

With reference to FIGS. 32A-32E, in one aspect of the present invention, the IVOREE platform 100 includes a favorites features that allows a patron to quickly navigate to content using a series of favorite screens 120 in which they are interested. The content shown or listed in the favorites features is fully customizable (see FIGS. 32D-32E). The favorites feature allows the patron to select items (content) or casinos which they like and want to see in the favorites feature. The information may also be used to make content recommendations to the patron in the future.

With reference to FIG. 32A, items (content or casinos) may be added to the favorites features (method M800). In a first step S802, the patron navigates and selects the content the patron wants added to the favorites feature. The patron can navigate to the desired content through the home screen or the search function (see above). In a second step S804, the patron adds the content to the favorites feature. In the illustrated embodiment, the patron may add the selected content to the favorites feature by tapping on a heart button located at the top right corner of an item (see FIG. 32E). If the item was successfully added to the favorites feature, a dialogue box will pop up on the bottom of the screen saying that the item was successfully added to favorites feature. In addition, the heart button/icon may turn red. Once the patron has tapped the heart button, the item will be added to the favorites feature (for that patron), in a third step S806.

With reference to FIG. 32B, items (content or casinos) may be removed to the favorites features (method M900). In a first step S902, the patron navigates and selects the content the patron wants removed from the favorites feature. The patron can navigate to the content to be removed through the home screen, the search function (see above) or the favorites features. In a second step S904, the patron removes the content from the favorites feature. In the illustrated embodiment, the patron may remove the selected content to the favorites feature by tapping on the heart button located at the top right corner of an item (see FIG. 32E). Once the patron has tapped the heart button, the item will be removed from the favorites feature (for that patron), in a third step S806.

With reference to FIG. 32C, a method M1000 allows a patron to access content in favorites, navigate to the favorites screen by tapping the heart icon on the navigation menu at the bottom of the screen (first step S1002). Once you navigate to the favorites screen, the items in the patron's favorites feature are shown (second step S1004).

### Notifications

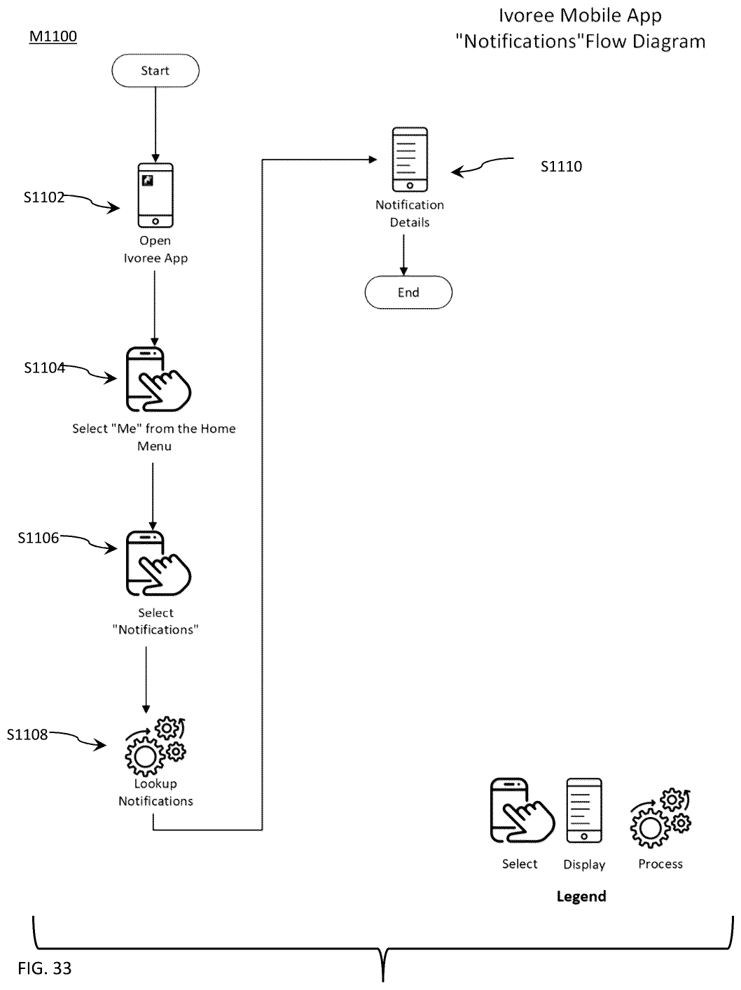

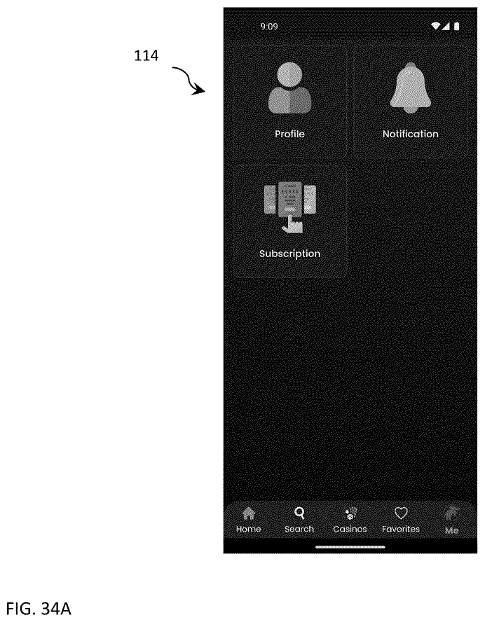

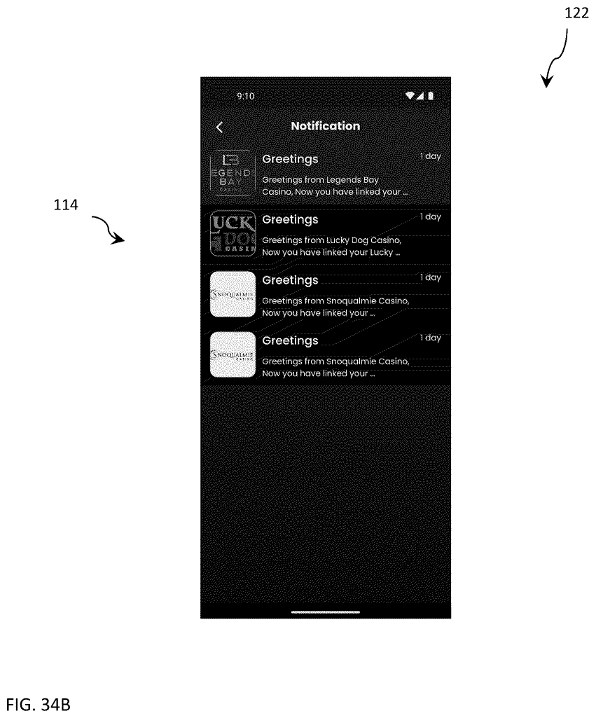

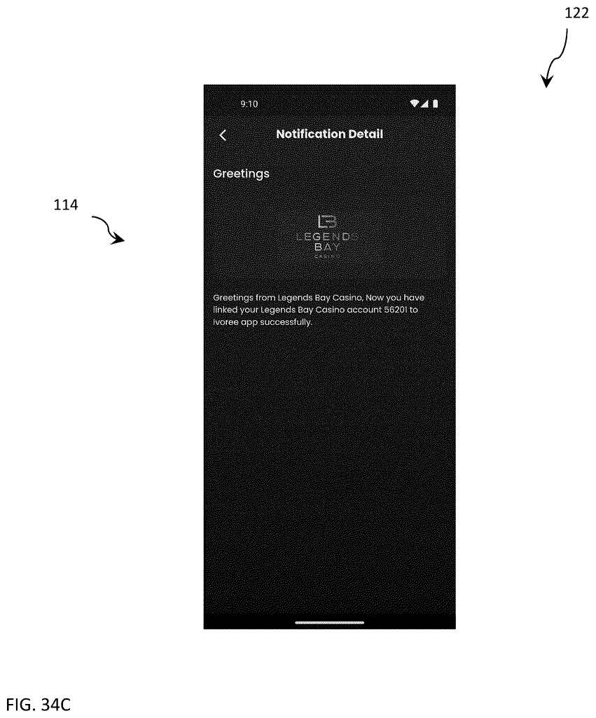

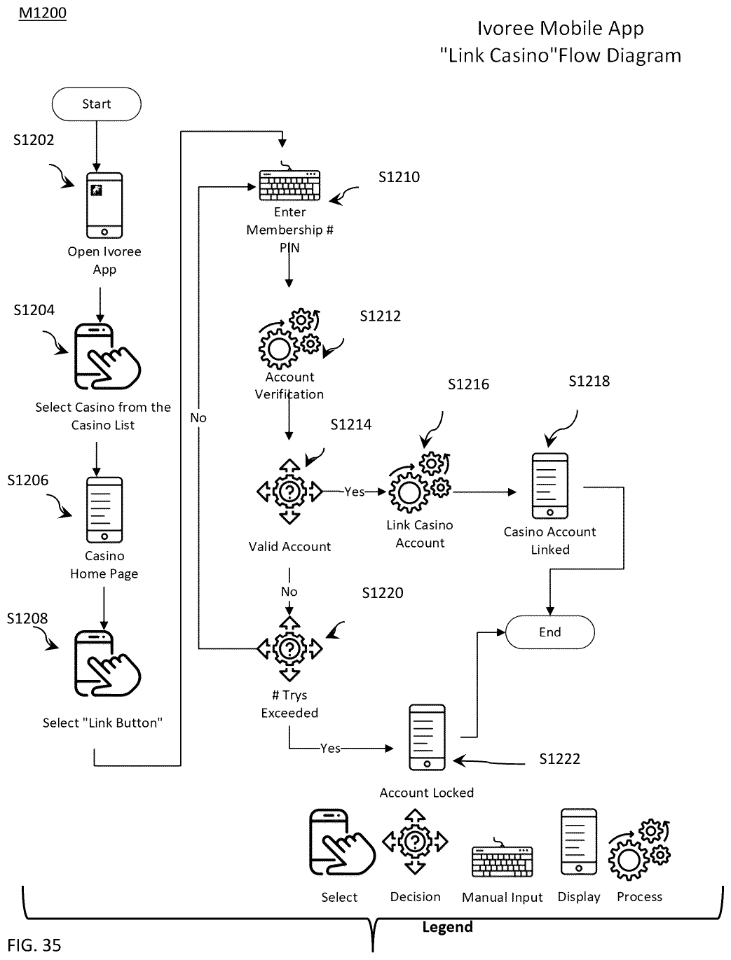

With reference to FIGS. 33 and 34A-34C, the IVOREE platform 100 includes a notification feature that allows the patron to view a list of, and details of a, notification in a series of notification screens 122. The notification feature may be used to notify patrons about upcoming promotions or events. Generally, the patrons are notified about promotions or events for casinos for which the patron has a linked player tracking account or to which the patron is a member (see below). A casino 52 or casino management system 50 can target notifications to users, and the user can opt in or out of notifications. A method M1100 associated with the notification feature is shown in FIG. 33. In a first step S1102, the patron opens up the One Mobile App 102 and in the second step S1104, selects “Me” from a home menu to display a list of icons related to the platform account (see FIG. 34A). In a second step S1104, the patron can select a “notifications” icon to show a list of available notification(s) (FIG. 34B). In a third step S1106, the patron can read a notification (FIG. 34C) by selecting one of the notifications.

### Link Casino—Casino Membership

All information related to a casino may be located at the casino page. Some casino information may be accessed by a patron, even if the patron does not have a player tracking account or if their player tracking account is not linked to their IVOREE account. However, to see patron specific information about the casino, the patron must first link the casino with their account, then click a show membership button. Once the patron clicks the show membership button, they can see membership details such as their points, the number of points needed to get to the next tier, their offers/promotions, and games that the patron is eligible to play. As discussed below, the patron can also see a 3D view of the casino. The 3D view is navigable, I.e., the patron may pan within the 3D view and click on items in the casino to see more information about them. The patron can also see a floor map of the casino in which they can see all of the amenities in the casino by section or by absolute location, and they can see information about each amenity. The user can also see static generated content of the casino such as information about dining, lodging, and events.

A patron may link their IVOREE account to a casino from the casino's home screen in the IVOREE platform 100 using a method M1200. In a first step S1202, the patron opens the One Mobile App 102, and selects a casino from a casino list (or from search results—see above) in a second step S1204. In a third step S1206, the method M1200 navigates to the casino home page.

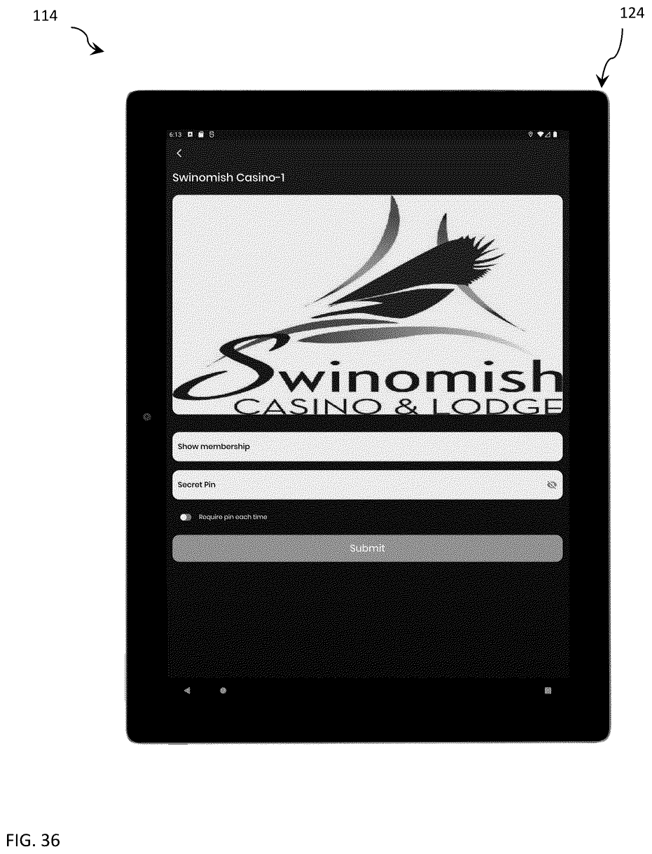

To link the casino to the patron's IVOREE account, the patron selects a <Link> button and a casino link screen 124 (FIG. 36) is displayed. In a fifth step S1210, the casino link screen 124 requires or prompts the patron to enter the membership number for the casino management system 50 associated with the casino 52 and a secret pin selected by the patron. The patron does not need to enter the PIN every time, however, for added security, the patron user can also choose to enter the pin every time. The membership number (and PIN) are verified in a sixth step S1212, and if validated (seventh step S1214), the patron's account at the casino management system 50 is linked to the patron's IVOREE account (eighth and ninth steps S1216, S1218). If the membership number (or PIN) is invalid and the number of invalid attempts exceeds predetermined number (in tenth step S1220), then the account is locked (eleventh step S1222). Otherwise, the method M1200 returns to the fifth step S1210 and the patron is prompted to try again.

### Membership Navigation

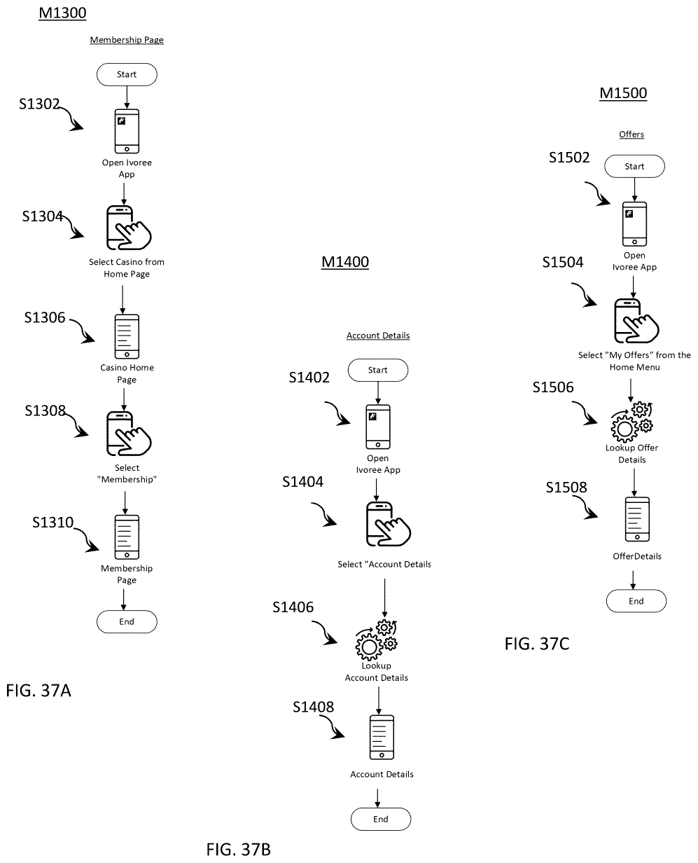

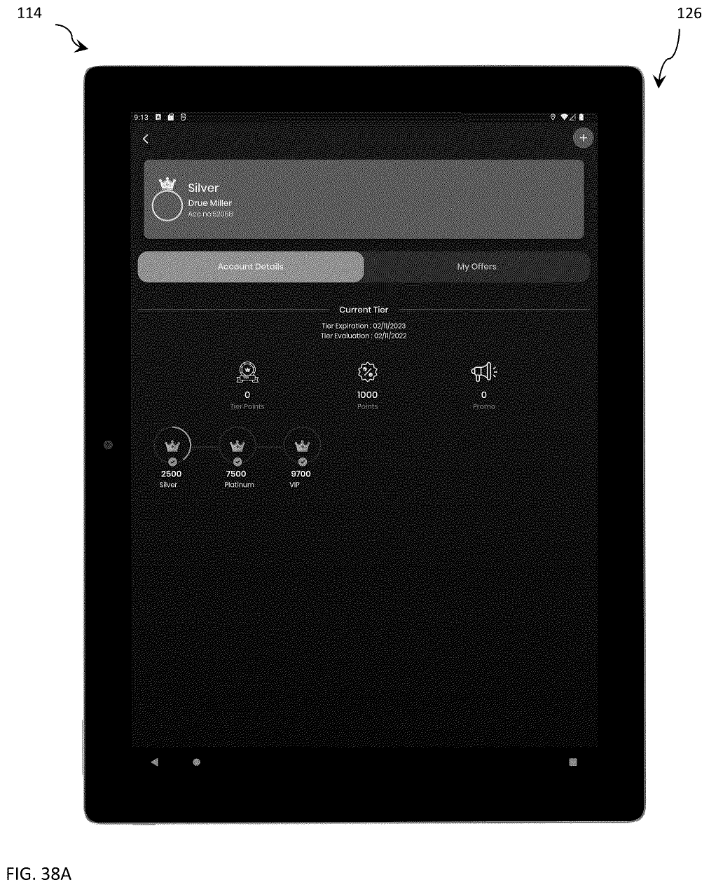

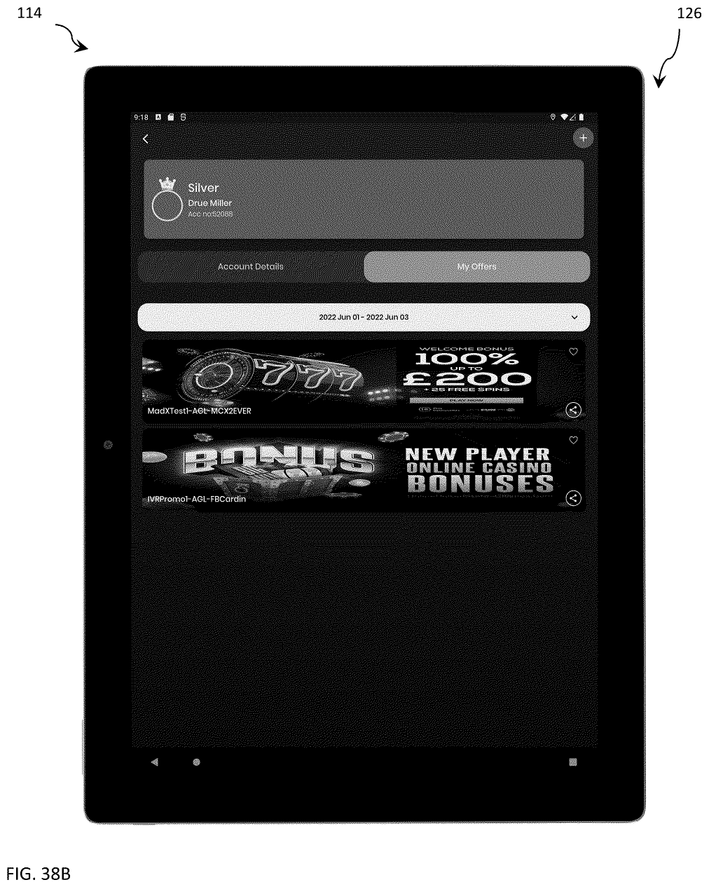

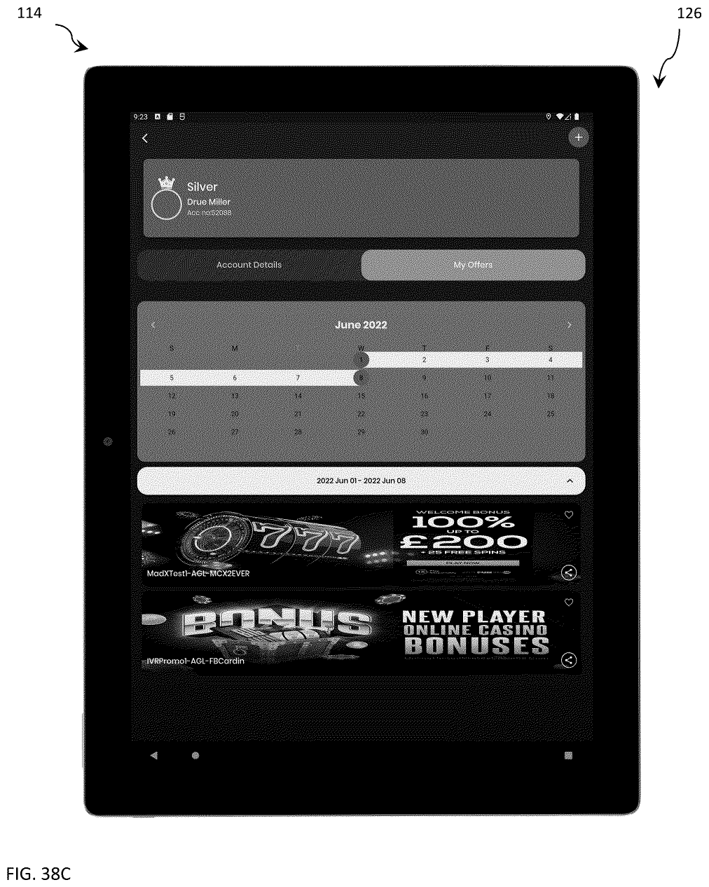

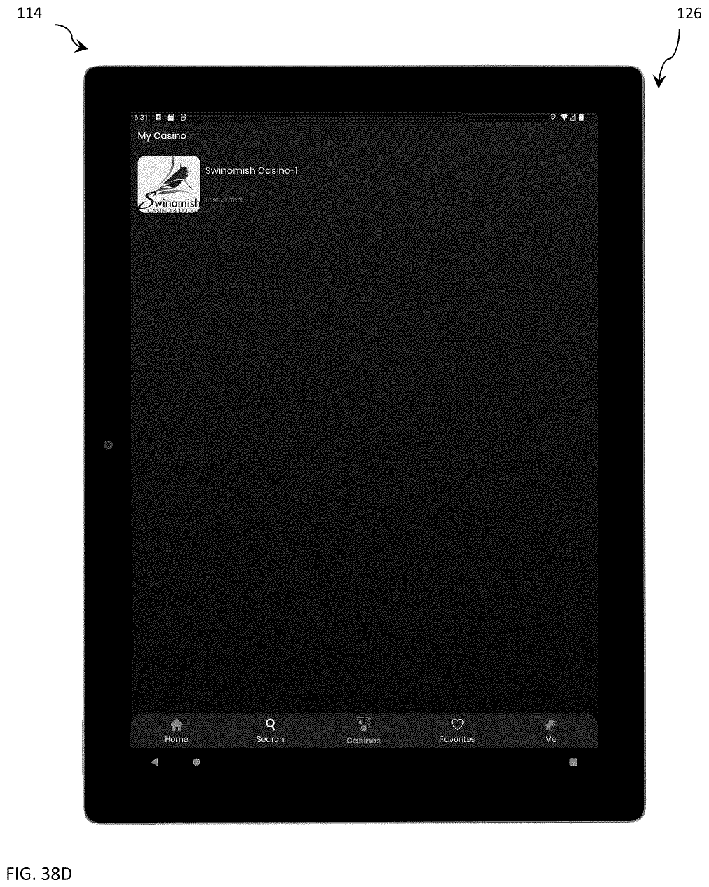

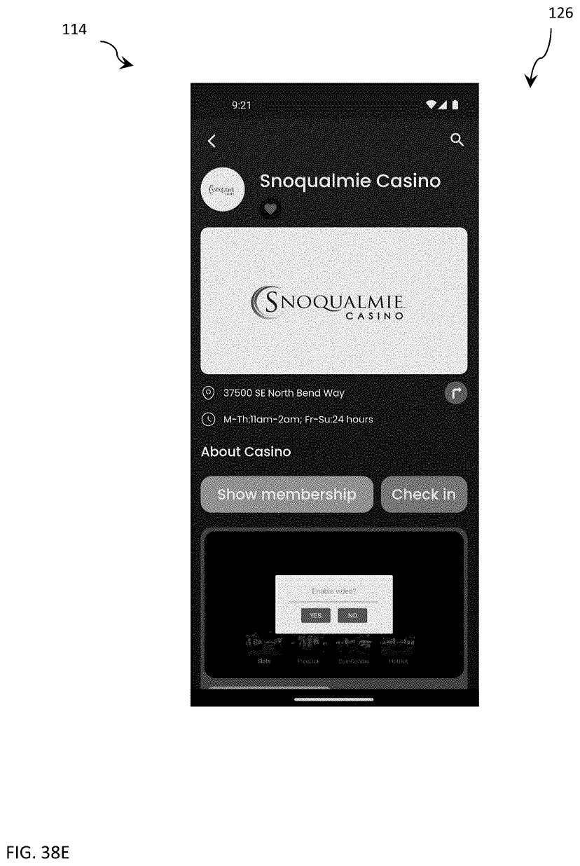

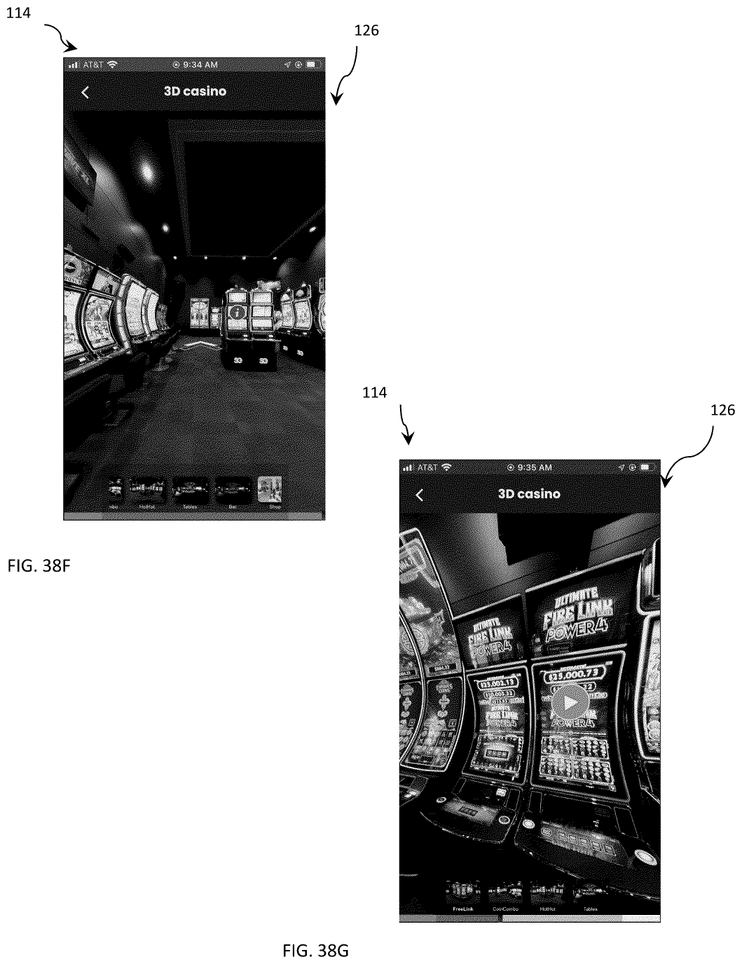

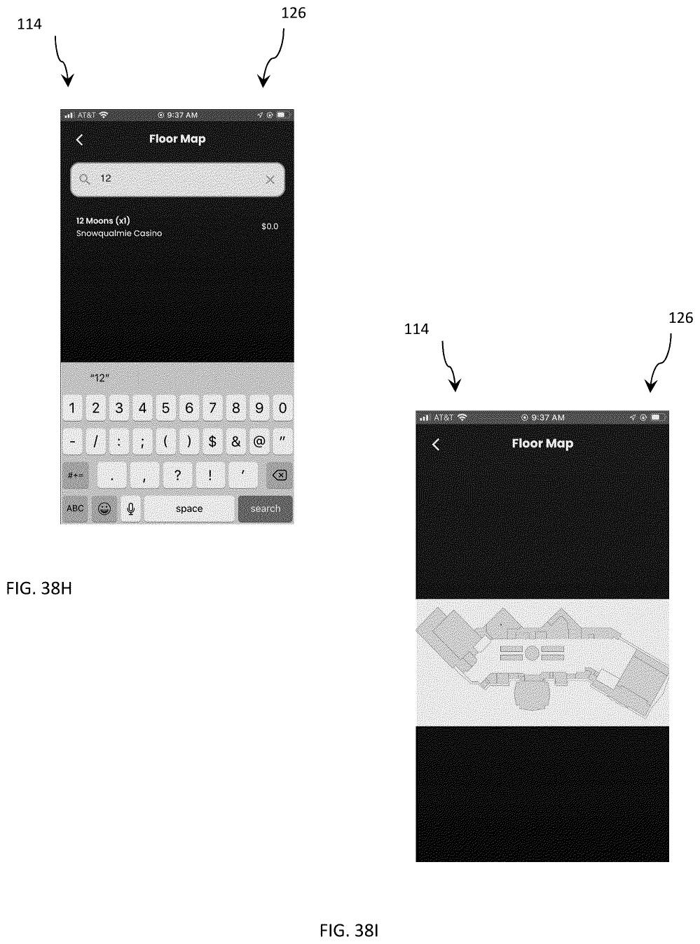

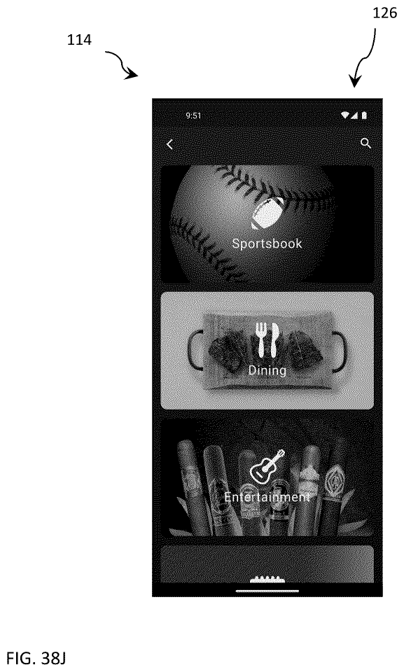

With reference to FIGS. 37A-37C and FIGS. 38A-38J, after a casino 52 or a casino management system 50 at a casino 52 has been linked to a patron's IVOREE account, the patron can interact with information related to the casino 52, including patron specific information via a plurality of membership screens 126 (FIGS. 38A-38J).

With reference to FIG. 37A, a method M1300 allows the patron to navigate to a casino membership screen (FIG. 38A). In a first step S1302, the patron opens the One Mobile App 102, and selects a casino from a casino list (or from search results—see above) in a second step S1304. In a third step S1306, the method M1300 navigates to the casino home page. In a fourth step S1308, to navigate to the casino membership screen, the patron selects a <membership> button and the casino membership screen in a fifth step S1310.

The casino membership screen 126 includes all the details of the patron's casino membership such as the patron's current reward tier and the number of points you need to reach the next rewards tier.

With reference to FIG. 37B, a method M1400 allows the patron to display their account details. In a first step S1402, the patron opens the One Mobile App 102. In a second step S1404, the patron selects an account details icon (not shown). In a third step S1406, the method M1400 looks up the patron's account details and displays the patron's account details in a fourth step S1408.

With reference to FIG. 37C, a method M1500 allows the patron to view any special offers. In a first step S1502, the patron opens the One Mobile App 102. In a second step S1504, the patron may select “My Offers” from the patron's home menu. In a third step S1506, the method M1500 looks up the patron's current offers and displays the offers in a fourth step S1508 (see FIG. 38B). In the illustrated embodiment, a calendar drop-down menu may be provided to allow the patron to search or display a set of offers within a set of dates (FIGS. 38B-38C).

With reference to FIGS. 38D-38J, a series of membership screens 126 associated with casinos and content related to the casino(s) for which a patron is a member. Information related to a particular casino (to which they are linked) by using the search feature (see above) or tapping on the casino on the patron's home screen. With reference to FIG. 38D, a patron may see the casinos to which they are a member under “My Casinos”. Information related to a particular casino (to which they are linked) by using the search feature (see above) or tapping on the casino on the patron's home screen. In the illustrated embodiment, some casino information is shown on a casino landing screen 126 (see FIG. 38E). With reference to FIGS. 38F-38G, from the casino landing screen, the patron may select on the <3d View> button to open a 3D view of the casino. Within the 3D view, the patron may navigate to look around the casino, move around the casino, and interact with items in the casino. With reference to FIGS. 38H-38I, from the casino landing screen, the patron selects the <Show Floor Map> button, resulting in a search bar being displayed. The patron may enter a search for a specific within the casino, for example, by denomination or name. A list of items that fit the search criteria are displayed and selection of one of the items will display a map illustrating the location of the item. With reference to FIG. 38J, from the casino landing screen, a list of cards or icons with the name (or Widget header) and an associated widget scroll down below the 3D view, you should see cards with the name of the widget headers, and an image may be displayed. The patron may select a widget header to see the contents.

### Kiosk Sign-Up

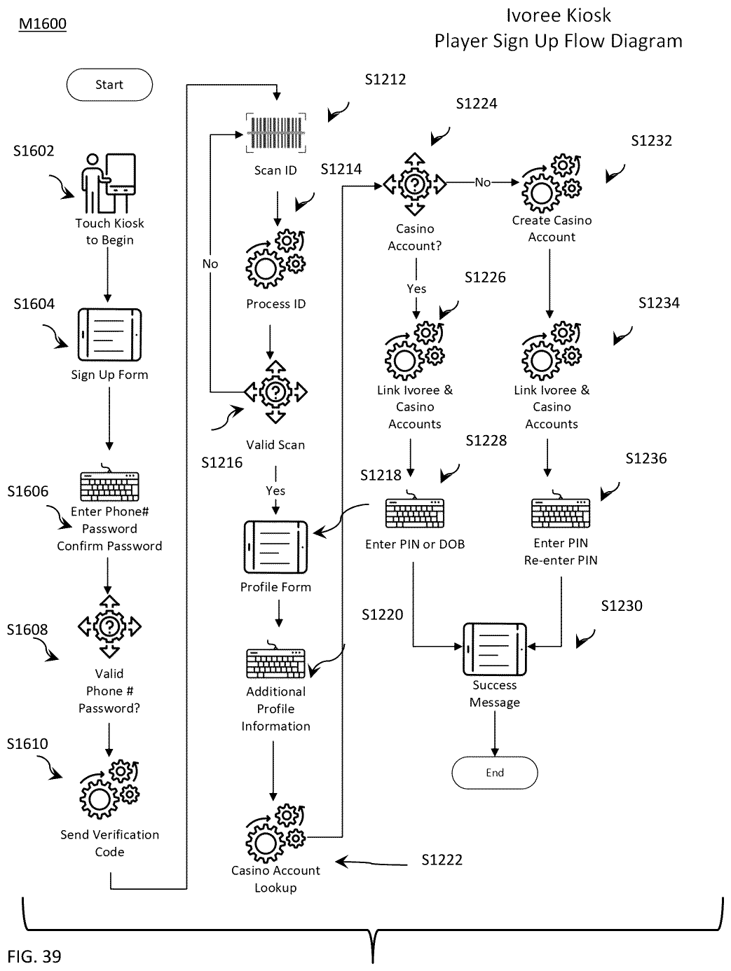

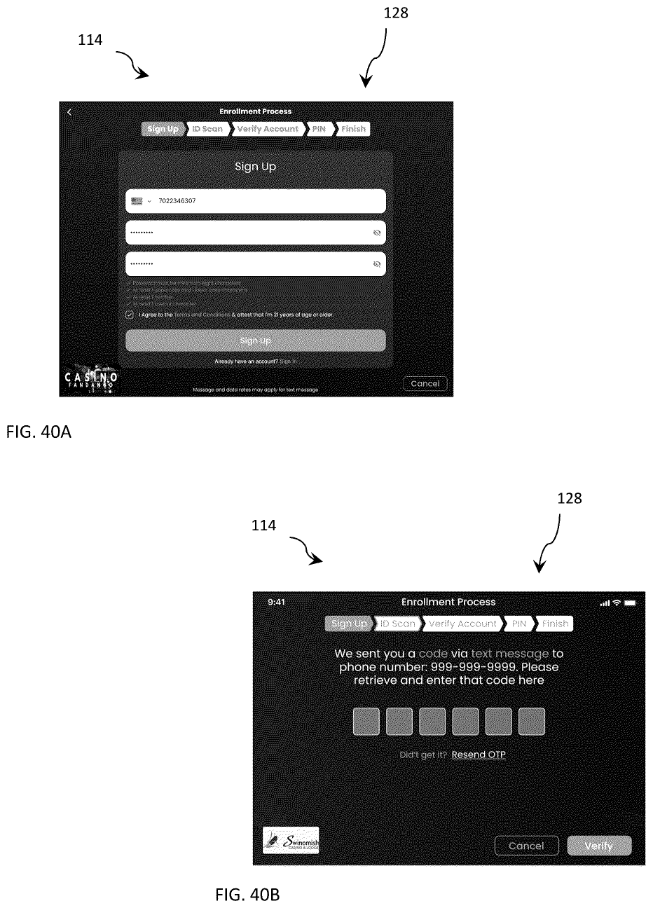

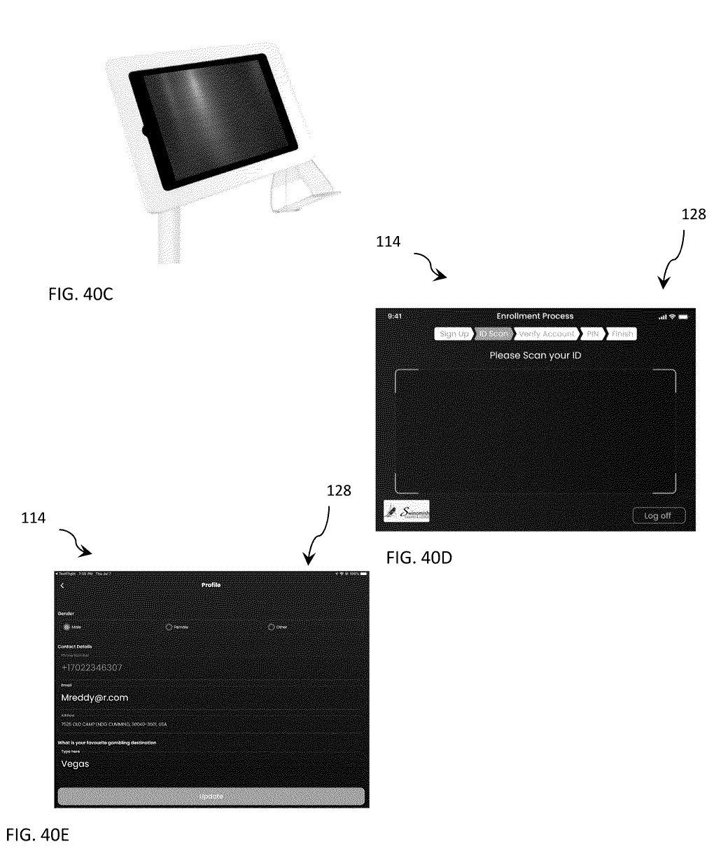

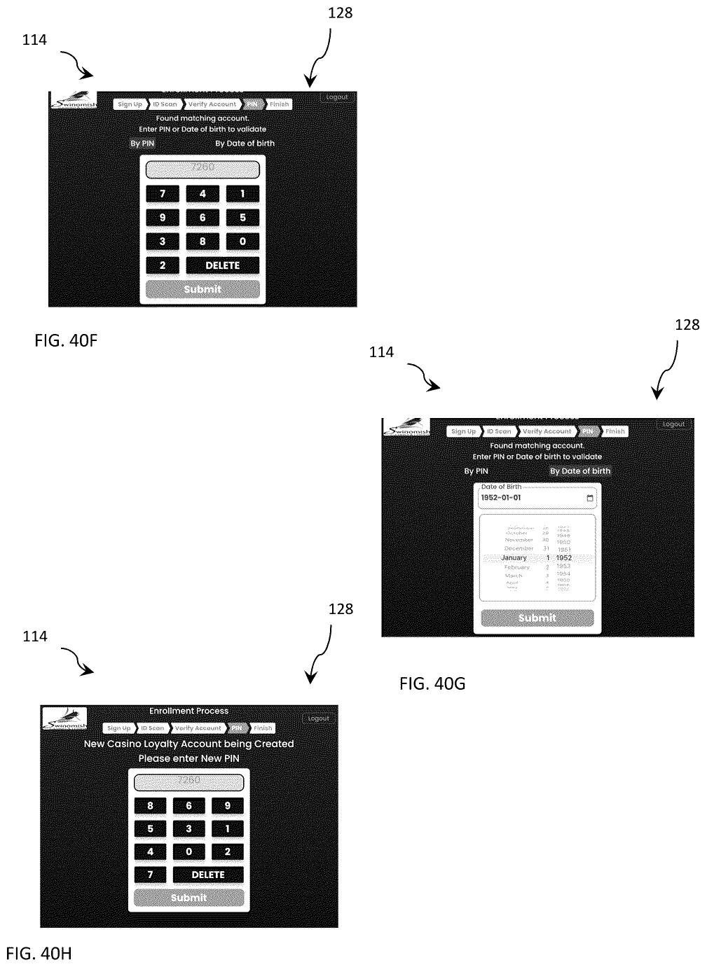

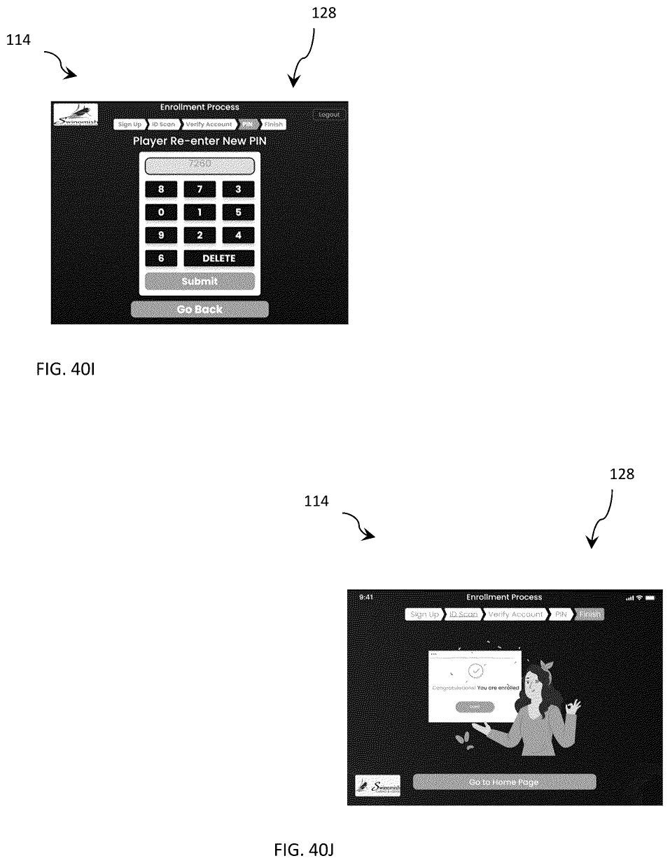

Aa patron may sign up or create an account on the IVOREE platform 104, which may be referred to as an IVOREE account, on various devices located within a casino, for example, a kiosk or at via a user interface on an electronic gaming machine (EGM). With reference to FIG. 39 and FIGS. 40A-40J, a method M1600 associated with creation of an IVOREE account on a kiosk is shown. In a first step S1602, initiates the sign-up process at the kiosk, for example, by touching a touchscreen of the kiosk. In a second step S1604, a sign-up form is displayed (see FIG. 40A). The patron is prompted to enter their primary mobile phone number which is used as their account number and their password (third and fourth steps S1606, S1608). The password is confirmed by entering it twice. After the patron provides their account information a One Time Verification Code (fifth step S1610) is sent to the mobile phone number (FIG. 40B) and must be entered to verify the account.

In a sixth step S1212, once the player phone number has been authenticated the player is prompted to scan their government issued ID using a scanning shelf attached to the kiosk (FIGS. 40C-40D). The ID is processed and validated in seventh and eighth steps S1214, S1216. The player's profile is updated with the players information from the government issued ID and the player is then prompted to enter their email and favorite gaming destination (FIG. 40E) or other types of desired profile information (ninth and tenth steps S1218, S1220). After the profile data has been entered “Update” is selected to save the profile information.

Once the patron has entered their profile information, the patron's player loyalty account may be linked to their IVOREE account (steps S1222-S1230). If the player's player tracking or loyalty account was found, they can choose whether they want to enter their pin (FIG. 40F) or their birthdate (FIG. 40G) to validate the account. Otherwise, the player must enter their new pin to create a new casino loyalty account (FIG. 40H). Then they must re-enter the pin to verify it (FIG. 401). Finally, the player will see a screen that says that they are finished and can go to the casino home page (FIG. 40J).

### Time Share

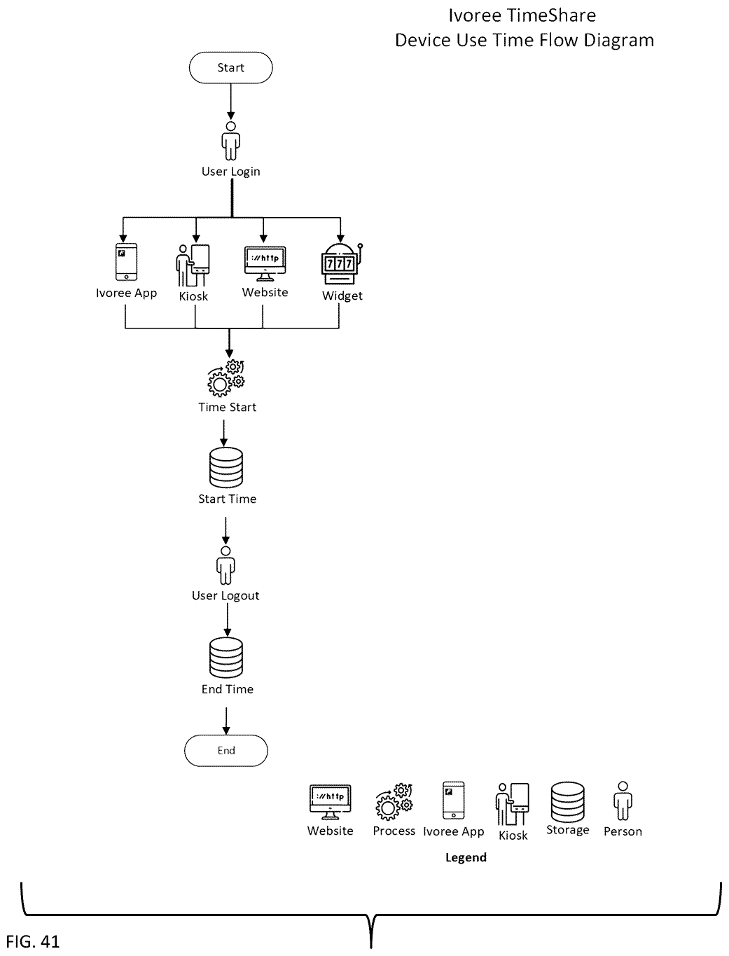

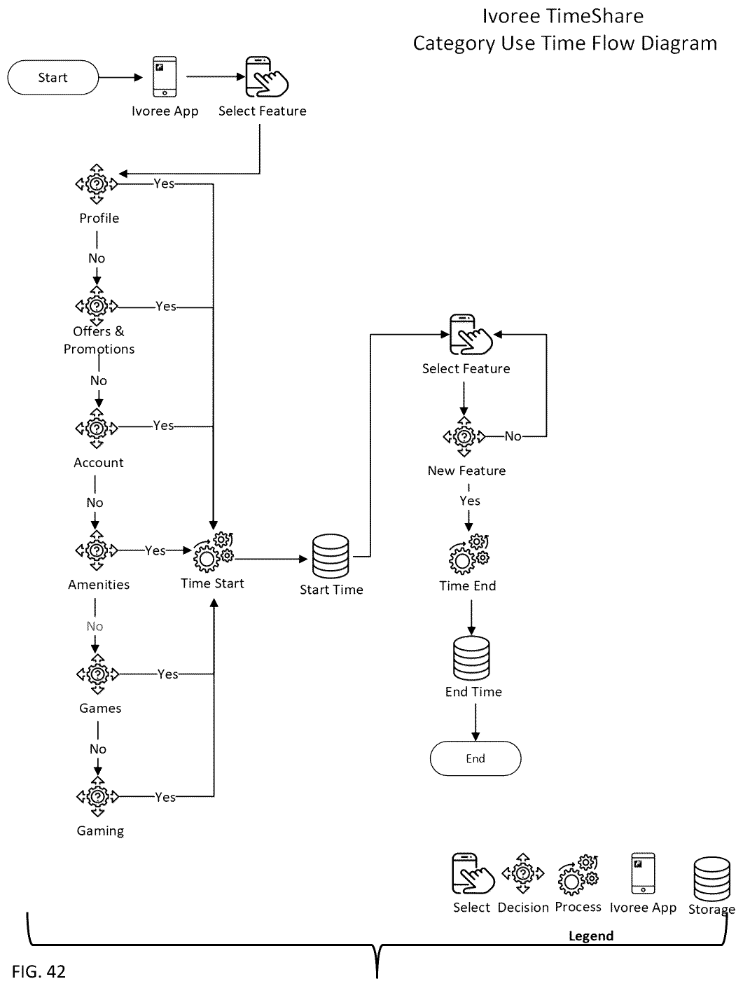

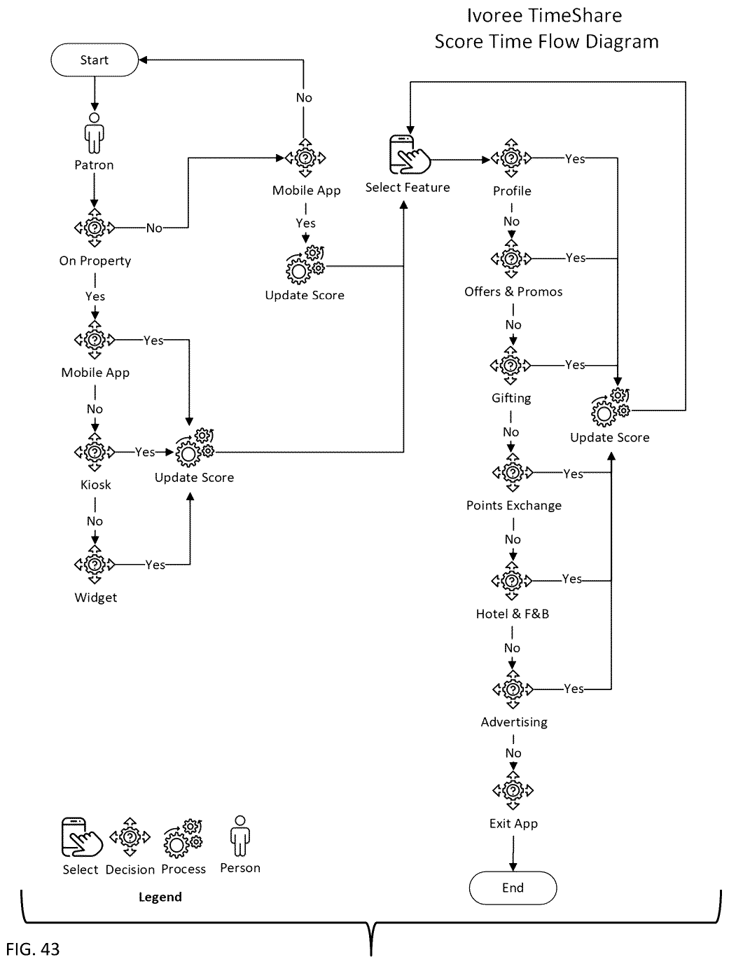

With reference to FIGS. 41-43, in another aspect of the present invention, the IVOREE platform 104 may provide a method to track the amount of time a patron spends at a single casino operator, a multi casino operator or across disparate casino operators. The IVOREE platform 104 may track: amount of time a consumer spends on different devices; the amount of time a patron spends across different categories; the amount of time a patron spends across different activities; and/or the patron spending across different sources. The above method may provide a consumer scoring method to calculate the value of the consumer to casino operator based on time spent (which may be referred to as a “Time-Share” score).

In one embodiment, the Time-Share score may be based device usage, including:
Time spent on the One Mobile App,
Time spent on the Ivoree Mobile Tablet-Kiosk solution in the physical casino,
Time spent on the Ivoree Mobile webpage,
Time spent on the Ivoree Mobile widget that is on the EGM and Tables point-of-play devices (iVIEWs (Bally Systems), Sentinels (Aristocrat Systems), NextGen (IGT Systems), Nams (Konami Systems), DM (Bally Systems), UGA (IGT Systems), nCompass (Aristocrat Systems)),
Time spent on each of the casino walled gardens (for each individual casino property) on the Ivoree Mobile—app, tablet-kiosk, tablet and widgets at the Point-of-play devices,
Time spent on the cell phone as measured by tracking of user across all apps installed on user's phone (if that is enabled), and,
Time spent in the physical casino as measured by geofencing (if enabled), based on user location services.

The Time-Share score may also be based the following categories:
Time spent on administrative functions (change address, email info, PIN etc.),
Time spent on offers/promotions,
Time spent on reviewing points, comps, balances etc.,
Time spent on amenities (hotel, restaurant, retailers etc.),
Time spent on gamification (playing games etc.), and
Time spent on reviewing slots, tables offering (Gaming info).

In one aspect of the present invention, the term Time-Share is a derived value that is computed using the factors listed above. The value computed is based on three main categories: location of the user, type of device used to access the platform, and type of activity accessed/performed on the platform. In one embodiment, each of the categories defined above have an equal weighting of 33.33% and the highest score that may ever be achieved is 99.99. This highest score indicates a fully engaged patron with a great amount of propensity to spend time and engage with the casino/resort property, perform activities both on the physical property as well as on the device.

The lowest score that can ever be achieved is 0. The lowest score indicates a non-engaged patron that has no propensity to spend time and engage with the casino/resort property—both physical and digital on device.

For purposes of clarity, this score only measures time. It does not measure the amounts wagered, total spend etc. either on property or on mobile devices.

### Time Share—Scoring Mechanism & Categories—Expanded

Location of the User—On Casino/Resort Property

If the patron engages with the platform through one of the channels available on casino/resort property, then this is considered a full 100% score. For such interaction to happen, one of the following events/scenarios will need to take place:
patron accesses platform on a personal device (that may be a mobile telephone, tablet, webOS device or a wireless handheld device of another kind) with “Location Settings” tracking on. And the patron is “geo-fenced” and can be verified to be within the casino/resort property area—as defined by the casino on the platform Ivoree—CMS backend system. Patron is logged in with credentials that can validate the user as a registered individual of the platform.
User accesses platform on a property Tablet-Kiosk device. User is logged in with credentials that can validate the user as a registered individual of the platform.
User accesses platform on a property EGM or Table Point-of-Play interface—via widget. User is logged in with credentials that can validate the user as a registered individual of the platform.

Off Casino/Resort Property

If the user/patron engages with the platform through a channel available off casino/resort property, then this is considered 50% of the full score. For such interaction to happen, one of the following events/scenarios will need to take place:
User accesses platform on a personal device (that may be a mobile telephone, tablet, webOS device or a wireless handheld device of another kind) with “Location Settings” tracking on. And the user is “geo-fenced” and can be verified to NOT be within the casino/resort property area—as defined by the casino on the platform Ivoree—CMS backend system. User is logged in with credentials that can validate the user as a registered individual of the platform.

If the patron accesses the platform on a personal device (that may be a mobile telephone, tablet, webOS device or a wireless handheld device of another kind) with “Location Settings” tracking on and the patron is logged in with credentials that can validate the patron as a registered individual of the platform, then this is considered a full 100% score.

If the patron accesses the platform using Tablet-Kiosk on casino/resort property and user is logged in with credentials that can validate the patron as a registered individual of the platform, then this is considered a 75% score.

If the patron accesses the platform using EGM or Table Point-of-Play interface—via widget on casino/resort property and user is logged in with credentials that can validate the user as a registered individual of the platform, then this is considered a 50% score.

In one embodiment, the following types of activities or functions accessed/performed on the Platform are given predetermined weights:
Profile—5%
   Update personal information: mailing address, email address, reset PIN etc.
Hotel/Valet Check-in/Beverage Ordering—5%
   Check-in to hotel room
   Check-in to get car from valet
   Beverage Ordering
Offers/Promotions/Reservations—25%
   Review promotions, offers, coupons from casino/property or channel partners
   “Opt-In” to promotions, offers, etc.
   Redeem promotions, offers etc.
   Make reservations for restaurants, hotels, RV park, Golf
   Purchase/redeem tickets for concerts, events or other activities taking place at the casino/resort or their channel partners
   Gamification: playing games (e.g. only—Spin-the-Wheel, Lucky Envelope etc.)
Continuity Gifting—25%
   Continuity Gifting “Check-In”
   Gift selection
   Gift Redemption & Shipping/Pickup
Points Exchange—20%
   Channel Partner “Check-In” (for conversion of points to gifts or gift cards or e-cards)
   Gift selection, Gift Card selection or E-card selection
   Redemption & Shipping/Pickup
Ad Participation/Viewing—20%
   Clicking on ads
   Viewing ads

If all the activities listed above in Section V(3) above are performed by a user within a calendar day (24 hours), then this is considered a full 100% score.

### Wallet Share

In another aspect of the present invention, the IVOREE platform 104 provide a method to track:
a patron's spending at a single casino operator, a multi casino operator or across disparate casino operators,
a patron's spending across different categories, and.
a patron's spending across different sources.

The IVOREE platform 104 may provide a consumer scoring method to calculate the value of the consumer to a casino operator based on spend.

Wallet-Share Criteria:
Points Earned->Gaming & Non-Gaming
ADT (Average Daily Theo—if available)->Gaming
Free Play Earned->Gaming
Total Coin-In->Gaming
Hotel, Retail, F&B, Gas Stations/Convenience Stores, Valet, Entertainment Spend->Non-Gaming Amenities

Source of Information & Categorization
Value received from Gaming Systems (Aristocrat, Bally/Scientific Games, Konami, IGT)
Value received from other Non-Gaming 3rd Party Systems (Point of Sale, Hotel, Retail, F&B, Valet, Entertainment Activities, Convenience Stores etc.)
Value received from 3rd party channel partners (Points Exchange, Continuity Gifting)

Scoring Mechanism

The spend score for each property may be calculated as a function of the above parameters. When available, the Spend Score for each property is broken up into Gaming Spend Score and Non-Gaming Spend Score. If the user/patron has multiple properties connected on the platform, then Spend Score may be determined for each property and a Total Spend Score=Spend Score for Property 1+Spend Score for Property 2 etc. . . . . The Wallet-Share Score may be calculated as a function of Spend Score for Property 1 vs. Total Spend Score.

Spend Score Calculation—Gaming

The following parameters are used to determine a patron's Spend Score—Gaming:
ADT—Average Daily Theo (Highest scoring consideration): This covers the gaming wagering value of the patron for the particular property. This is a theoretical value that is computed within the Gaming System (Player Tracking System) and is a calculated value of the total amount wagered—total amount won/returned to the player at the EGM/
Points Earned—This is a calculated value which differs from property to property. Individual properties assign and provide a certain number of points as earned by the patron/player—for every dollar wagered at the EGM. Using the information gained from the Gaming System (Player Tracking system), the points earned by the patron/player can be used to work backwards and determine the total dollars wagered at the EGM by the individual.
Total Coin-In: This is the value of the total $ amount that is wagered by the player/patron at the EGM.
Free Play Earned: Operators award free play directly commensurate with spend and often on an escalator basis. i.e., the highest tier players/patrons receive the greatest percentage of the overall free play awarded, followed by diminishing scale for the next tier and proportionally lower for each tier level lower.

The preferred mode of calculation is to take all 4 parameters outlined above into consideration. When one or more of the above parameters are unavailable, then the other parameters take a larger value.

The Spend Score—Gaming takes into account the parameters listed above for each of the preceding periods (weeks, months, quarters etc.) and determines an overall trend pattern for the player. That is a key coefficient used to determine Spend Score—Gaming value which may change from one “period” to another.

Spend Score Calculation—Non-Gaming

The following parameters may be used to determine a patron's Spend Score—Non-Gaming:
Total $ Spent—This is the value of the total $ amount that is spent by the player/patron at the non-gaming amenities and facilities associated with the property/resort.
Points Earned—This is a calculated value which differs from property to property. Individual properties assign and provide a certain number of points as earned by the patron/player—for every dollar wagered at the non-gaming facilities. Using the information gained from the Gaming System (Player Tracking system), the points earned by the patron/player can be used to work backwards and determine the total dollars spent at non-gaming outlets by the individual.

The preferred mode of calculation is to take both parameters outlined above into consideration. When one of the above parameters is unavailable, then the other parameter takes a larger value.

The Spend Score—Non-Gaming takes into account the parameters listed above for each of the preceding periods (weeks, months, quarters etc.) and determines an overall trend pattern for the player. That is a key coefficient used to determine Spend Score—Non-Gaming value which may change from one “period” to another.

### Total Spend Score Calculation—Gaming+Non-Gaming

The combination of Spend Score—Gaming & Spend Score—Non-Gaming are used to determine the Total Consolidated Spend Score. The Spend Score—Gaming is given greater weightage relative to the Spend Score—Non-Gaming in the calculation of the Total Consolidated Spend Score. The weightage associated with the Gaming vs. Non-Gaming Spend Score may be adjusted/altered at a property level.

### Wallet-Share Score

The Wallet-Share score is determined when the patron/player information outlined above is available for more than one property OR if patrons/players with similar demographic, spend patterns, game play patterns participate in disparate casinos—which may be used to derive a trend and hence determine Wallet-Share score.

The Wallet-Share Score->Same Patron: If a player/patron frequents more than one property/resort/casino using the Company platform, then the Wallet-Share Score is used as a calculated value. The calculation is based on analysis of Spend-Score values in totality vs. that for the specific property in question.

The Wallet-Share Score->Derived Value: For players/patrons that frequent disparate properties and have similar demographic (age, sex), trip patterns (days and times visiting the casino), play patterns (types of EGMs, tables played, denomination wagered, ADT, etc.) and with similar Spend Score for Gaming and/or Spend Score for Non-Gaming, such patron scores are taken into consideration together (as long as data exists across multiple periods) to extrapolate a pro-rated Wallet-Share score value.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A computer platform for providing patrons with access to a plurality of casino management systems (CMS), comprising:
a data store configured to store a database including a patron data file including a plurality of patron records and a patron CMS data file including a plurality of patron CMS configuration records, each patron record and each patron CMS configuration record being associated with one of the patrons, each patron record including computer platform logon data, each patron CMS configuration record including CMS logon data for an associated casino management system; and,
one or more content servers coupled to the data store including at least one processor programmed to execute an algorithm, the algorithm steps including the steps of:
allowing one of the patrons to logon onto to the computer platform using a user device;
allowing the one of the patrons to select one of the plurality of casino management systems;
locating the patron CMS configuration record associated with the one of the patrons and the one of the plurality of casino management systems and automatically logging onto the one of the plurality of casino managements systems as the one of the patrons using the CMS logon data in the located patron CMS configuration record;
providing access to the one of the plurality of casino management systems to the one of the patrons via the user device.

2. The computer platform, as set forth in claim 1, wherein the computer platform includes cache data and, in providing access to the one of the plurality of casino management systems, the algorithm includes the steps of:
opening a CMS session;
retrieving session data from the one of the plurality of casino management systems;
presenting the session data to the one of the patrons and allowing the one of the patrons to interact with the session data during the CMS session via the user device; and,
closing the CMS session in response to a patron action and deleting the session data from the cache memory.

3. The computer platform, as set forth in claim 2, wherein the session data includes at least one of player tracking points, casinos in range of the one of the patron's current location, active widgets associated with the casinos in range of the one of the patron's current location, tier points, personalized offers, available games, sweepstakes, VIP program, and leaderboard data.

4. The computer platform, as set forth in claim 1, wherein the data store includes persistent CMS data related to the casino management system, the algorithm includes the step of presenting and allowing the one of the patrons to interact with the persistent CMS data during the CMS session.

5. The computer platform, as set forth in claim 1, wherein the algorithm includes the step of presenting and allowing the one of the patrons interact with data in the patron record associated with the one of the patrons.

6. The computer platform, as set forth in claim 1, wherein the user device is one of mobile phone, a tablet, a kiosk, an electronic gaming machine, and a computing device on which a web browser is being executed.

7. The computer platform, as set forth in claim 6, wherein the database includes at least one device data file including a plurality of user device records, each device record including data related to an associated device for controlling settings and features of the associated device used in providing access to the one of the plurality of casino management systems to the one of the patrons via the user device.

8. A method for operating a computer platform for providing patrons with access to a plurality of casino management systems (CMS), the computer platform including a data store and one or more content servers coupled to the data store, the one or more content servers including at least one processor programmed to execute an algorithm, the data store configured to store a database including a patron data file including a plurality of patron records and a patron CMS data file including a plurality of patron CMS configuration records, each patron record and each patron CMS configuration record being associated with one of the patrons, each patron record including computer platform logon data, each patron CMS configuration record including CMS logon data for an associated casino management system, the algorithm including the steps of:
allowing one of the patrons to logon onto to the computer platform using a user device;
allowing the one of the patrons to select one of the plurality of casino management systems;
locating the patron CMS configuration record associated with the one of the patrons and the one of the plurality of casino management systems and automatically logging onto the one of the plurality of casino managements systems as the one of the patrons using the CMS logon data in the located patron CMS configuration record;
providing access to the one of the plurality of casino management systems to the one of the patrons via the user device.

9. The method, as set forth in claim 8, wherein the computer platform includes cache data and, in providing access to the one of the plurality of casino management systems, the algorithm including the steps of:
opening a CMS session;
retrieving session data from the one of the plurality of casino management systems;
presenting the session data to the one of the patrons and allowing the one of the patrons to interact with the session data during the CMS session via the user device; and,
closing the CMS session in response to a patron action and deleting the session data from the cache memory.

10. The method, as set forth in claim 9, wherein the session data includes at least one of player tracking points, casinos in range of the one of the patron's current location, active widgets associated with the casinos in range of the one of the patron's current location, tier points, personalized offers, available games, sweepstakes, VIP program, and leaderboard data.

11. The method, as set forth in claim 8, wherein the data store includes persistent CMS data related to the casino management system, the algorithm includes the step of presenting and allowing the one of the patrons to interact with the persistent CMS data during the CMS session.

12. The method, as set forth in claim 8, wherein the algorithm includes the step of presenting and allowing the one of the patrons interact with data in the patron record associated with the one of the patrons.

13. The method, as set forth in claim 8, wherein the user device is one of mobile phone, a tablet, a kiosk, an electronic gaming machine, and a computing device on which a web browser is being executed.

14. The method, as set forth in claim 13, wherein the database includes at least one device data file including a plurality of user device records, each device record including data related to an associated device for controlling settings and features of the associated device used in providing access to the one of the plurality of casino management systems to the one of the patrons via the user device.

15. One or more non-transitory computer-readable storage media, having computer-executable instructions embodied thereon for operating for operating a computer platform for providing patrons with access to a plurality of casino management systems (CMS), the computer platform including a data store and one or more content servers coupled to the data store, the one or more content servers including at least one processor, the data store configured to store a database including a patron data file including a plurality of patron records and a patron CMS data file including a plurality of patron CMS configuration records, each patron record and each patron CMS configuration record being associated with one of the patrons, each patron record including computer platform logon data, each patron CMS configuration record including CMS logon data for an associated casino management system, the computer-executable instructions cause the at least one processor to execute an algorithm to:
allow one of the patrons to logon onto to the computer platform using a user device;
allow the one of the patrons to select one of the plurality of casino management systems;
locate the patron CMS configuration record associated with the one of the patrons and the one of the plurality of casino management systems and automatically log onto the one of the plurality of casino managements systems as the one of the patrons using the CMS logon data in the located patron CMS configuration record;
provide access to the one of the plurality of casino management systems to the one of the patrons via the user device.

16. The one or more non-transitory computer-readable storage media, as set forth in claim 15, wherein the computer platform includes cache data and, in providing access to the one of the plurality of casino management systems, the computer-executable instructions cause the at least one processor to execute the algorithm to:
open a CMS session;
retrieve session data from the one of the plurality of casino management systems;
present the session data to the one of the patrons and allowing the one of the patrons to interact with the session data during the CMS session via the user device; and,
close the CMS session in response to a patron action and deleting the session data from the cache memory.

17. The one or more non-transitory computer-readable storage media, as set forth in claim 16, wherein the session data includes at least one of player tracking points, casinos in range of the one of the patron's current location, active widgets associated with the casinos in range of the one of the patron's current location, tier points, personalized offers, available games, sweepstakes, VIP program, and leaderboard data.

18. The one or more non-transitory computer-readable storage media, as set forth in claim 15, wherein the data store includes persistent CMS data related to the casino management system, the computer-executable instructions cause the at least one processor to execute the algorithm to present, and allow the one of the patrons to interact, with the persistent CMS data during the CMS session.

19. The one or more non-transitory computer-readable storage media, as set forth in claim 16, wherein the computer-executable instructions cause the at least one processor to execute the algorithm to present, and allow the one of the patrons interact, with data in the patron record associated with the one of the patrons.

20. The one or more non-transitory computer-readable storage media, as set forth in claim 15, wherein the user device is one of mobile phone, a tablet, a kiosk, an electronic gaming machine, and a computing device on which a web browser is being executed.

21. The method, as set forth in claim 20, wherein the database includes at least one device data file including a plurality of user device records, each device record including data related to an associated device for controlling settings and features of the associated device used in providing access to the one of the plurality of casino management systems to the one of the patrons via the user device.
